(19) United States
(12) Patent Application Publication
(10) Pub. No.: US 2010/0167256 A1
(43) Pub. Date: Jul. 1, 2010

(54) System and method for global historical database

(76) Inventor: Douglas Michael Blash, Frederick, MD (US)

Correspondence Address: Douglas Michael Blash, P.O. Box 597, Shepherdstown, WV, 25443, US

(21) Appl. No.: 12/379,070

(22) Filed: Feb. 12, 2009

Related U.S. Application Data
(60) Provisional application No. 61/064,070, filed on Feb. 14, 2008.

(51) Int. Cl. G09B 5/00; G06F 17/30; G06F 3/048; H04L 9/28; G06F 3/16; G06Q 30/00

(52) U.S. Cl. 434/308; 715/780; 713/193; 715/728; 434/428; 705/7; 463/29; 463/30

(57) ABSTRACT

In accordance with a number of embodiments, this document presents an innovative system and method which may be used to input data relating to any number of historical or scientific subjects, store the data in a collaborative format, and output data in any number of static or animated formats [FIG. 2]. In various embodiments, this method may provide a revolutionary means for encoding the entire history of the earth, encoding the entire history of human cultures, and for ensuring that all input data adhere to a universal data format. It provides and specifies a number of innovative and collaborative protocols for input [FIG. 3], storage [FIG. 4], classification [FIGS. 5A-5V], sorting [FIG. 6A], filtering [FIG. 6B], verifying [FIG. 6C], compiling [FIG. 8], updating [FIG. 9], customizing [FIG. 11], and publishing data [FIG. 12]. It may also provide a means for creating a revolutionary format of global historical collaborative animated map [FIGS 10A-10V, FIGS. 11A-11E]. It may be used widely in various applications, including but not limited to education, journalism, governments, international business, and international relations.

### CROSS-REFERENCE TO RELATED APPLICATIONS

This application claims the benefit of Preliminary Patent Application Ser. No. US-61/064,070, filed Feb. 14, 2008, by the present inventor, Douglas Michael Blash, which is incorporated in its entirety by reference.

The patent or application file contains at least one drawing executed in color. Copies of this patent or patent application publication with color drawings will be provided by the USPTO upon request and payment of the necessary fee.

### FEDERALLY SPONSORED RESEARCH

Not applicable.

### SEQUENCE LISTING OR PROGRAM

Not applicable.

### BACKGROUND OF THE INVENTION

1. Field

This invention relates generally to the categories of computer programming and education. In computer programming, it relates specifically to computer programming for database structure and database management. In education, it relates specifically to education in social studies, the social sciences, and all of the diverse fields that may be included under the modern definition of “human geography” as an interdisciplinary study, including but not limited to world history, civilizations, globalization, religious studies, political science, governments, civics, economics, cultural anthropology, archaeology, linguistics, genetics, biology, ecology, climatology, environmental sciences, geography, and the earth sciences.

2. Prior Art

All modern standard GIS-based systems are designed to take elements of map data, arrange them into layers of polygon data, line data, and point data, with associated text, to wrap them around a virtual globe for accurate viewing, and to perform various types of spatial analysis on the data. These systems, often with simplified interfaces, have become very popular in recent years. All GIS-based systems involve manipulations of map data in virtual space, and many of them will also allow for manipulations of data across time. Almost all involve a plurality of data layers, but none of them allow for the specific types of data, the specific data structure, and the specific data management protocols that will be needed to create a fully functional tool for use in education, journalism, governments, international business, and international relations.

The basic systems and methods for Geographic Information Systems (GIS) were developed as early as the late 1950s or early 1960s, by government and military agencies, for use in missile tracking and intelligence mapping. The first publicly-known and fully-realized GIS-based system was developed in 1962 by the Canadian Department of Forestry for use in land management, and similar systems were concurrently developed by the United States Geological Survey (USGS). The first GIS-based systems for private enterprise were developed in the very early 1980s, including ARC/INFO, which was released in 1982 by the Environmental Systems Research Institute (ESRI).

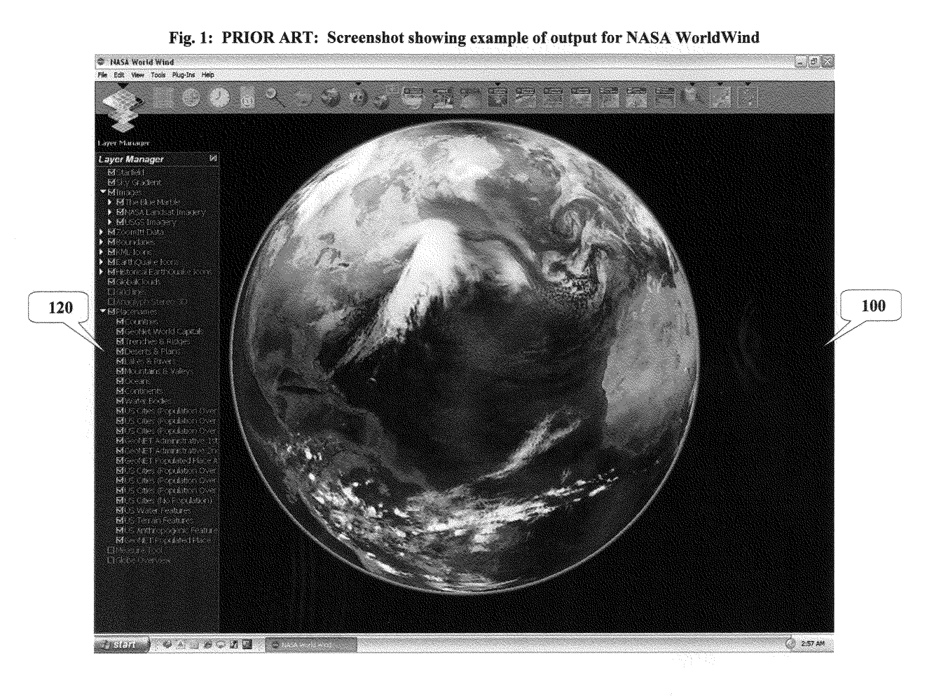

Today, the most well-known GIS-based systems are WorldWind, which was released by the National Aeronautics and Space Administration (NASA) in 2004, Google Earth, which was released by Google in 2005, and Microsoft Virtual Earth, which was released by Microsoft later in 2005. FIG. 1 shows a screenshot of NASA WorldWind, highlighting the map area (100) and the legend area (102). NASA WorldWind may be considered the most scientific offering, while Microsoft Virtual Earth may be considered the most commercial offering, and Google Earth is currently the most popular. There are also a variety of specifically educational offerings, but as stated, none of them allow for the specific types of data, the specific data structure, and the specific data management protocols that will be needed to create a fully functional tool for use in education, journalism, governments, international business, and international relations.

Specifically, all of the prior art suffers from several of the following design flaws or disadvantages: 1) none of them provide a means for encoding the entire history of the earth; 2) none of them provide a means for encoding the entire history of human cultures; 3) they may not provide a means for a universal data format; 4) they may be limited to a certain time period; 5) they may be limited to a certain geographic region; 6) they may not provide any means for moving through time; 7) they may not provide any means for rendering past landscapes accurately; 8) they may not provide any means for user-created content; 9) they may not provide any means for entering data with a guided graphic user interface; 10) they may not provide a means for the user or instructor to show only the data which the audience is ready or able to understand; 11) they may not provide a means for pre-programmed grade-level settings; 12) they may not provide a means for the user or instructor to show only the data which the audience considers to be sufficiently important; 13) they may not provide a means for event-importance highlighting; 14) they may not provide a means for the user or instructor to show only the data which has been vetted out by those who have reached a desired level of expertise in the appropriate field; 15) they may not provide a means for expertise-based data-vetting; 16) they may not provide a protocol for resolving disputes in the data; 17) they may not provide a protocol for continually updating data in the future; 18) and none of them provide a means for creating or customizing a fully-functional global historical collaborative animated map.

This specification will detail systems and methods for realizing all of these design elements and many more which are novel, useful, and wonderfully surprising when disclosed to persons having ordinary skill in the prior art.

### SUMMARY

In accordance with a number of embodiments, this document presents an innovative system and method which may be used to input data relating to any number of historical or scientific subjects, store the data in a collaborative format, and output data in any number of static or animated formats. In various embodiments, this method may provide a revolutionary means for encoding the entire history of the earth, encoding the entire history of human cultures, and for ensuring that all input data adhere to a universal data format. It provides and specifies a number of innovative and collaborative protocols for input, storage, classification, sorting, filtering, verifying, compiling, updating, customizing, and publishing data. It may also provide a means for creating a revolutionary format of global historical collaborative animated map. It may be used widely in various applications, including but not limited to education, journalism, governments, international business, and international relations.

### DRAWINGS

### Figures

The patent or application file contains at least one drawing executed in color. Copies of this patent or patent application publication with color drawings will be provided by the USPTO upon request and payment of the necessary fee.

FIG. 1 is PRIOR ART: It is a screenshot showing an example of output for NASA WorldWind.

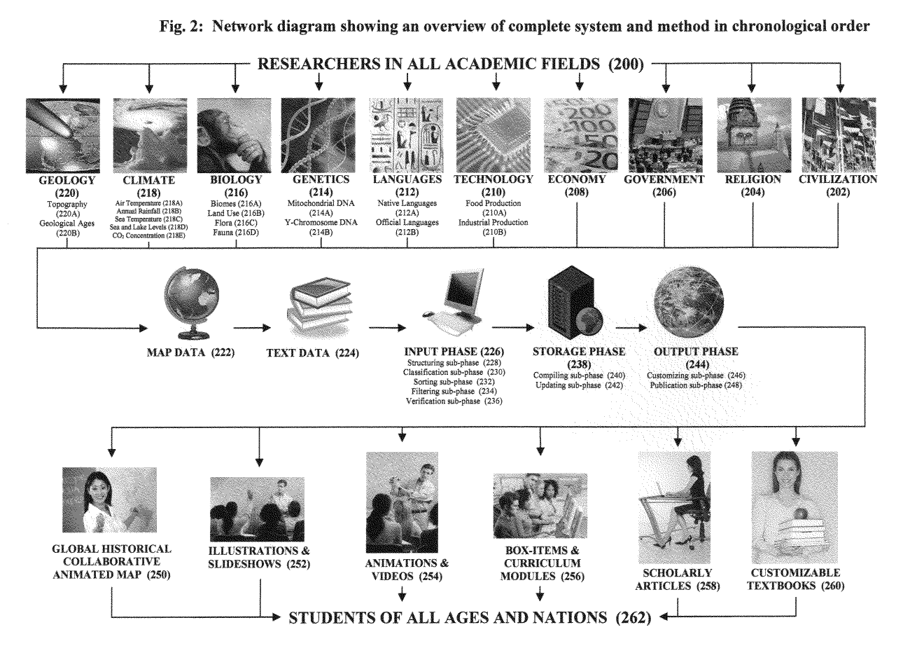

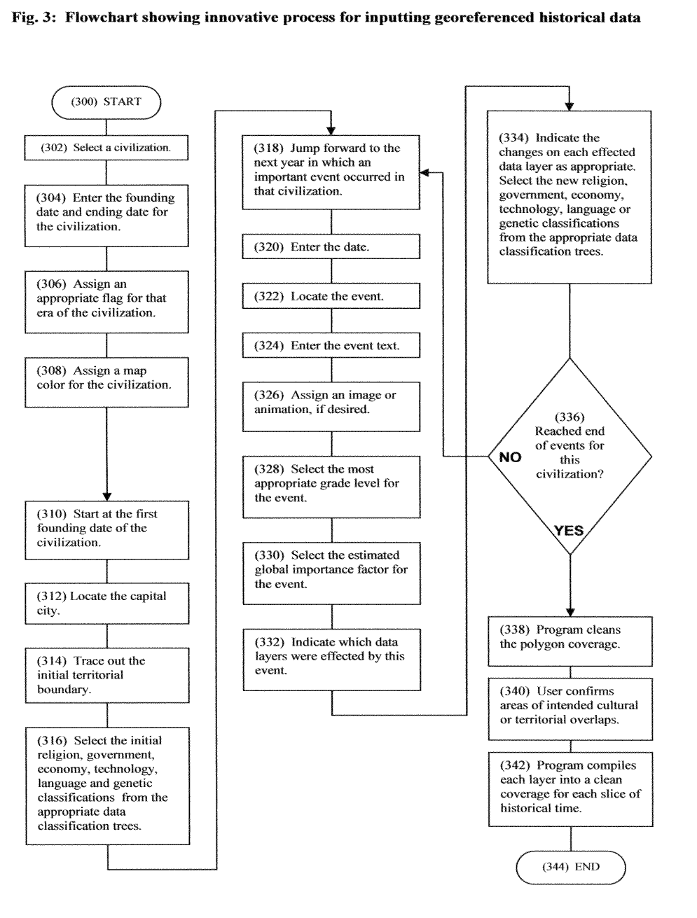

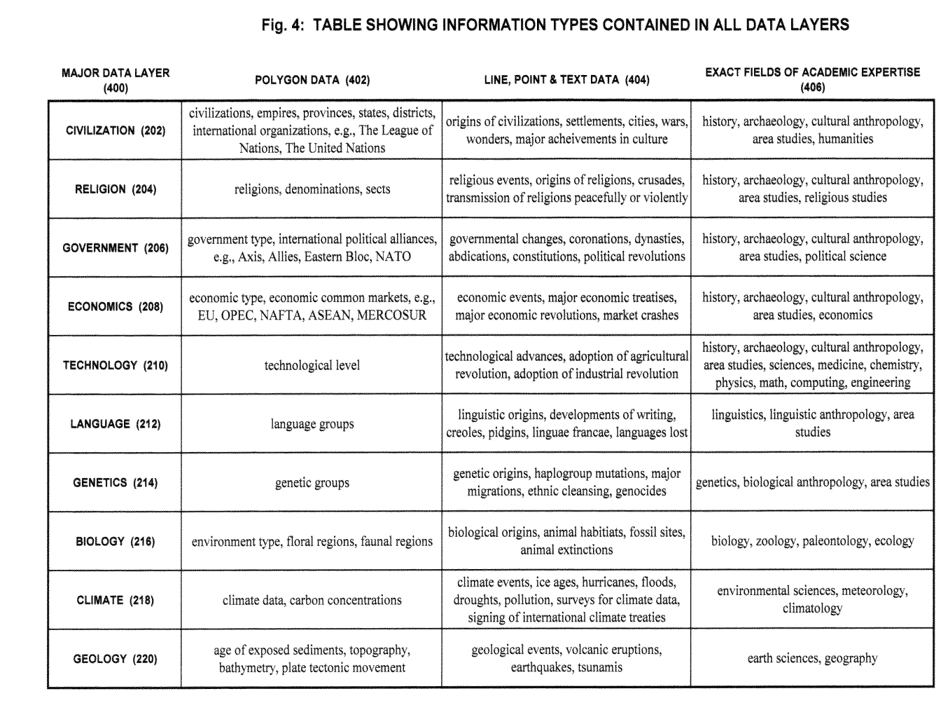

FIG. 2 is a network diagram showing an overview of the complete system and method in chronological order.

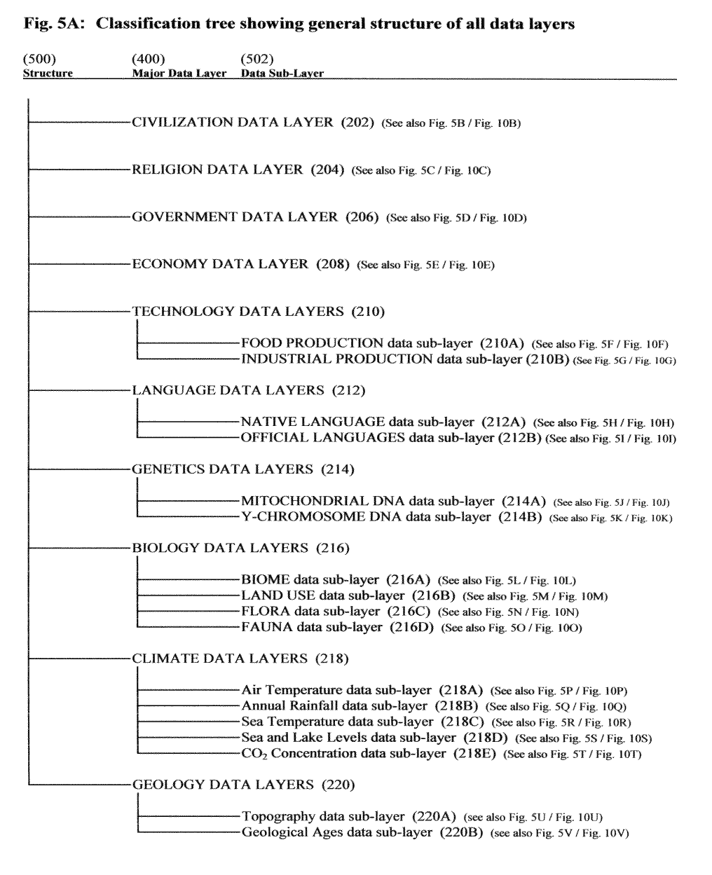

FIG. 3 is a flowchart showing an innovative process for inputting georeferenced historical data.

FIG. 4 is a table showing the information types that may be contained in all of the data layers.

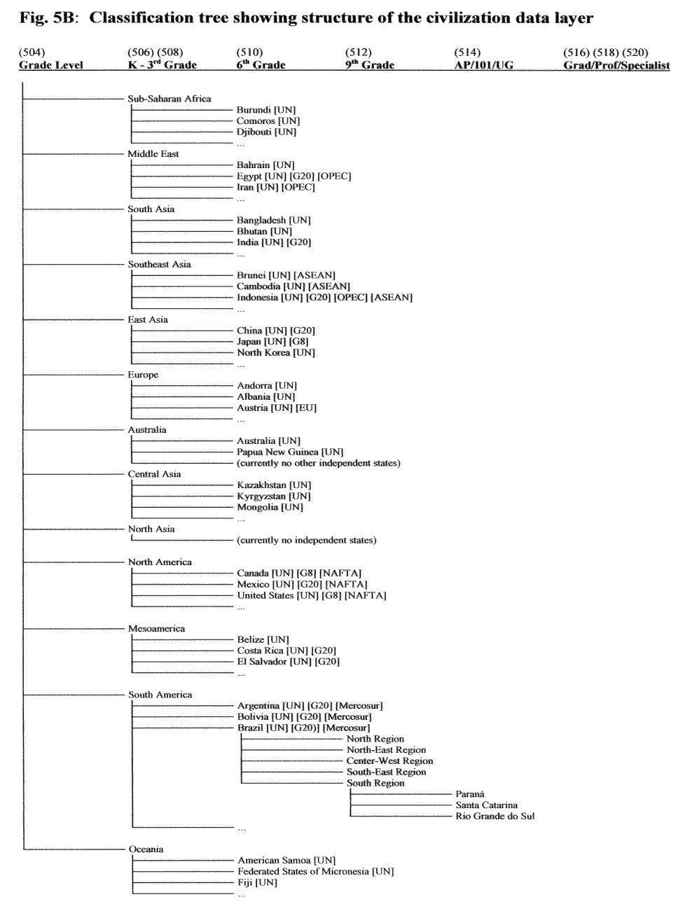

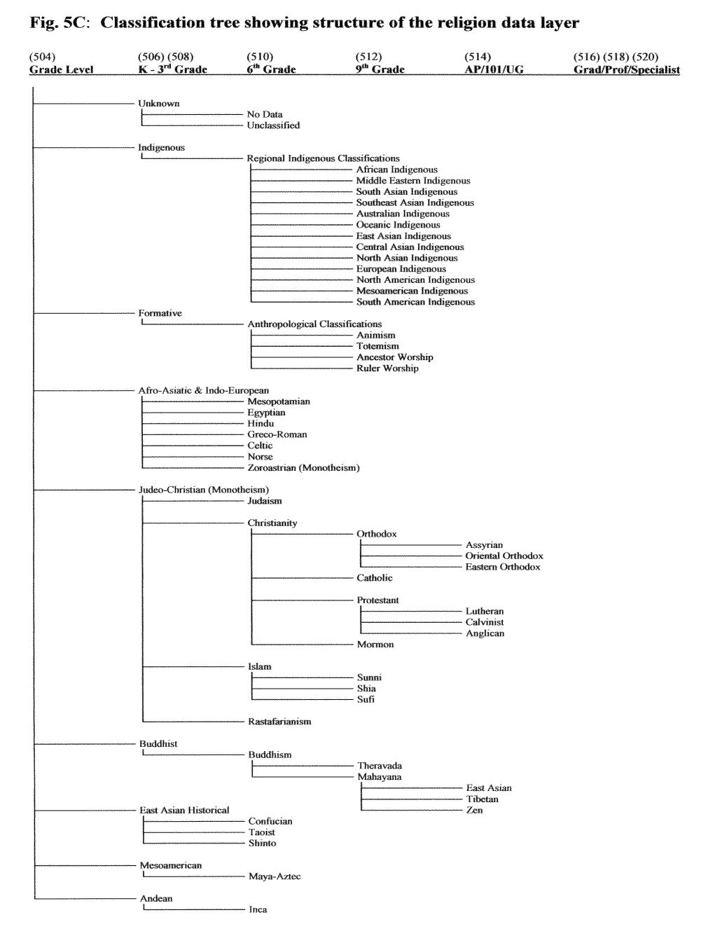

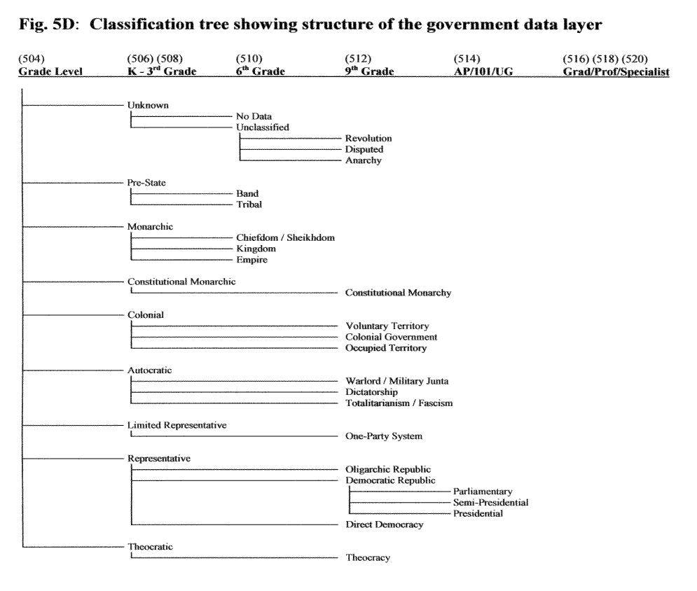

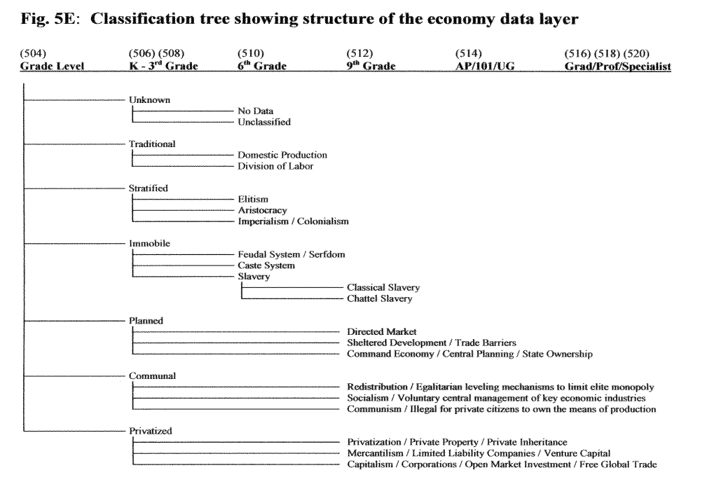

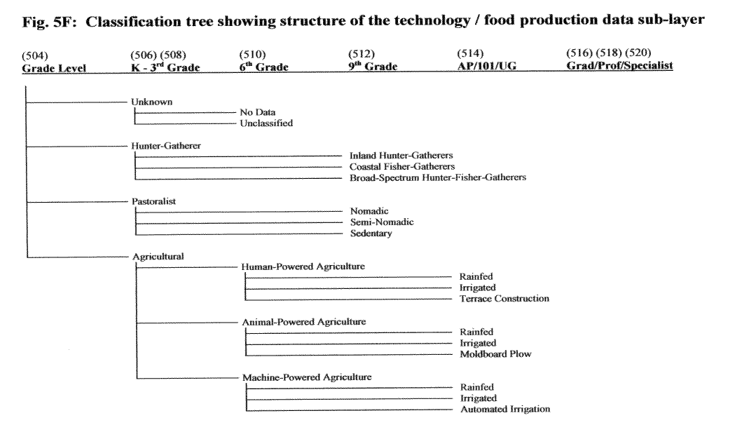

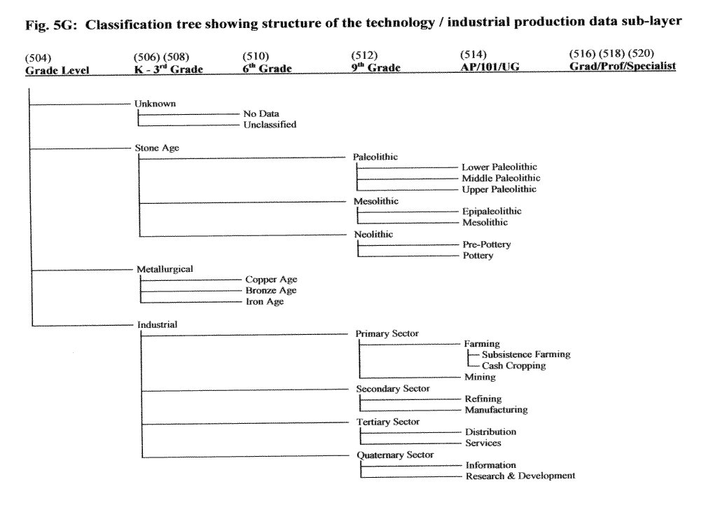

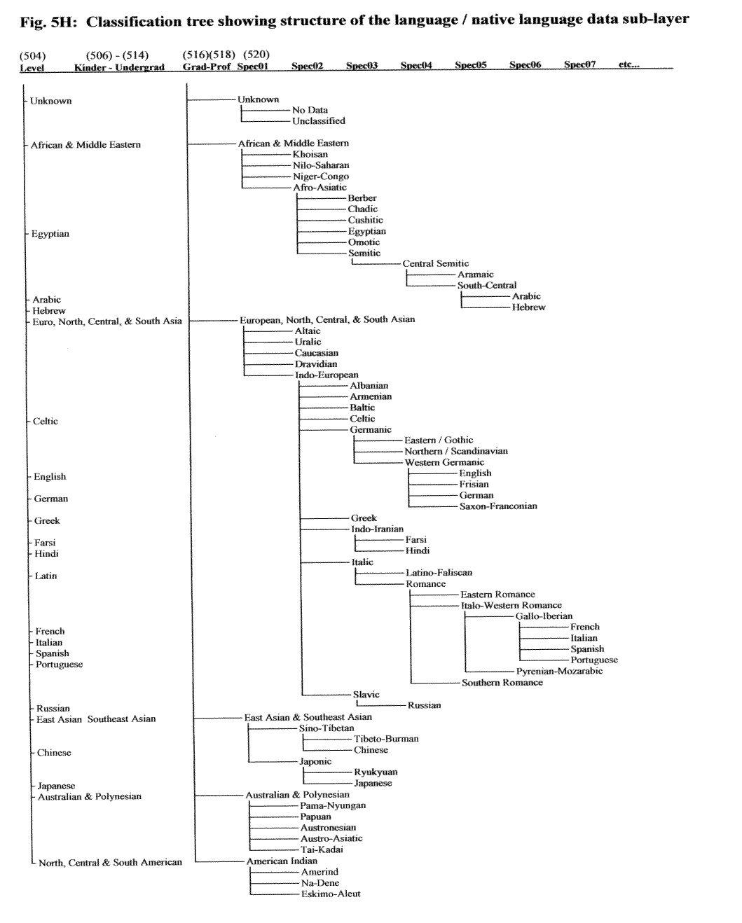

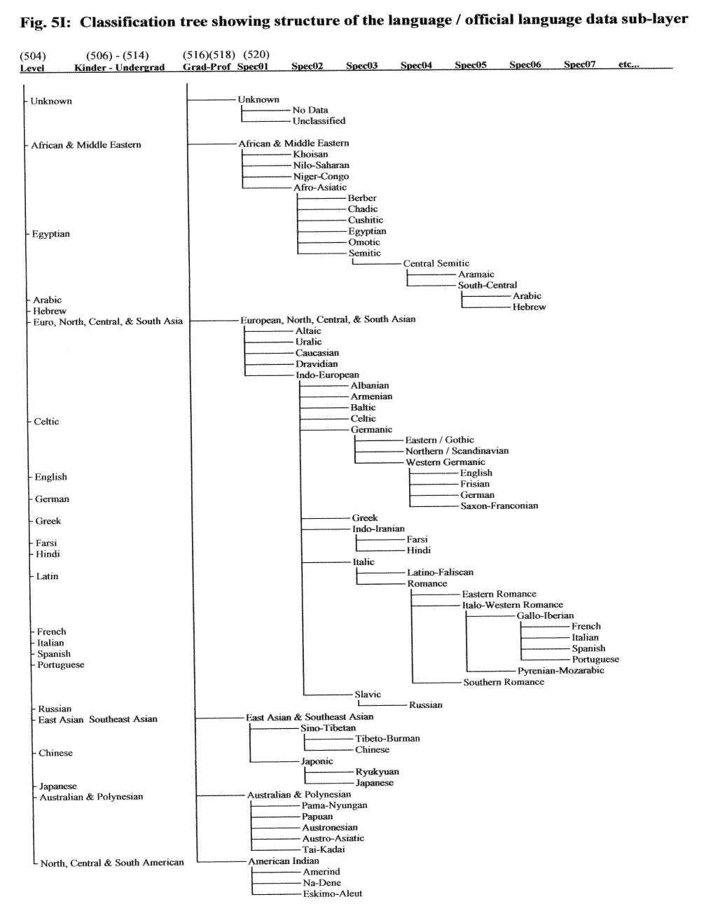

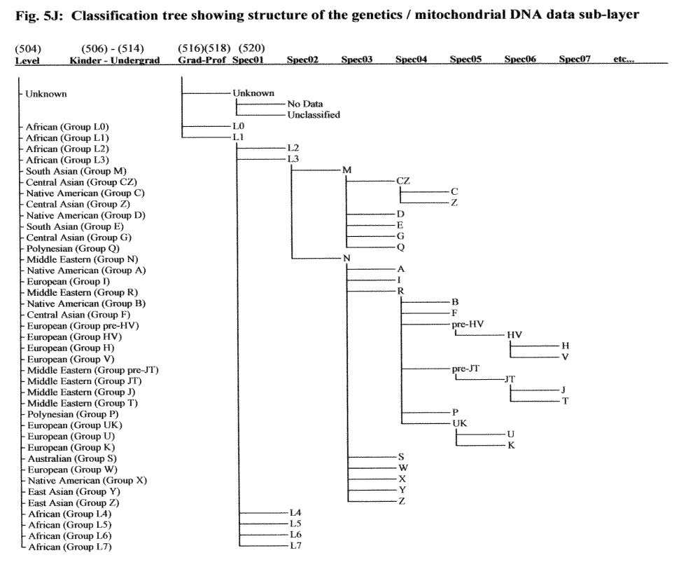

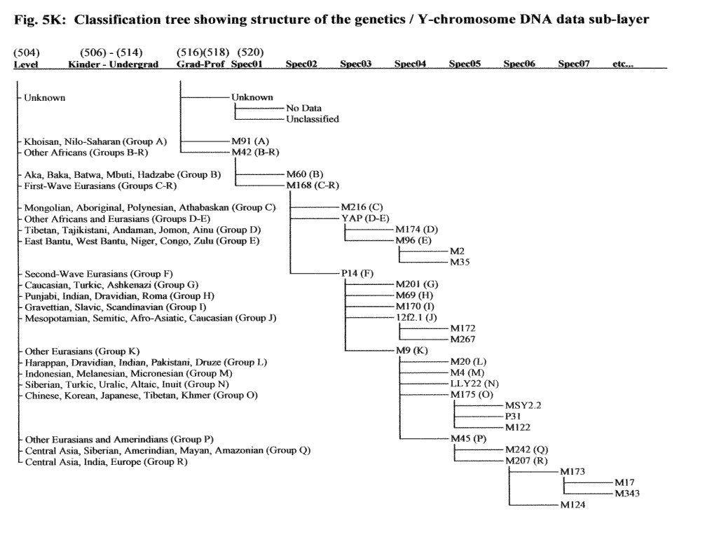

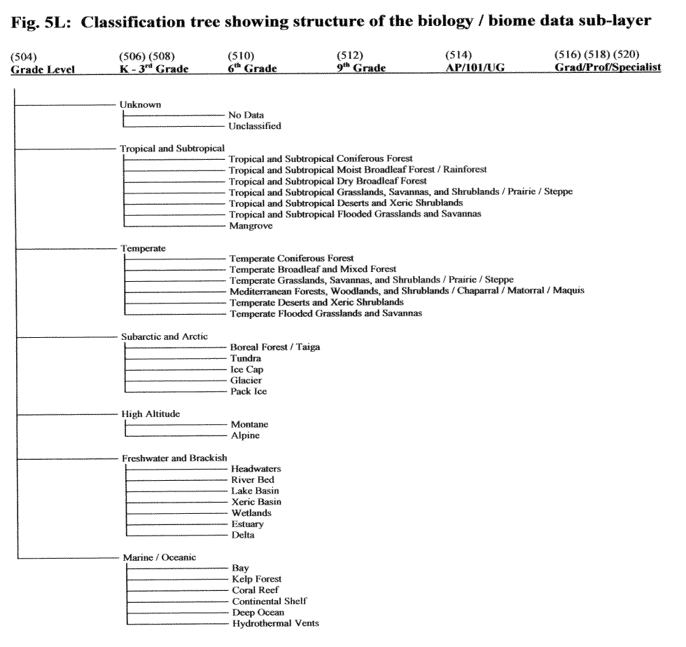

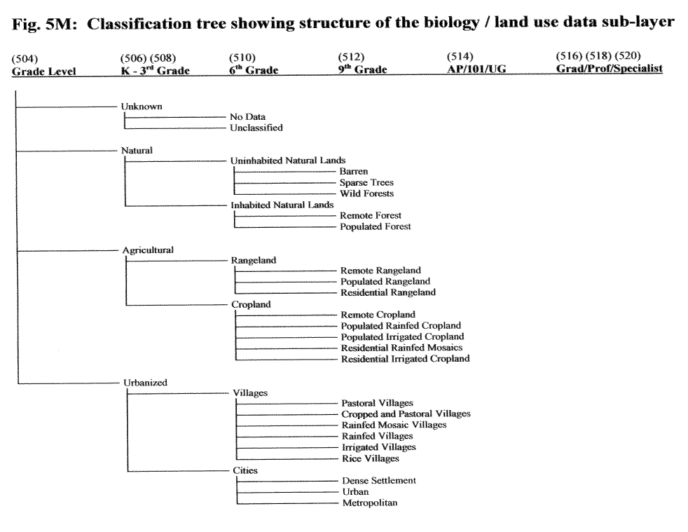

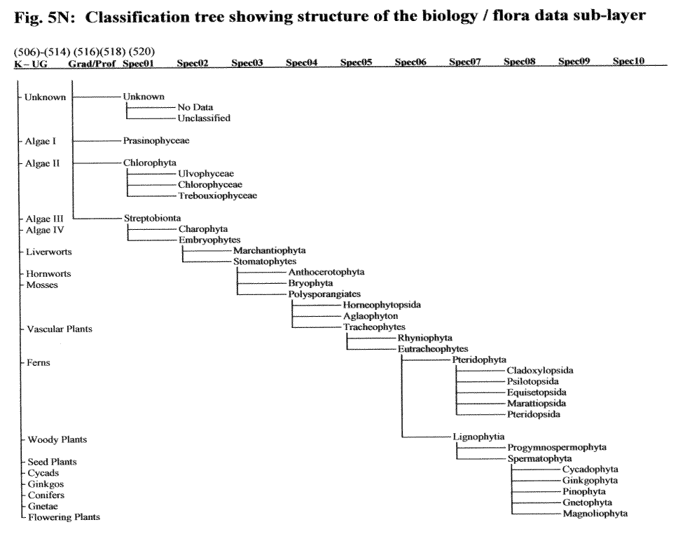

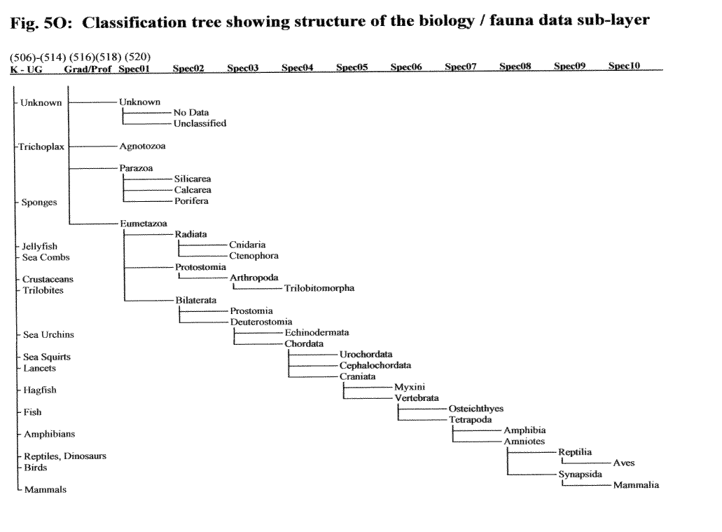

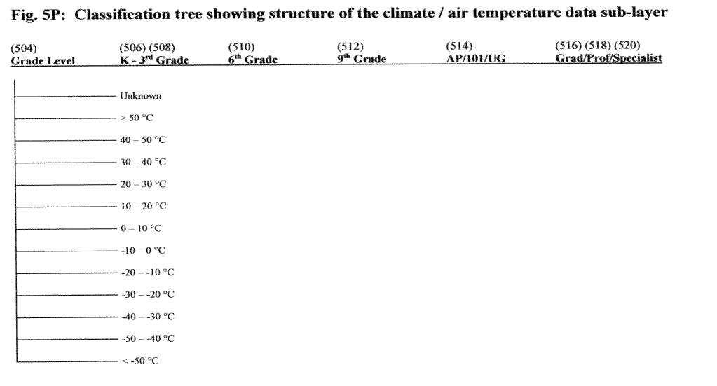

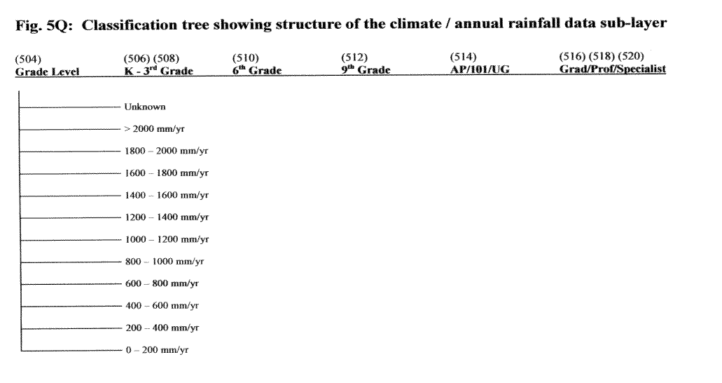

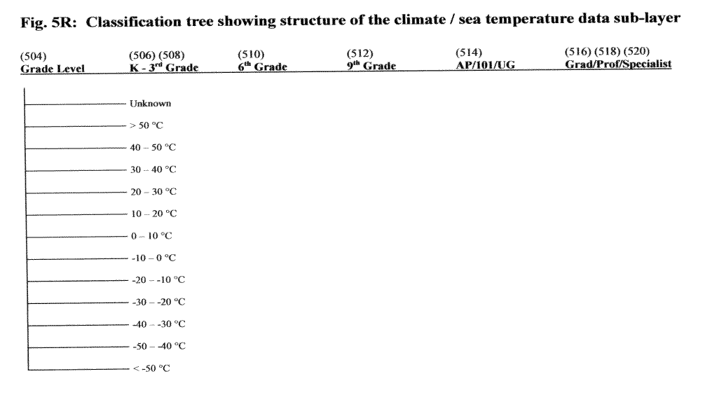

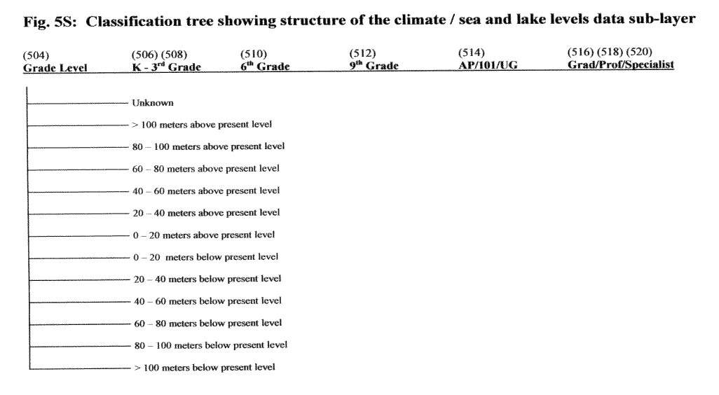

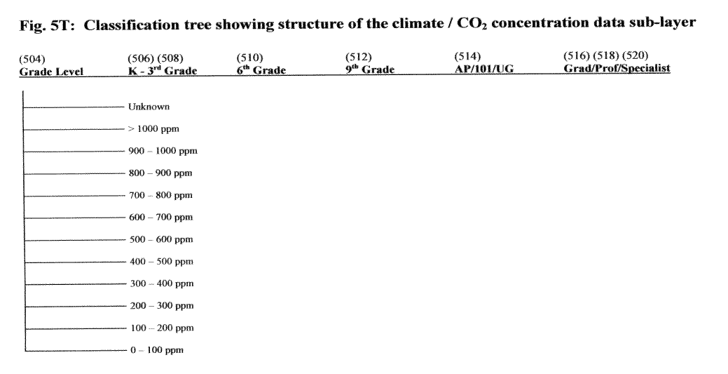

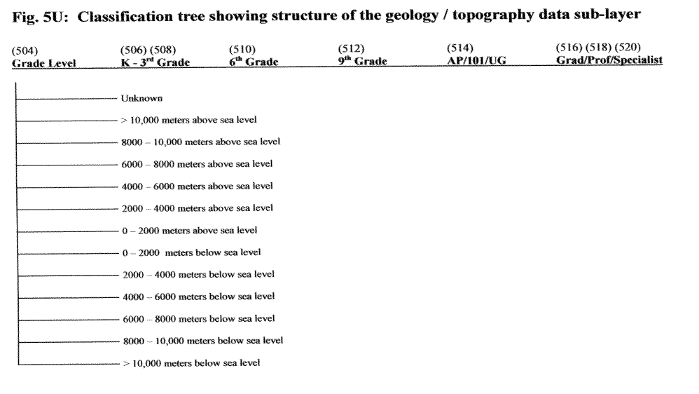

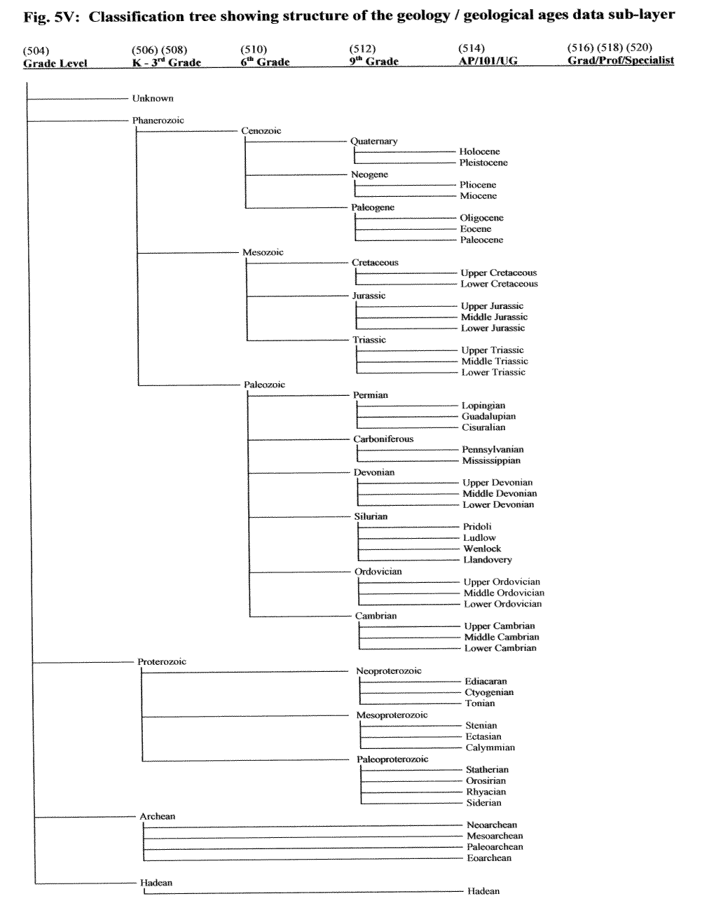

FIG. 5A is a classification tree showing the general structure of all of the data layers.

FIG. 5B is a classification tree showing the structure of the civilization data layer.

FIG. 5C is a classification tree showing the structure of the religion data layer.

FIG. 5D is a classification tree showing the structure of the government data layer.

FIG. 5E is a classification tree showing the structure of the economy data layer.

FIG. 5F is a classification tree showing the structure of the technology/food production data sub-layer.

FIG. 5G is a classification tree showing the structure of the technology/industrial production data sub-layer.

FIG. 5H is a classification tree showing the structure of the language/native language data sub-layer.

FIG. 5I is a classification tree showing the structure of the language/official language data sub-layer.

FIG. 5J is a classification tree showing the structure of the genetics/mitochondrial DNA data sub-layer.

FIG. 5K is a classification tree showing the structure of the genetics/Y-chromosome DNA data sub-layer.

FIG. 5L is a classification tree showing the structure of the biology/biome data sub-layer.

FIG. 5M is a classification tree showing the structure of the biology/land use data sub-layer.

FIG. 5N is a classification tree showing the structure of the biology/flora data sub-layer.

FIG. 5O is a classification tree showing the structure of the biology/fauna data sub-layer.

FIG. 5P is a classification tree showing the structure of the climate/air temperature data sub-layer.

FIG. 5Q is a classification tree showing the structure of the climate/annual rainfall data sub-layer.

FIG. 5R is a classification tree showing the structure of the climate/sea temperature data sub-layer.

FIG. 5S is a classification tree showing the structure of the climate/sea and lake levels data sub-layer.

FIG. 5T is a classification tree showing the structure of the climate/CO₂ concentration data sub-layer.

FIG. 5U is a classification tree showing the structure of the geology/topography data sub-layer.

FIG. 5V is a classification tree showing the structure of the geology/geological ages data sub-layer.

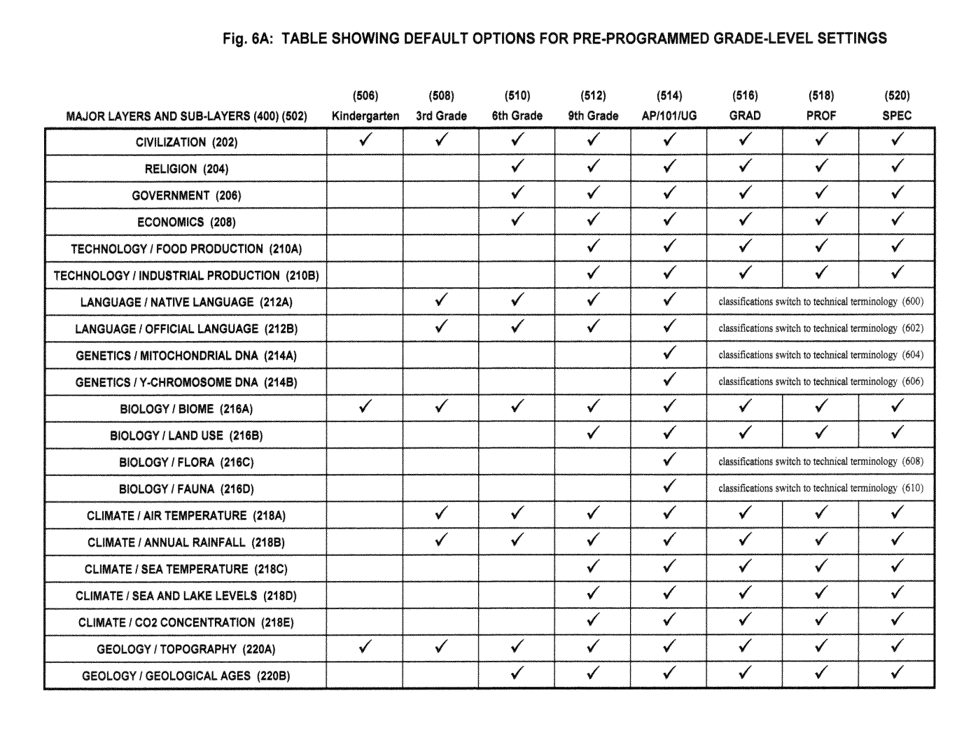

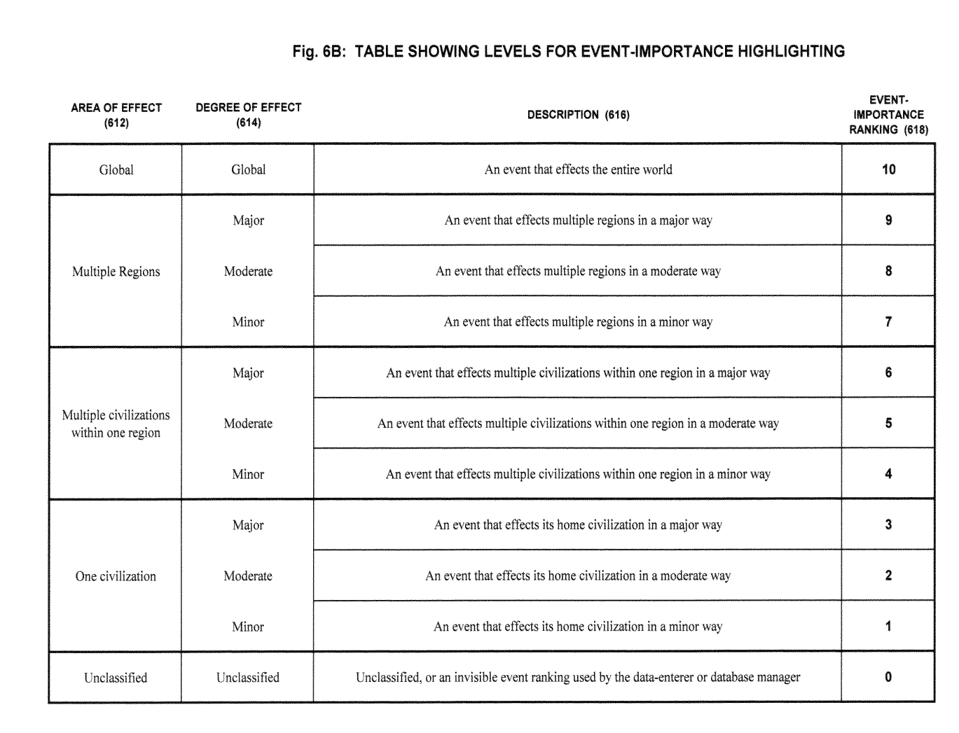

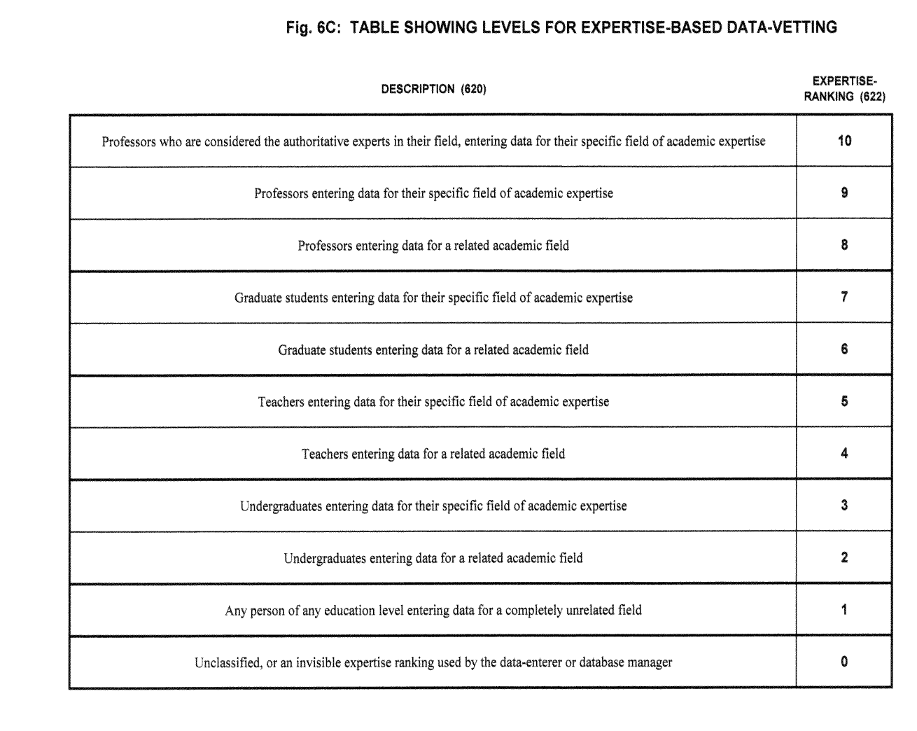

FIG. 6A is a table showing the default options for pre-programmed grade-level settings.

FIG. 6B is a table showing the levels for event-importance highlighting.

FIG. 6C is a table showing the levels for expertise-based data-vetting.

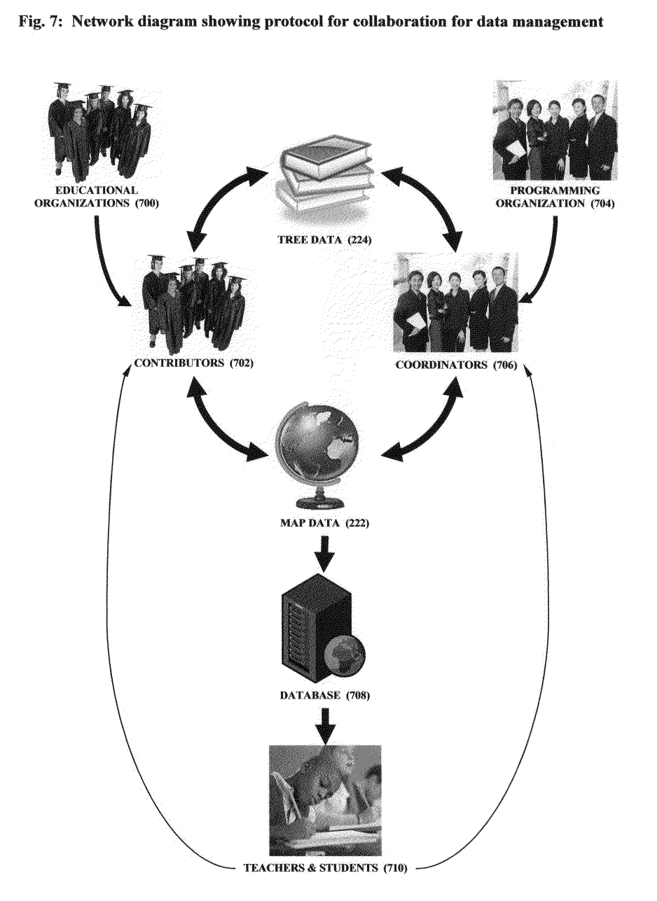

FIG. 7 is a network diagram showing the protocol for collaboration for data management.

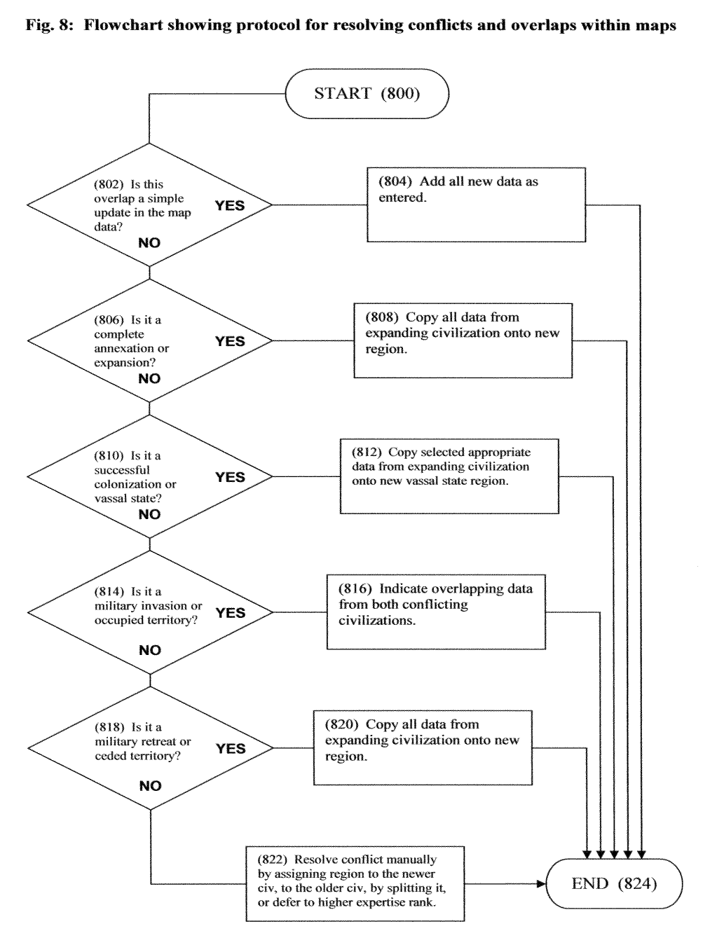

FIG. 8 is a flowchart showing the protocol for resolving conflicts and overlaps within maps.

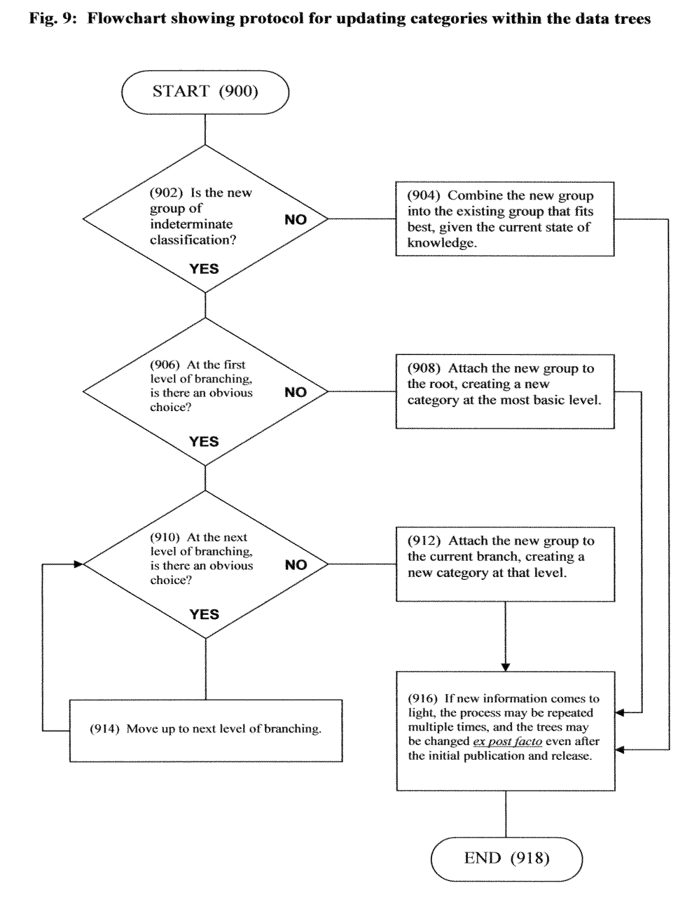

FIG. 9 is a flowchart showing the protocol for updating the categories within the data trees.

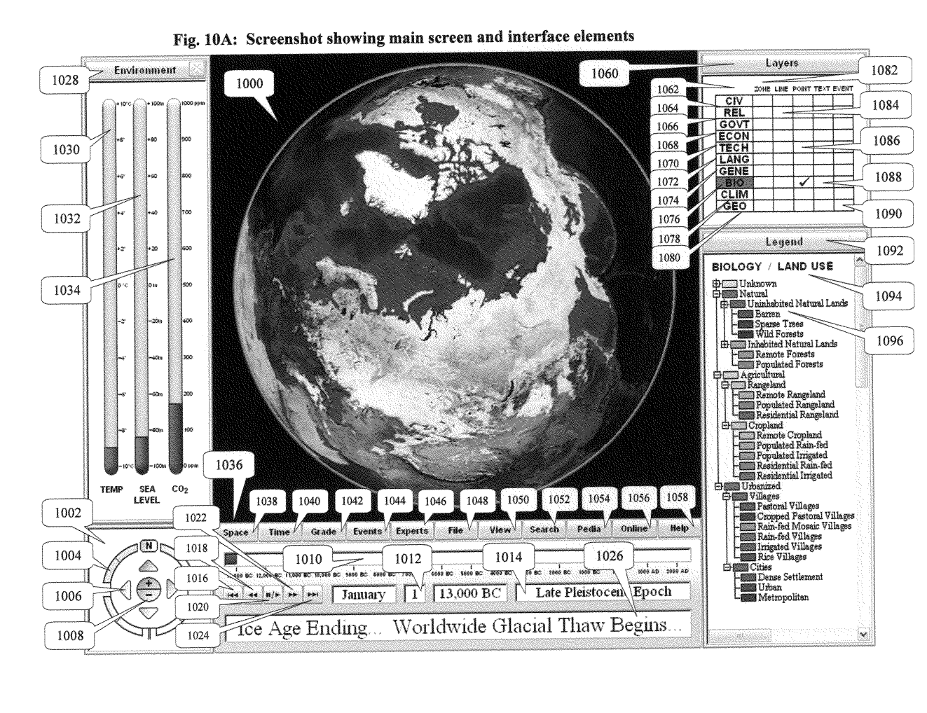

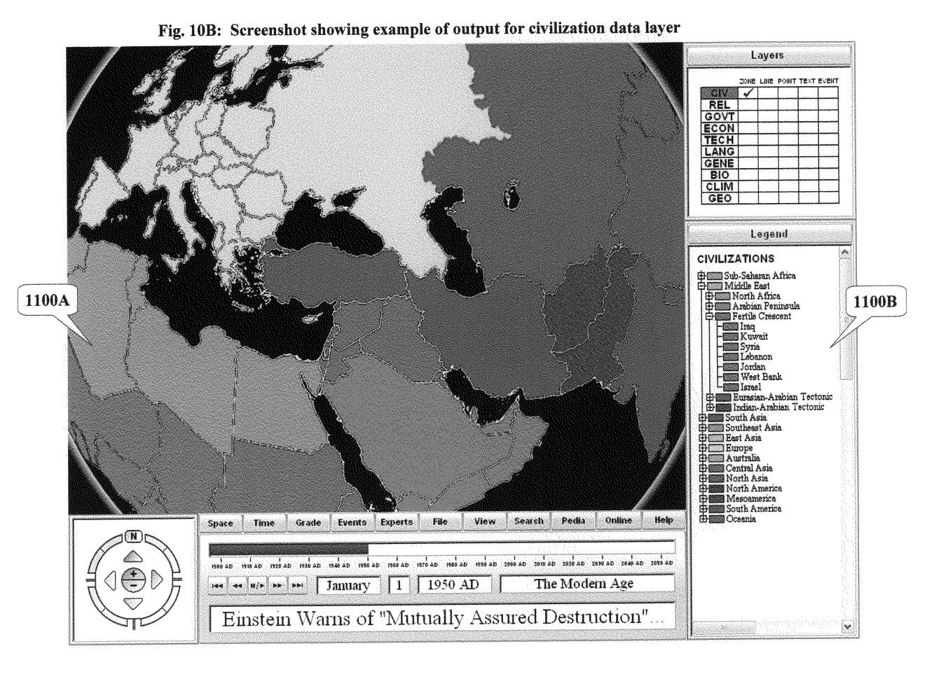

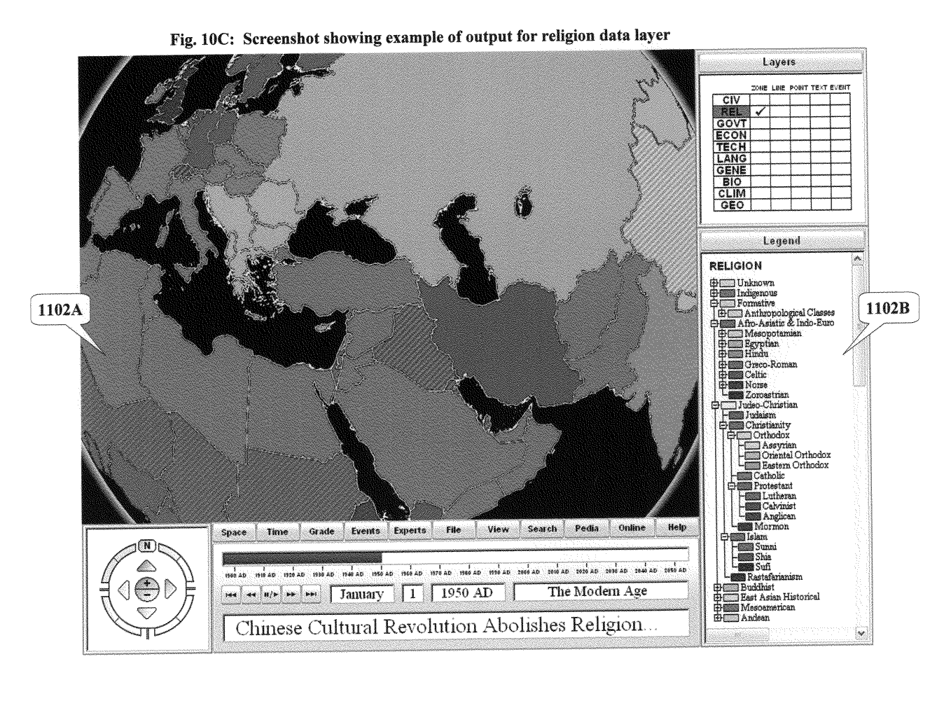

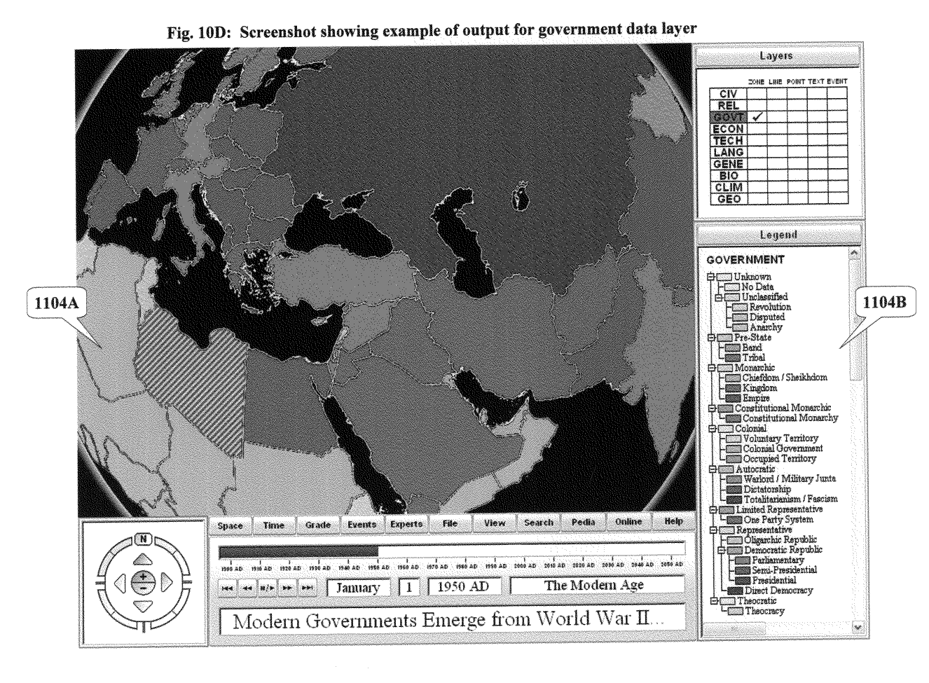

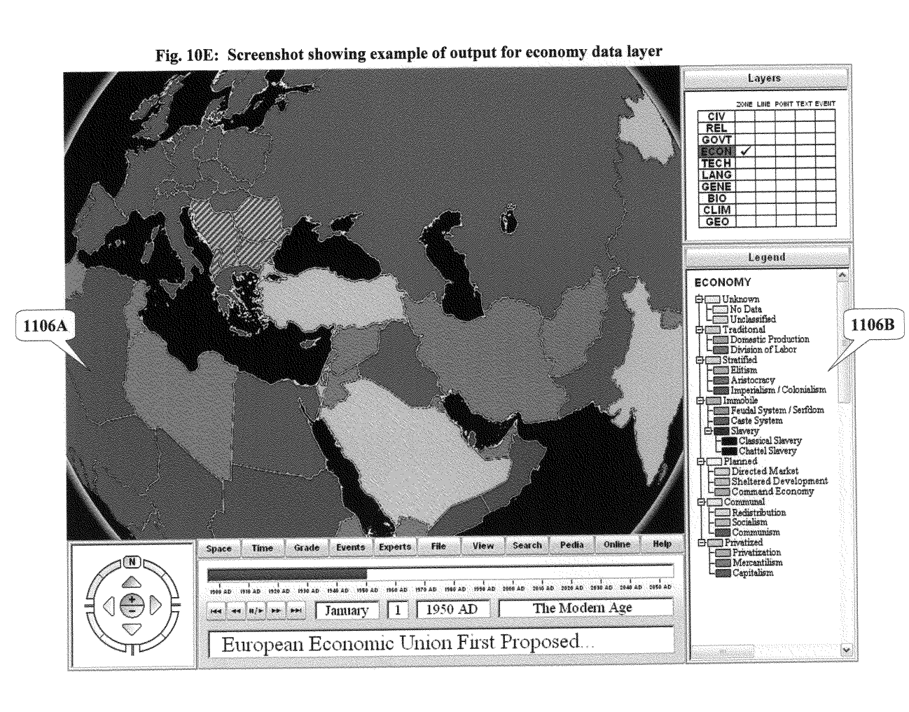

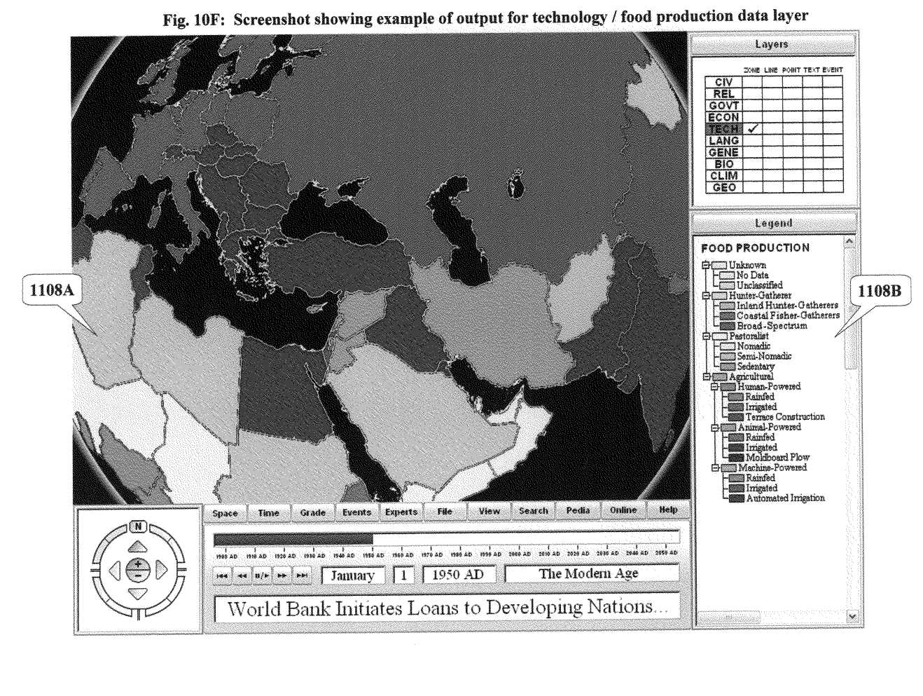

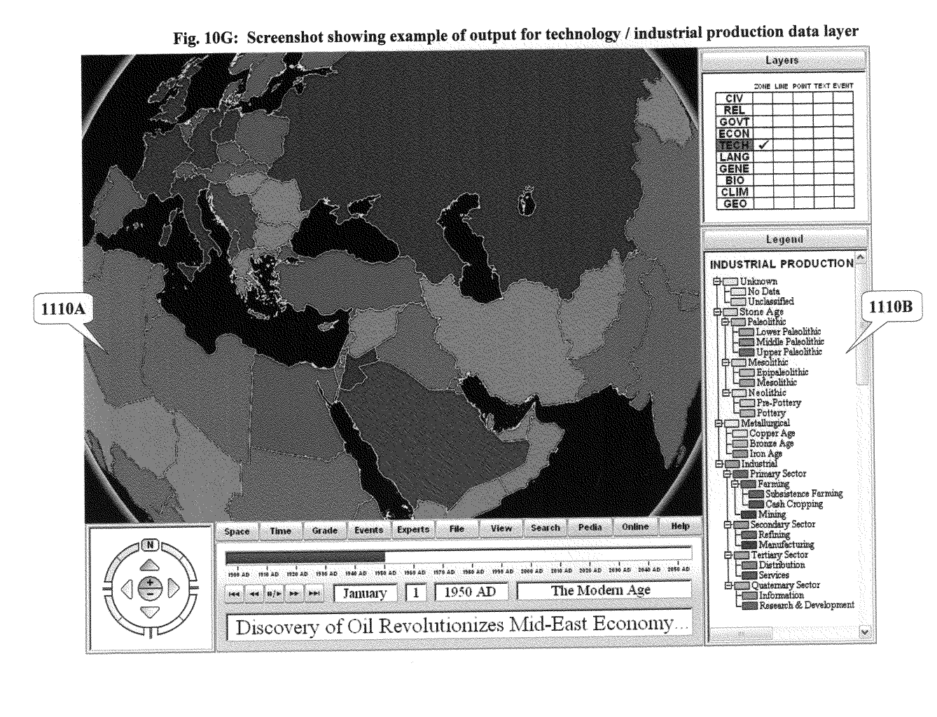

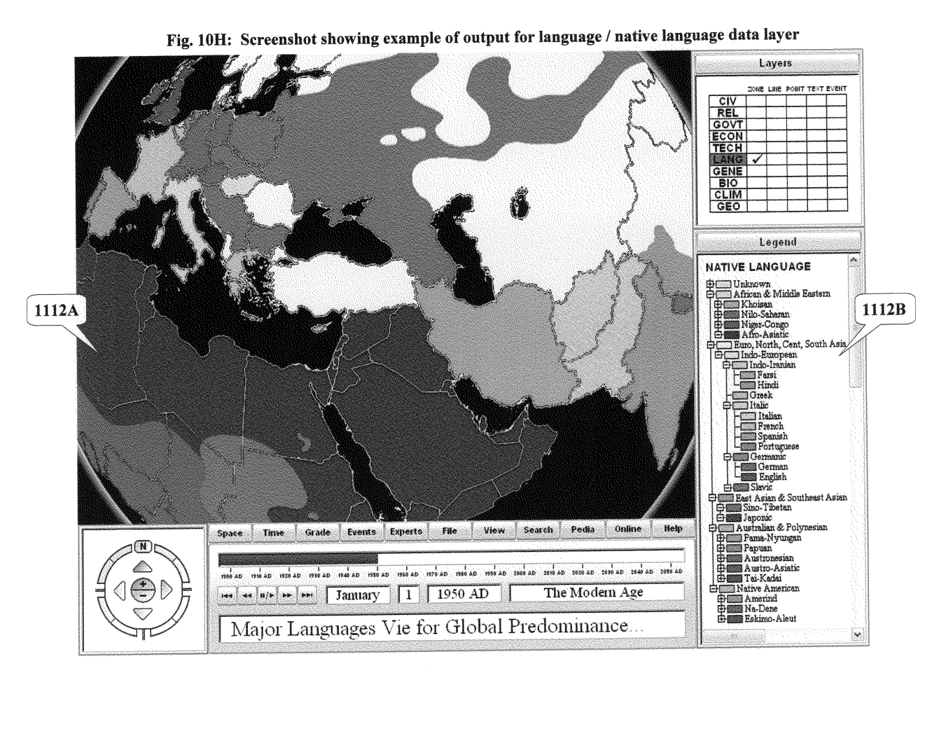

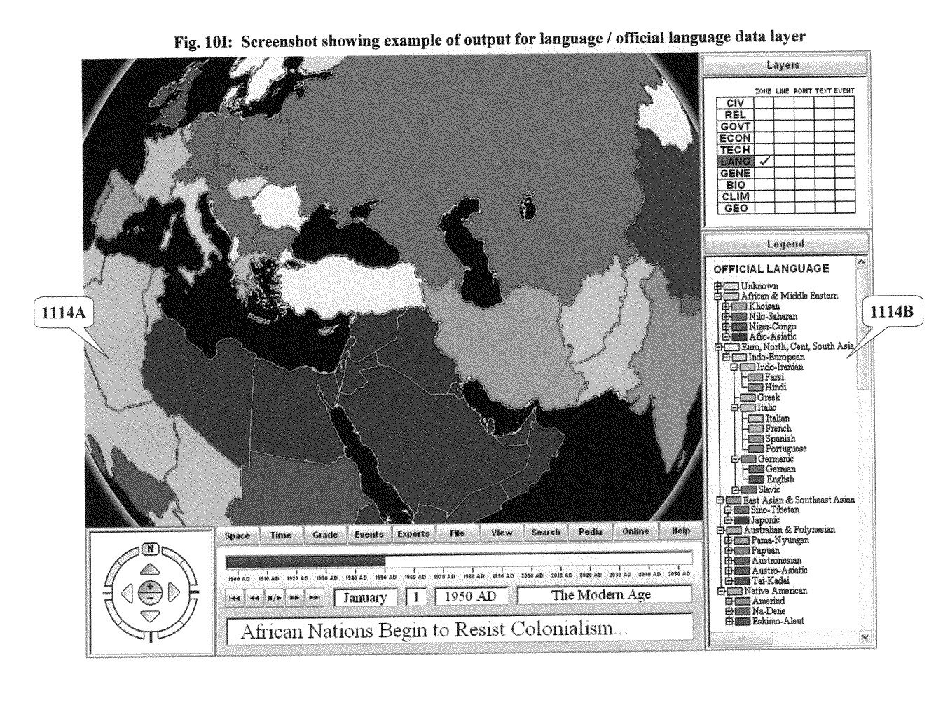

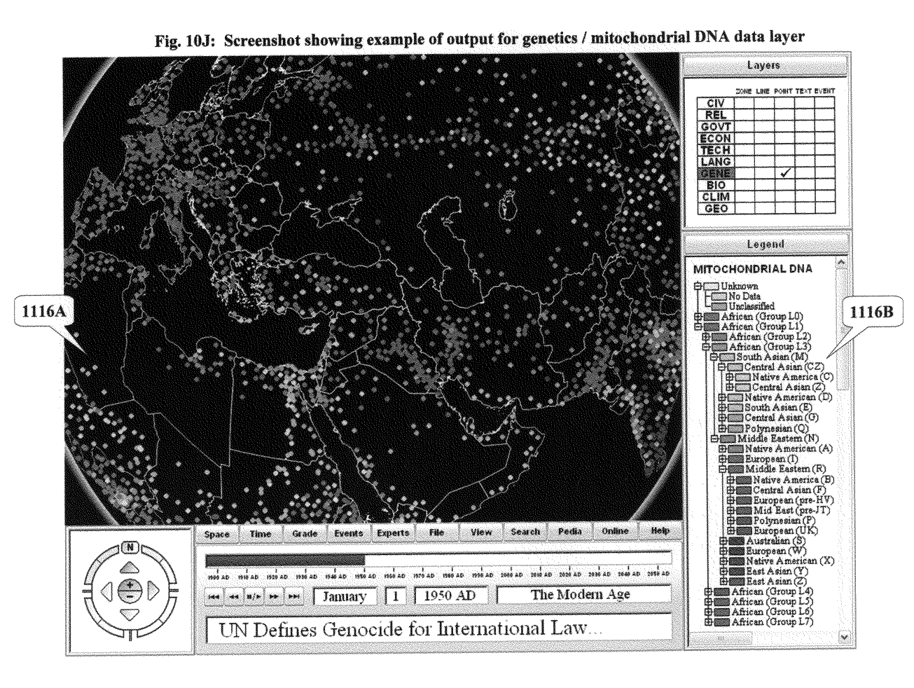

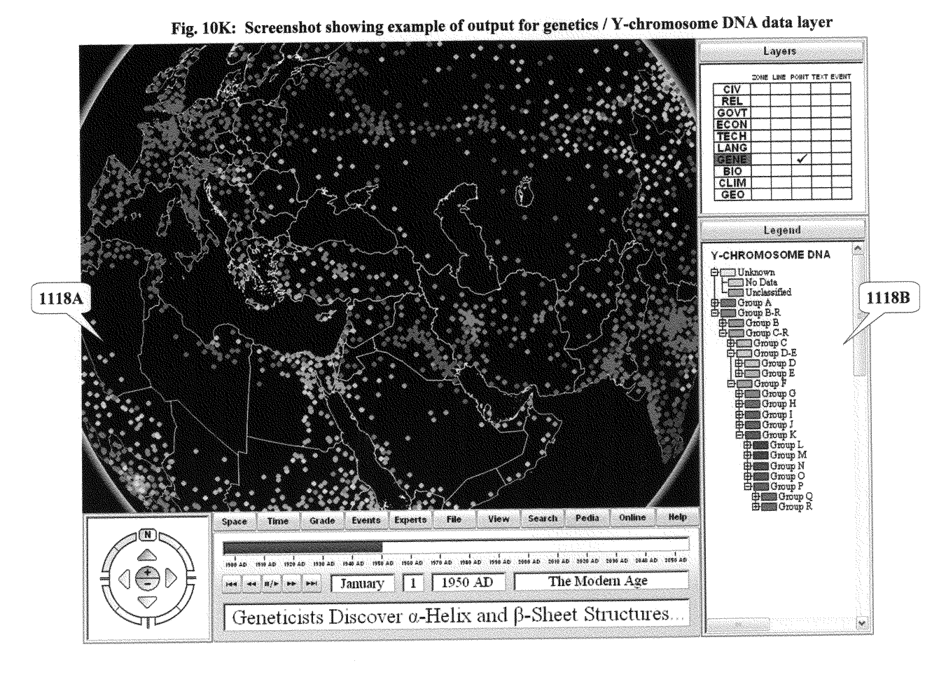

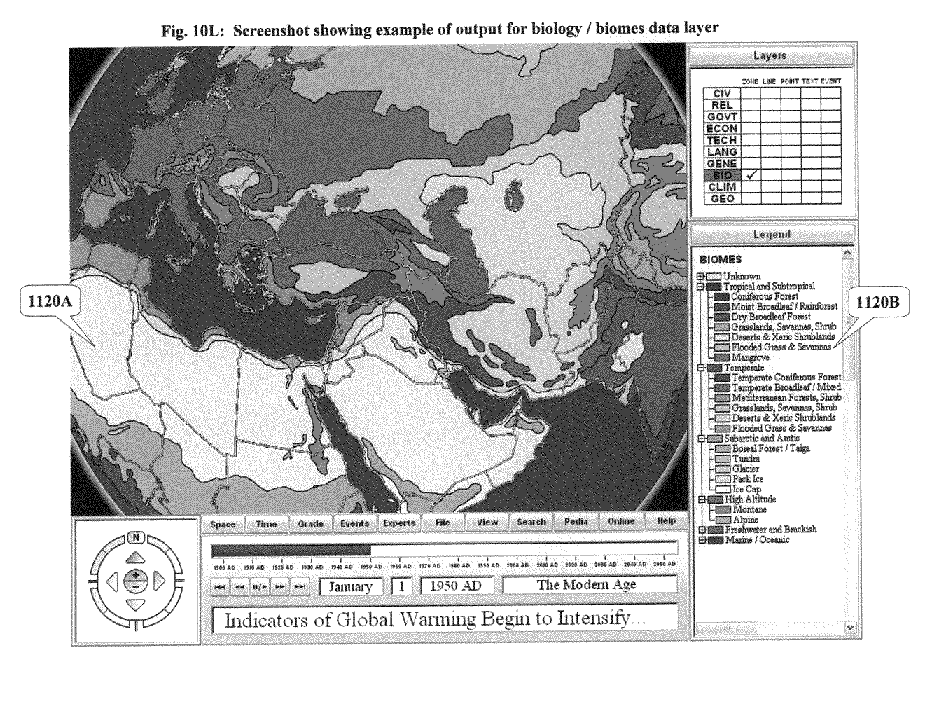

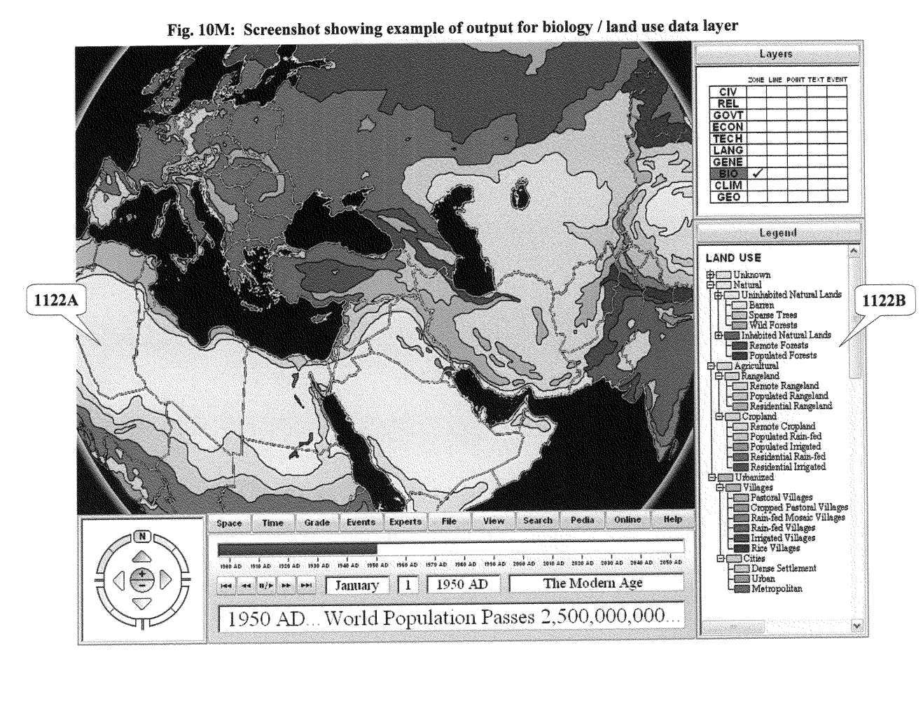

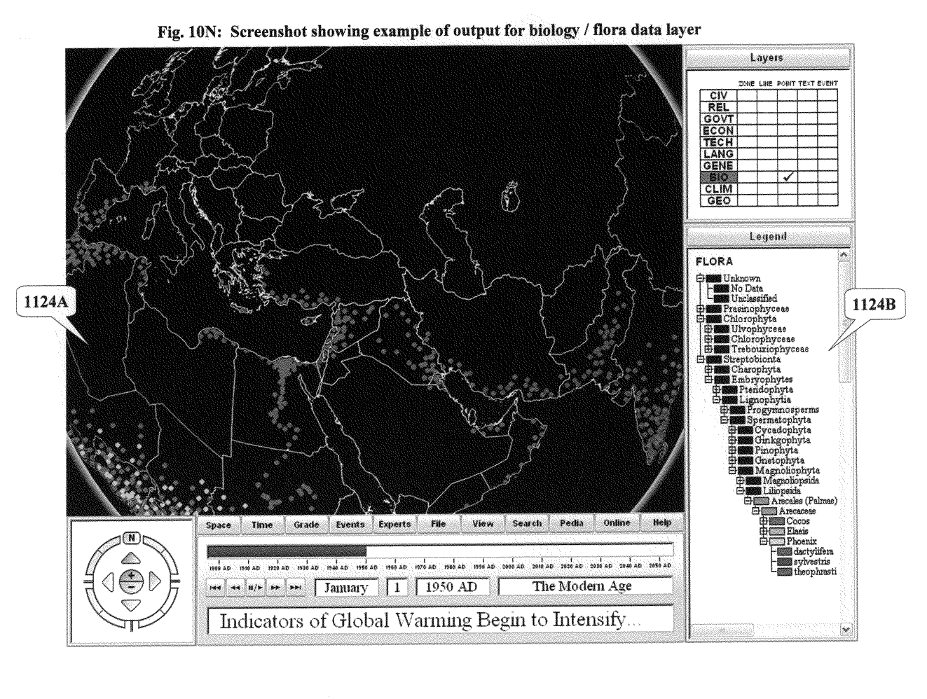

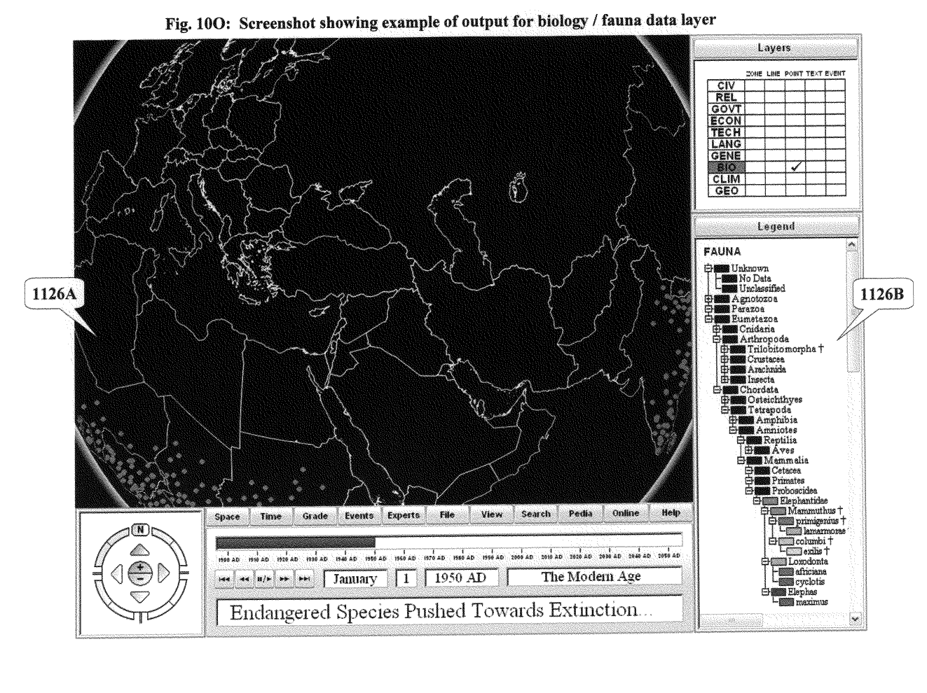

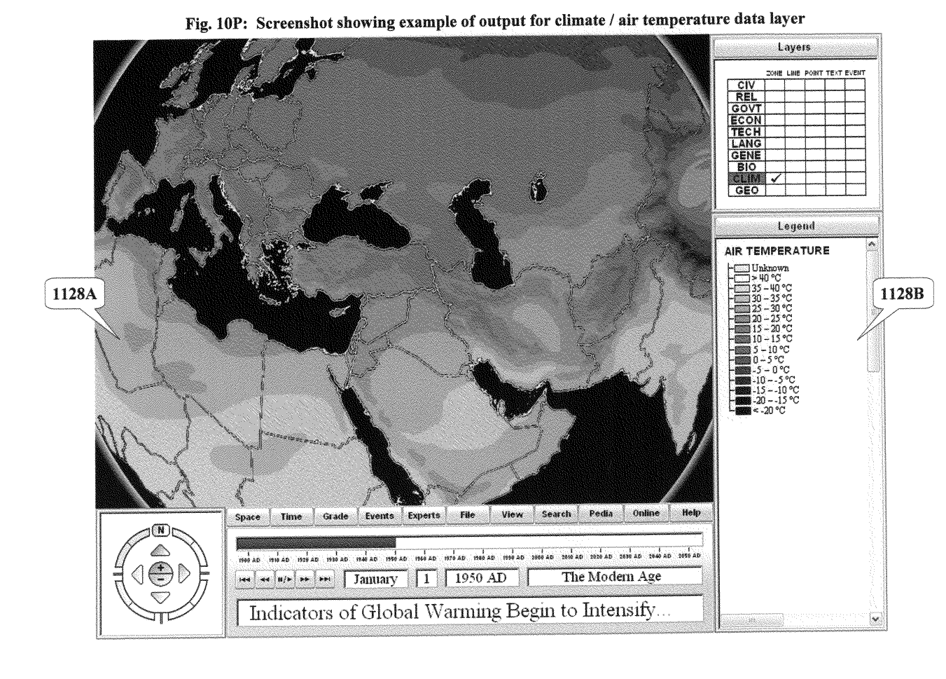

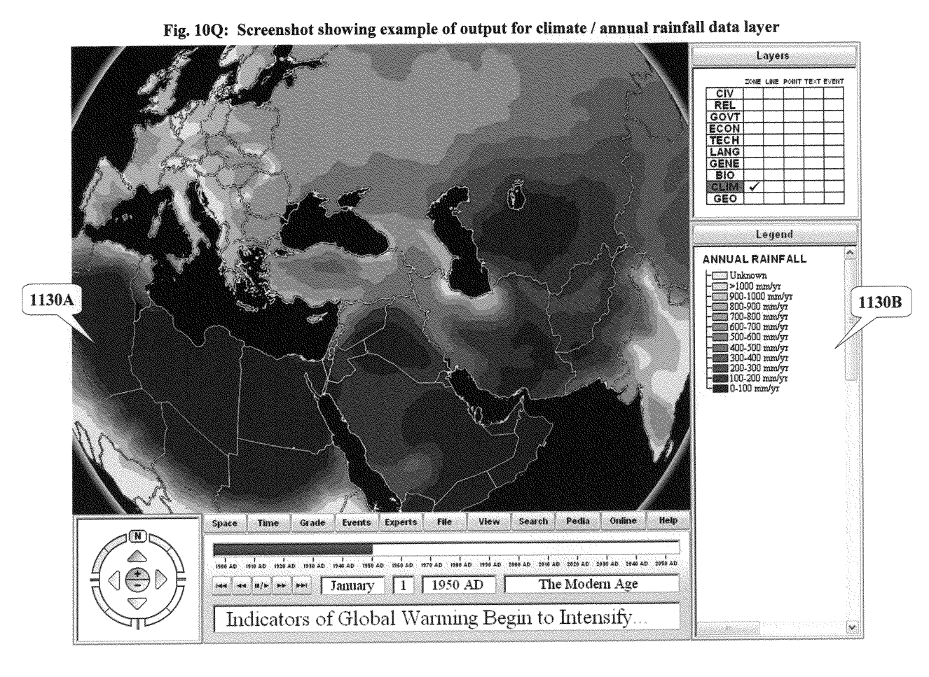

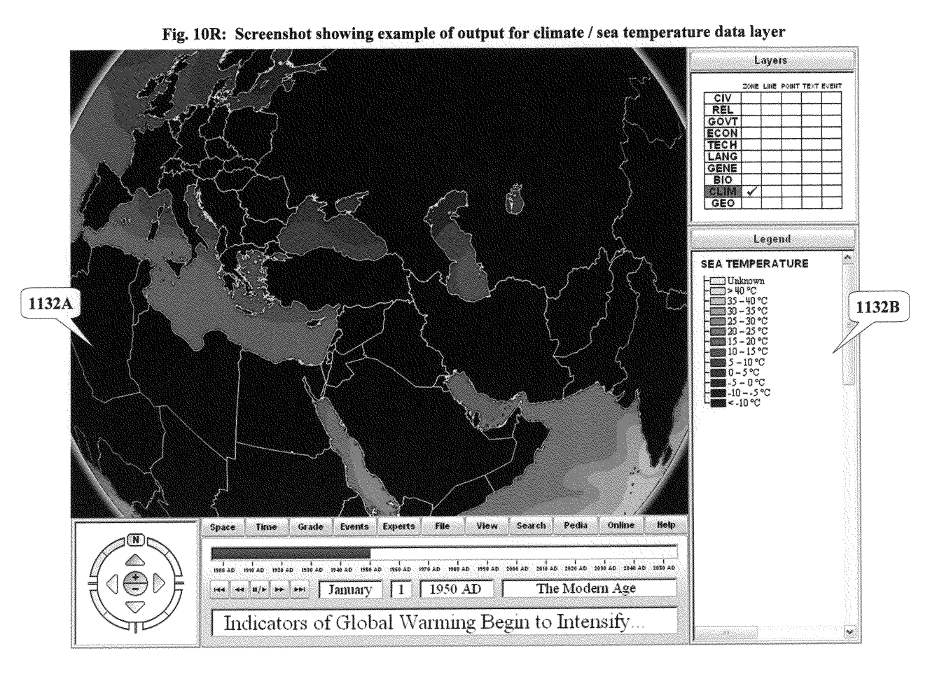

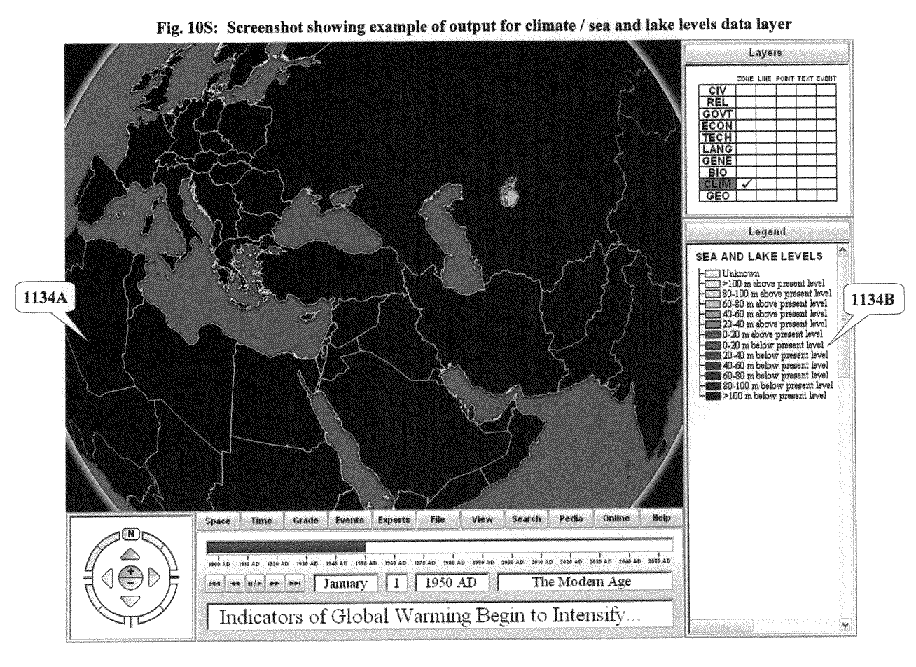

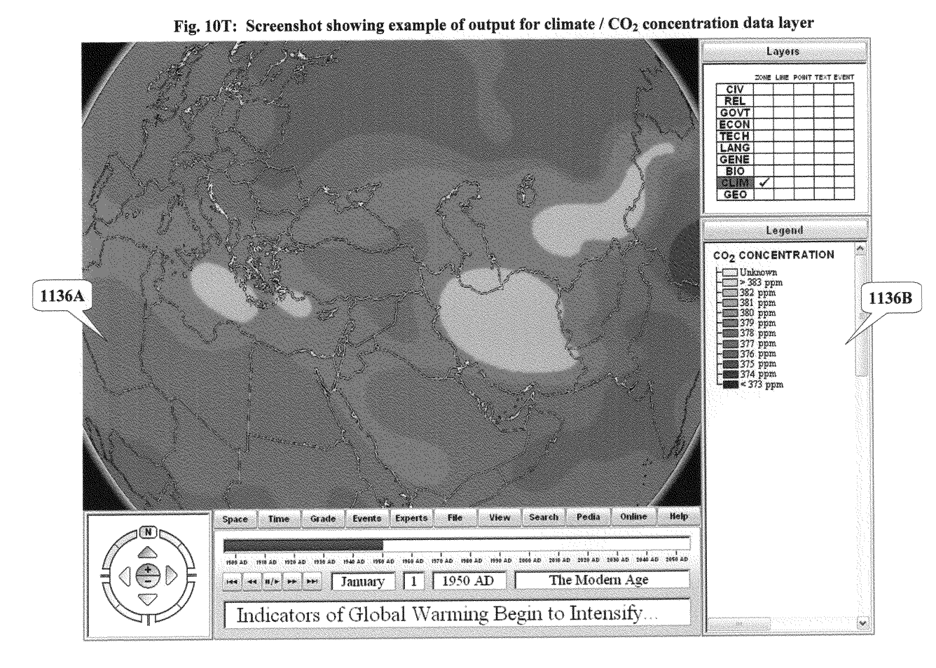

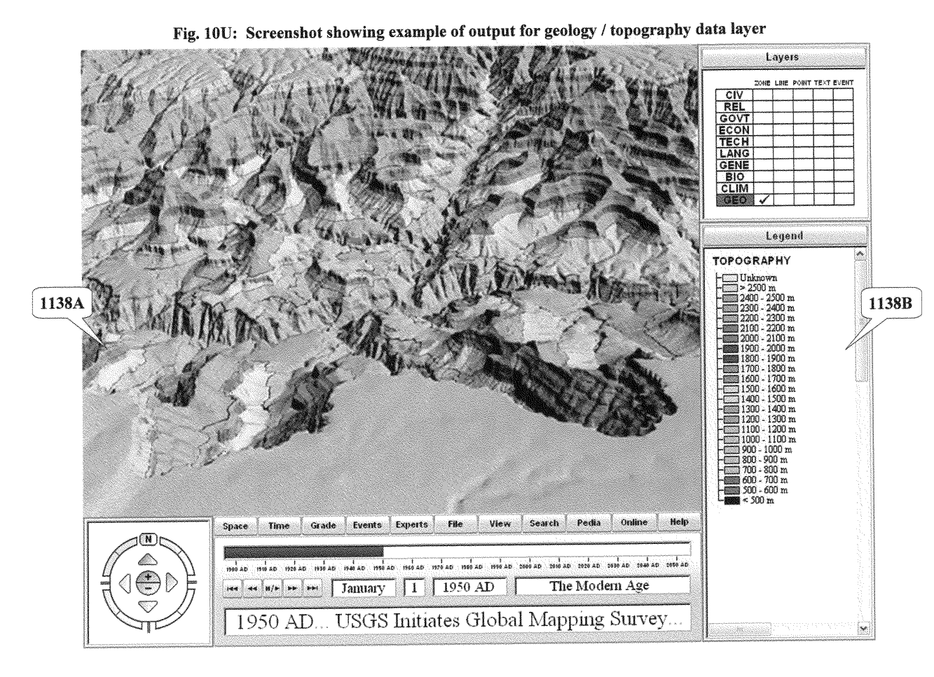

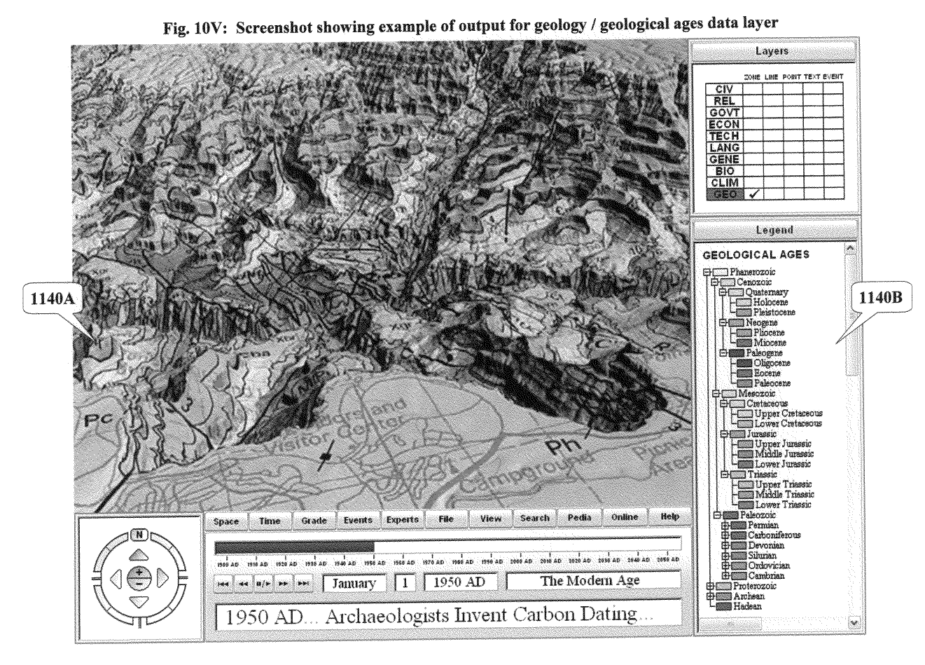

FIG. 10A is a screenshot showing the main screen and interface elements.

FIG. 10B is a screenshot showing an example of output for the civilization data layer.

FIG. 10C is a screenshot showing an example of output for the religion data layer.

FIG. 10D is a screenshot showing an example of output for the government data layer.

FIG. 10E is a screenshot showing an example of output for the economy data layer.

FIG. 10F is a screenshot showing an example of output for the technology/food production data sub-layer.

FIG. 10G is a screenshot showing an example of output for the technology/industrial production data sub-layer.

FIG. 10H is a screenshot showing an example of output for the language/native language data sub-layer.

FIG. 10I is a screenshot showing an example of output for the language/official language data sub-layer.

FIG. 10J is a screenshot showing an example of output for the genetics/mitochondrial DNA data sub-layer.

FIG. 10K is a screenshot showing an example of output for the genetics/Y-chromosome DNA data sub-layer.

FIG. 10L is a screenshot showing an example of output for the biology/biome data sub-layer.

FIG. 10M is a screenshot showing an example of output for the biology/land use data sub-layer.

FIG. 10N is a screenshot showing an example of output for the biology/flora data sub-layer.

FIG. 10O is a screenshot showing an example of output for the biology/fauna data sub-layer.

FIG. 10P is a screenshot showing an example of output for the climate/air temperature data sub-layer.

FIG. 10Q is a screenshot showing an example of output for the climate/annual rainfall data sub-layer.

FIG. 10R is a screenshot showing an example of output for the climate/sea temperature data sub-layer.

FIG. 10S is a screenshot showing an example of output for the climate/sea and lake levels data sub-layer.

FIG. 10T is a screenshot showing an example of output for the climate/CO₂ concentration data sub-layer.

FIG. 10U is a screenshot showing an example of output for the geology/topography data sub-layer.

FIG. 10V is a screenshot showing an example of output for the geology/geological ages data sub-layer.

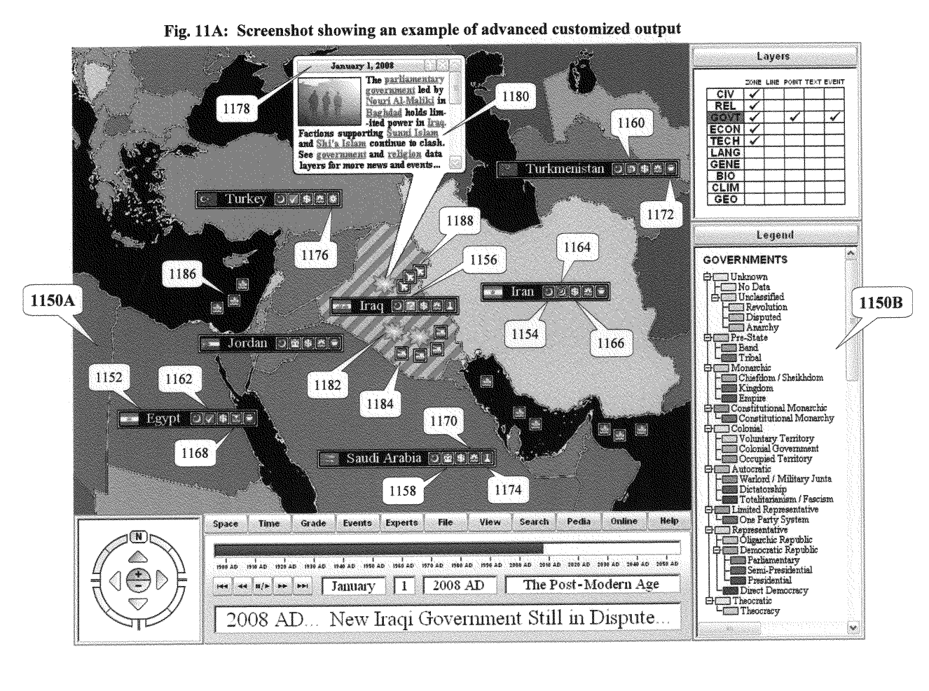

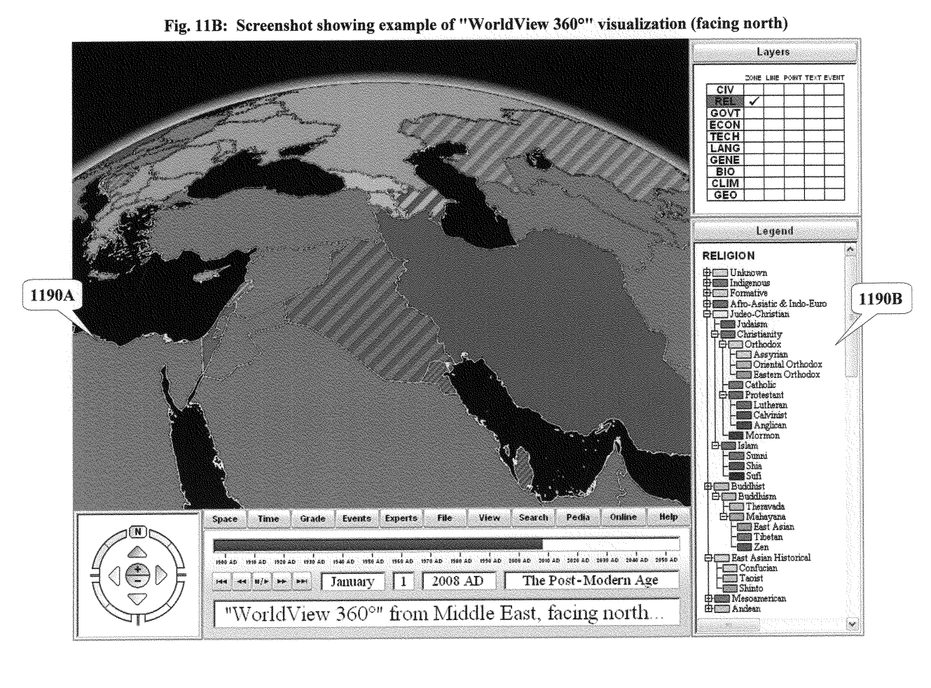

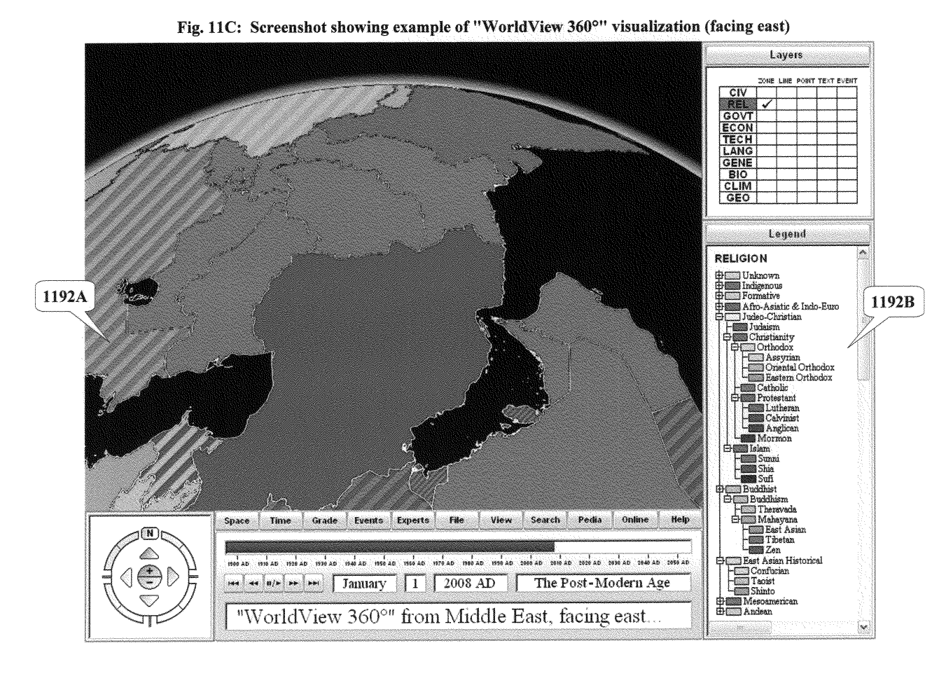

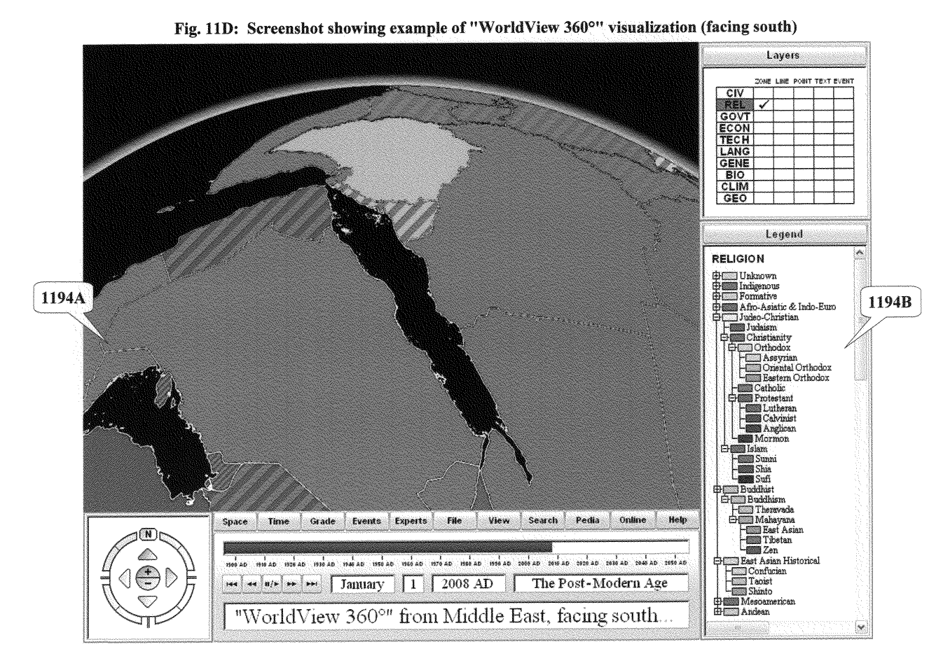

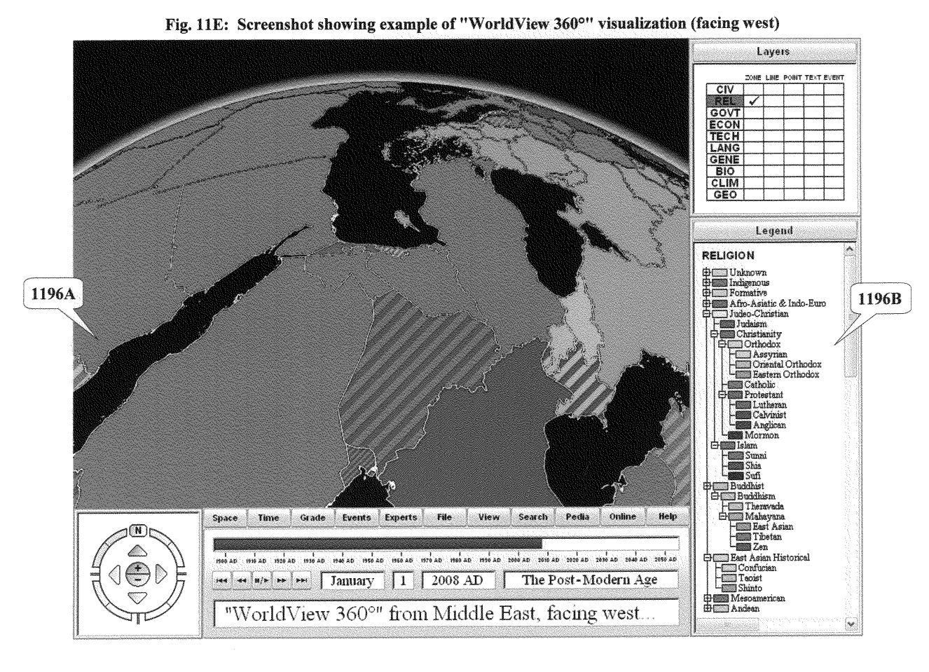

FIG. 11A is a screenshot showing an example of advanced customized output.

FIG. 11B is a screenshot showing one frame of an example of the “WorldView 360°” visualization (facing north).

FIG. 11C is a screenshot showing one frame of an example of the “WorldView 360°” visualization (facing east).

FIG. 11D is a screenshot showing one frame of an example of the “WorldView 360°” visualization (facing south).

FIG. 11E is a screenshot showing one frame of an example of the “WorldView 360°” visualization (facing west).

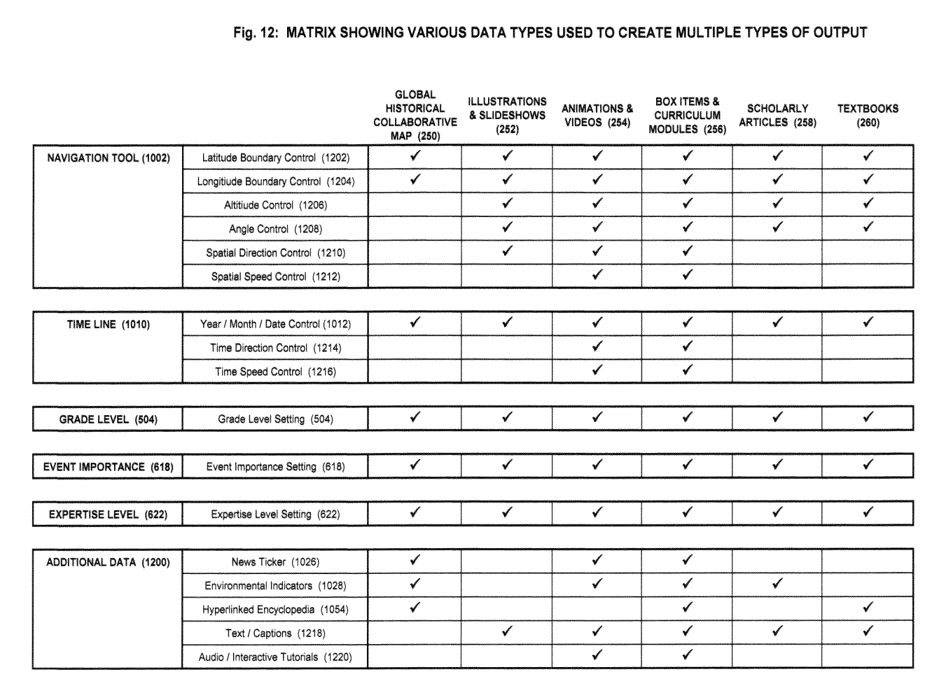

FIG. 12 is a matrix showing the data types that may be used to create multiple types of output using this system and method.

### DRAWINGS

### Reference Numerals

### FIG. 1: Prior Art: Screenshot Showing Example of Output for NASA WorldWind

100 PRIOR ART: map area for NASA WorldWind
102 PRIOR ART: legend area for NASA WorldWind

### FIG. 2: Introduction: Network Diagram Showing Complete System and Method in Chronological Order

200 researchers in all academic disciplines
202 CIVILIZATION data layer
204 RELIGION data layer
206 GOVERNMENT data layer
208 ECONOMY data layer
210 TECHNOLOGY data layers
210A FOOD PRODUCTION data sub-layer
210B INDUSTRIAL PRODUCTION data sub-layer
212 LANGUAGE data layers
212A NATIVE LANGUAGE data sub-layer
212B OFFICIAL LANGUAGE data sub-layer
214 GENETICS data layers
214A MITOCHONDRIAL DNA data sub-layer
214B Y-CHROMOSOME DNA data sub-layer
216 BIOLOGY data layers
216A BIOME data sub-layer
216B LAND USE data sub-layer
216C FLORA data sub-layer
216D FAUNA data sub-layer
218 CLIMATE data layers
218A AIR TEMPERATURE data sub-layer
218B ANNUAL RAINFALL data sub-layer
218C SEA TEMPERATURE data sub-layer
218D SEA AND LAKE LEVELS data sub-layer
218E CO₂ CONCENTRATION data sub-layer
220 GEOLOGY data layers
220A TOPOGRAPHY data sub-layer
220B GEOLOGICAL AGES data sub-layer
222 map data
224 text data
226 INPUT phase of operations
228 STRUCTURING sub-phase of operations
230 CLASSIFICATION sub-phase of operations
232 SORTING sub-phase of operations
234 FILTERING sub-phase of operations
236 VERIFICATION sub-phase of operations
238 STORAGE phase of operations
240 COMPILING sub-phase of operations
242 UPDATING sub-phase of operations
244 OUTPUT phase of operations
246 CUSTOMIZING sub-phase of operations
248 PUBLICATION sub-phase of operations
250 global historical collaborative animated map
252 illustrations & slideshows
254 animations & videos
256 box-items & curriculum modules
258 scholarly articles
260 customizable textbooks
262 students of all ages and nations

### FIG. 3: Input: Flowchart Showing Innovative Process for Inputting Georeferenced Historical Data

300-344 (flowchart steps shown in order)

### FIG. 4: Structuring: Table Showing Information Types Contained in all Data Layers

400 name of major data layer
402 polygon data
404 line, point & text data
406 exact fields of academic expertise

### FIGS. 5A-5V: Classification: Classification Tree Showing General Structure of all Data Layers

500 data tree structure
502 name of data sub-layer
504 pre-programmed grade-level settings
506 pre-programmed grade-level setting for kindergarten
508 pre-programmed grade-level setting for 3^{rd} grade
510 pre-programmed grade-level setting for 6^{th} grade
512 pre-programmed grade-level setting for 9^{th} grade
514 pre-programmed grade-level setting for AP/101/undergraduates
516 pre-programmed grade-level setting for graduate students
518 pre-programmed grade-level setting for professors
520 pre-programmed grade-level settings for specialists

### FIG. 6A: Sorting: Table Showing Default Options for Pre-Programmed Grade-Level Settings

600 technical terminology switch trigger for language/native language data layer
602 technical terminology switch trigger for language/official language data layer
604 technical terminology switch trigger for genetics/mitochondrial DNA data layer
606 technical terminology switch trigger for genetics/Y-chromosome DNA data layer
608 technical terminology switch trigger for biology/flora language data layer
610 technical terminology switch trigger for biology/fauna data layer

### FIG. 6B: Filtering: Table Showing Levels for Event-Importance Highlighting

612 area of effect for event-importance ranking
614 degree of effect for event-importance ranking
616 description for event-importance ranking
618 levels for event-importance ranking

### FIG. 6C: Verification: Table Showing Levels for Expertise-Based Data-Vetting

620 description for expertise-based data-vetting
622 levels for expertise-based data-vetting

### FIG. 7: Storage: Network Diagram Showing Collaboration for Data Management

700 educational organization
702 contributors
704 programming organization
706 coordinators
708 database
710 teachers & students

### FIG. 8: Compiling: Flowchart Showing Process for Resolving Conflicts on Maps

800-824 (flowchart steps shown in order)

### FIG. 9: Updating: Flowchart Showing Process for Adding New Categories to Data Trees

900-918 (flowchart steps shown in order)

### FIG. 10A: Output: Screenshot Showing Main Screen and Interface Elements

1000 map area
1002 navigation tool
1004 compass ring
1006 navigation buttons
1008 zoom buttons
1010 timeline tool
1012 date readout
1014 historical period indicator
1016 back to previous event button
1018 reverse button
1020 play/pause button
1022 fast forward button
1024 forward to next event button
1026 news-ticker
1028 climate data indicators window
1030 air temperature data indicator
1032 sea level data indicator
1034 CO₂ concentration data indicator
1036 menu area
1038 “Space” button
1040 “Time” button
1042 “Grade” button
1044 “Events” button
1046 “Experts” button
1048 “File” button
1050 “View” button
1052 “Search” button
1054 “Pedia” button
1056 “Online” button
1058 “Help” button
1060 layer selection window
1062 “CIV” button
1064 “REL” button
1066 “GOVT” button
1068 “ECON” button
1070 “TECH” button
1072 “LANG” button
1074 “GENE” button
1076 “BIO” button
1078 “CLIM” button
1080 “GEO” button
1082 “ZONE” column
1084 “LINE” column
1086 “POINT” column
1088 “TEXT” column
1090 “EVENT” column
1092 legend window
1094 legend title
1096 legend tree

### FIG. 10B-V: Output: Screenshots Showing Examples of Output for all Data Layers

1100A map for CIVILIZATION data layer example output
1100B legend for CIVILIZATION data layer example output
1102A map for RELIGION data layer example output
1102B legend for RELIGION data layer example output
1104A map for GOVERNMENT data layer example output
1104B legend for GOVERNMENT data layer example output
1106A map for ECONOMY data layer example output
1106B legend for ECONOMY data layer example output
1108A map for TECHNOLOGY/FOOD PRODUCTION data layers example output
1108B legend for TECHNOLOGY/FOOD PRODUCTION data sub-layer example output
1110A map for TECHNOLOGY/INDUSTRIAL PRODUCT data sub-layer example output
1110B legend for TECHNOLOGY/INDUSTRIAL PRODUCT data sub-layer example output
1112A map for LANGUAGE/NATIVE LANGUAGE data sub-layer example output
1112B legend for LANGUAGE/NATIVE LANGUAGE data sub-layer example output
1114A map for LANGUAGE/OFFICIAL LANGUAGE data sub-layer example output
1114B legend for LANGUAGE/OFFICIAL LANGUAGE data sub-layer example output
1116A map for GENETICS/MITOCHONDRIAL DNA data sub-layer example output
1116B legend for GENETICS/MITOCHONDRLAL DNA data sub-layer example output
1118A map for GENETICS/Y-CHROMOSOME DNA data sub-layer example output
1118B legend for GENETICS/Y-CHROMOSOME DNA data sub-layer example output
1120A map for BIOLOGY/BIOME data sub-layer example output
1120B legend for BIOLOGY/BIOME data sub-layer example output
1122A map for BIOLOGY/LAND USE data sub-layer example output
1122B legend for BIOLOGY/LAND USE data sub-layer example output
1124A map for BIOLOGY/FLORA data sub-layer example output
1124B legend for BIOLOGY/FLORA data sub-layer example output
1126A map for BIOLOGY/FAUNA data sub-layer example output
1126B legend for BIOLOGY/FAUNA data sub-layer example output
1128A map for CLIMATE/AIR TEMPERATURE data sub-layer example output
1128B legend for CLIMATE/AIR TEMPERATURE data sub-layer example output
1130A map for CLIMATE/ANNUAL RAINFALL data sub-layer example output
1130B legend for CLIMATE/ANNUAL RAINFALL data sub-layer example output
1132A map for CLIMATE/SEA TEMPERATURE data sub-layer example output
1132B legend for CLIMATE/SEA TEMPERATURE data sub-layer example output
1134A map for CLIMATE/SEA AND LAKE LEVELS data sub-layer example output
1134B legend for CLIMATE/SEA AND LAKE LEVELS data sub-layer example output
1136A map for CLIMATE/CO₂ CONCENTRATION data sub-layer example output
1136B legend for CLIMATE/CO₂ CONCENTRATION data sub-layer example output
1138A map for GEOLOGY/TOPOGRAPHY data sub-layer example output
1138B legend for GEOLOGY/TOPOGRAPHY data sub-layer example output
1140A map for GEOLOGY/GEOLOGICAL AGES data sub-layer example output
1140B legend for GEOLOGY/GEOLOGICAL AGES data sub-layer example output

### FIG. 11A: Customizing: Screenshot Showing Example of Advanced Customized Output

1150A map for example of customized output using government data layer
1150B legend for example of customized output using government data layer
1152 civilization banners
1154 icon for “Islam” religion
1156 icon for “disputed” government
1158 icon for “kingdom” government
1160 icon for “autocracy” government
1162 icon for “republic” government
1164 icon for “theocracy” government
1166 icon for “capitalism” economy
1168 icon for “animal-powered irrigated” food production
1170 icon for “machine-powered irrigated” food production
1172 icon for “mining” industrial production
1174 icon for “refining” industrial production
1176 icon for “manufacturing” industrial production
1178 geo-referenced date-referenced event pop-up
1180 hyperlinks to internal encyclopedia and outside sources
1182 icon for violence or battle
1184 icon for modern era army unit
1186 icon for modern era naval unit
1188 icon for modern era air force unit
   FIG. 11B-E: Customizing: Screenshots with Example of “WorldView 360°” Visualization (N,E,S,W)
1190A map for example of “WorldView 360°” visualization using religion data layer (facing north)
1190B legend for example of “WorldView 360°” visualization using religion data layer (facing north)
1192A map for example of “WorldView 360°” visualization using religion data layer (facing east)
1192B legend for example of “WorldView 360°” visualization using religion data layer (facing east)
1194A map for example of “WorldView 360°” visualization using religion data layer (facing south)
1194B legend for example of “WorldView 360°” visualization using religion data layer (facing south)
1196A map for example of “WorldView 360°” visualization using religion data layer (facing west)
1196B legend for example of “WorldView 360°” visualization using religion data layer (facing west)

### FIG. 12: Publication: Matrix Showing Data Types Used to Create Multiple Types of Output

1200 additional data
1202 latitude boundaries control
1204 longitude boundaries control
1206 altitude control
1208 angle control
1210 spatial direction control
1212 spatial speed control
1214 time direction control
1216 time speed control
1218 additional text/interactive captions
1220 additional audio/interactive tutorials

### DETAILED DESCRIPTION

### Introduction

In accordance with a number of embodiments, this document presents an innovative system and method which may be used to input data relating to any number of historical or scientific subjects, store the data in a collaborative format, and output data in any number of static or animated formats. In various embodiments, this method may provide a revolutionary means for encoding the entire history of the earth, encoding the entire history of human cultures, and for ensuring that all input data adhere to a universal data format. It provides and specifies a number of innovative and collaborative protocols for input, storage, classification, sorting, filtering, verifying, compiling, updating, customizing, and publishing data. It may also provide a means for creating a revolutionary format of global historical collaborative animated map. It may be used widely in various applications, including but not limited to education, journalism, governments, international business, and international relations.

It may also include a guided graphic user interface that provides a means for visual template-based data-entry with a guided graphic user interface, categorized data trees, customizable depth of detail, pre-programmed grade-level settings, event-importance highlighting, and expertise-based data-vetting. It may be used to create tools for curriculum development, or a wide variety of interactive multimedia presentations.

These innovations may allow an instructor or user to view the sum total of the historical knowledge of humankind on a virtual globe that can be easily visualized and studied, with the ability to choose any region of focus, or to choose any period of time, or to select any category of study, or to show any type of information to any interactive level of detail, or at any desired grade level, or within any specified level of historical importance, or with a sufficient level of vetting by experts for scientific accuracy.

It may present information that every citizen of the modern world needs to know, but in a way that may be in various embodiments and using various parameters, more accurate, more visual, more intuitive, more comprehensible, more retainable, more teachable, more encyclopedic, more globalized, more customizable, more unified, more updatable, more expandable, more transmittable, and available more rapidly and more cheaply than ever before, with fewer mistakes and less repeated effort.

This database may be a collaborative document, constantly open to scholarly scrutiny, constantly expanding, and constantly made more accurate and more detailed. If successful, this system and method may become one of the core reference sites on the internet. It may take some time to fill in every corner of the globe and every millennium of history, but once complete, it may be the equivalent of the Human Genome Project for international historians and environmental scientists.

It may be based on the traditional GIS, or Geographic Information Systems, platforms that are typically used to create georeferenced databases, primarily for urban planning and environmental impact assessments, yet it may contain a multitude of additions and improvements that have never been properly codified into such systems. For the purposes of this specification, and for maximum clarity, the embodiments are described wherever possible using the standard established conventions and terminology of GIS-based systems, which have been well-known since the early 1980s.

However, this is not an indication that GIS-based systems are the only way to realize the embodiments. For example, any number of computer programming languages, such as FORTRAN, C, C++, Perl, Pascal, assembly language, the Java language, JavaScript, Java Applet technology, Smalltalk, Hypertext Markup Language (HTML), Dynamic Hypertext Markup Language (DHTML), eXtensible Markup Language (XML), eXtensible Style Language (XLS), Scalable Vector Graphics (SVG), Vector Markup Language (VML), Macromedia's Flash technology, and the like, may be used to implement aspects of the present invention. Furthermore, various programming approaches, such as procedural, object-oriented, or artificial intelligence techniques may be employed, depending on the requirements of each particular implementation.

All modern standard GIS-based systems are designed to take elements of map data, arrange them into layers of polygon data, line data, and point data, with associated text, to wrap them around a virtual globe for accurate viewing, and to perform various types of spatial analysis on the data. These systems, often with simplified interfaces, have become very popular in recent years. All GIS-based systems involve manipulations of map data in virtual space, and many of them will also allow for manipulations of data across time. Almost all involve a plurality of data layers, but none of them allow for the specific types of data, the specific data structure, and the specific data management protocols that will be needed to create a fully functional tool for use in education, journalism, governments, international business, and international relations.

The present author and inventor is an archaeologist with several years of research experience across the United States and the Middle East. He has worked at a wide variety of excavations at terrestrial, tidal, coastal, and underwater sites, conducted a multitude of remote sensing surveys, and has designed a number of GIS databases. He has studied a core curriculum that covers comparative global historical developments across every major cultural region in the world, spanning 7,000,000 years of history. He has worked with professors and students from over a dozen nations, and as such, the embodiments are designed to be as universal as possible. However, this is not an indication that the exact examples given, the exact data layers given, the exact data structures given, and the exact protocols given are the only possible way to realize the embodiments. Infinite variations are possible, and infinite alternatives may be imagined with the benefit of reading this disclosure.

### Static Description

For maximum clarity, this section will begin with a static description, which will explain the structure and connections of all the elements, and then proceed with a full operational description, which will further describe the elements in action. Both descriptions will follow the same outline, use the same drawings, and use the exact same part numbers.

FIG. 1 shows the most relevant prior art. This has been discussed in detail above.

FIG. 2 shows an introduction and overview of the complete system and method for this embodiment in chronological order. Researchers in all academic fields (200) may contribute and input data in a plurality of academic and scientific subject areas. These are shown in this embodiment as being divided into ten major data layers, six of which are sub-divided into two or more related data sub-layers. The exact structure and content of the data layers and sub-layers in this embodiment are shown in full detail in a series of figures later in the specification (Refer to FIG. 4, FIGS. 5A-5V, and FIGS. 6A-C).

In this embodiment, the data layers include, but are not limited to:

CIVILIZATION data layer (202)

RELIGION data layer (204)

GOVERNMENT data layer (206)

ECONOMY data layer (208)

TECHNOLOGY data layers (210A-B)
FOOD PRODUCTION data sub-layer (210A)
INDUSTRIAL PRODUCTION data sub-layer (210B)

LANGUAGE data layers (212A-B)
NATIVE LANGUAGE data sub-layer (212A)
OFFICIAL LANGUAGE data sub-layer (212B)

GENETICS data layers (214A-B)
MITOCHONDRIAL DNA data sub-layer (214A)
Y-CHROMOSOME DNA data sub-layer (214B)

BIOLOGY data layers (216A-D)
BIOME data sub-layer (216A)
LAND USE data sub-layer (216B)
FLORA data sub-layer (216C)
FAUNA data sub-layer (216D)

CLIMATE data layers (218A-E)
AIR TEMPERATURE data sub-layer (218A)
ANNUAL RAINFALL data sub-layer (218B)
SEA TEMPERATURE data sub-layer (218C)
SEA AND LAKE LEVELS data sub-layer (218D)
CO₂ CONCENTRATION data sub-layer (218E)

GEOLOGY data layers (220A-B)
TOPOGRAPHY data sub-layer (220A)
GEOLOGICAL AGES data sub-layer (220B)

Since this is a multimedia platform, the data input can include map data (222) in the form of pre-existing paper and digital maps, and text data (224) in the form of primary sources, secondary sources, and any form of research data and publications.

In this embodiment, the database may be maintained and updated in a collaborative format, although submissions may be juried and reviewed by professional scholars following the protocols outlined in this specification. In this way, the database may be juried and reviewed in substantially the same manner that professional academic journals are juried and reviewed in order to maintain standards of content quality and scientific accuracy (See FIGS. 6A-C, FIGS. 7, 8, 9).

The system and method will proceed through a plurality of phases and sub-phases of operations. These are shown in this embodiment as being divided into three major phases of operations, all of which are sub-divided into two or more related sub-phases of operations. The exact content of these phases and sub-phases will be described in detail in chronological order, and this will form the common outline for the static and operational descriptions.

In this embodiment, the phases of operations include, but are not limited to:

INPUT phase of operations (226)
STRUCTURING sub-phase of operations (228)
CLASSIFICATION sub-phase of operations (230)
SORTING sub-phase of operations (232)
FILTERING sub-phase of operations (234)
VERIFICATION sub-phase of operations (236)

STORAGE phase of operations (238)
COMPILING sub-phase of operations (240)
UPDATING sub-phase of operations (242)

OUTPUT phase of operations (244)
CUSTOMIZING sub-phase of operations (246)
PUBLICATION sub-phase of operations (248)

Since this is a multimedia platform, output may be created in a variety of formats.

In this embodiment, the formats of output detailed include, but are not limited to:

GLOBAL HISTORICAL COLLABORATIVE ANIMATED MAP output (250)

ILLUSTRATIONS AND SLIDESHOWS output (252)

ANIMATIONS AND VIDEOS output (254)

BOX-ITEMS AND CURRICULUM MODULES output (256)

SCHOLARLY ARTICLES output (258)

CUSTOMIZABLE TEXTBOOKS output (260)

Since this is a transmittable database, the data can be sent to students of all ages and nations (262) in multiple formats, including but not limited to: the inclusion or exclusion of different types of data, variations in the input of the data, variations in the structure of the data, variations in the storage of the data, variations in the output of the data, variations in the presentation of the data, translations of the database into foreign languages, a simplified interface for younger students and instructors, a more complex interface for advanced students and instructors, a voice-activated interface for selecting and customizing output, the capability for users to add extra layers, the capability to restrict or encrypt extra layers for internal use only, automated versions of map visualizations which may be executed with only one click of the mouse or with only minimal input from the user, data for past geological ages which may include the ability to visually warp georeferenced map data and regions back into their former tectonic positions including Pangaea, hypothetical scenarios for past events, multiple simultaneous hypothetical scenarios for past events, hypothetical scenarios for future events, multiple simultaneous hypothetical scenarios for future events, alternative scenarios representing religious histories, alternative scenarios representing mythological histories, alterations of the database structure for users with different historical or religious worldviews, alterations of the database content for users with different historical or religious worldview, a 3-D version which may include specialized eyewear, a mobile version for tourists and travelers, the integration of updated news-feeds into the database, the development of games and activities, and the development of educational materials in all formats, including materials that allow students to use any element of this method as part of a curriculum, and including materials that allow students to use any element of this method in a computer-based or non-computer-based format.

### Input

FIG. 3 shows an introduction and overview of the INPUT phase of operations (226) for this embodiment in procedural order, detailing the process for inputting the georeferenced historical data. This may provide an innovative means for visual template-based data-entry method using a guided graphic user interface. The steps are labeled (300-344) on the flowchart. This will be discussed in full detail during the operational description section of this specification.

### Structuring

FIG. 4 illustrates the STRUCTURING sub-phase of operations (228) in this embodiment. It is a table showing what information types are contained in all the data layers in this embodiment.

The first column shows the name of data layer (400). The names of the data layers are listed below (202-220). The second column shows what polygon data (402) may appear in each data layer (202-220). In the context of Geographic Information Systems databases, polygon data is two-dimensional data that encodes the boundaries of regions on a map. These regions may represent countries, continents, oceans, or natural or man-made zones of any kind. For this specification, polygon data may also be referred to as “zone data” since that term is more clear for most readers, especially when referring to maps. The third column shows what line, point & text data (404) may be shown in each data layer (200-220). In the context of Geographic Information Systems databases, line data is one-dimensional data that encodes lines on a map. These lines may represent roads, ocean currents, trade routes, or vectors of any kind. Point data is zero-dimensional data that encodes points on a map. These points may represent cities, events, data samples, or locations of any kind. Text data includes labels that are attached to zones, polygons, lines or points on the map, and may be displayed on screen to provide additional information to the user. The fourth column shows the exact fields of academic expertise (406) for each data layer (202-220). Contributors who are educated in the specified fields may be the primary contributors to the corresponding data layer, and may be considered to be entering data for their exact field of expertise for the purposes of expertise-based data-vetting, as described in detail below, in FIG. 6C.

The CIVILIZATION data layer (202) will indicate what societies have control over a specific region at a specific time. This will illustrate the boundaries of societies and civilizations, empires and their provinces. Identifications of societies may be based on international boundaries, ethnic self-identification, or archaeological designations as appropriate, as exemplified in FIG. 5B. This layer by itself may recreate the look of a traditional political map, and may convey a great deal of information on its own.

On the civilization data layer (202), polygon data (402) may include civilizations, empires, provinces, etc. Increasing the level of detail on the polygon data may show increasingly smaller provinces and jurisdictions, as detailed in FIG. 5B. Point, line, and text data (404) may include cities, battles, events that mark cultural achievements, etc. Exact fields of academic expertise (406) may include history, archaeology, humanities, etc. These fields may be given priority in data-vetting for this layer.

The RELIGION data layer (204) will indicate what religions are present in a region. Classifications may be based upon the traditional classifications of world religions and their sects, and their branching developmental relationships from one another as deduced by historians, as exemplified in FIG. 5C. Whenever such classifications are in doubt or unknown, they may be resolved following the flowchart detailed in FIG. 9.

On the religion data layer (202), polygon data (402) may include religions, denominations, sects, etc. Increasing the level of detail on the polygon data may show increasingly smaller denominations and sects, as detailed in FIG. 5C. Point, line, and text data (404) may include events of religious importance, religious conversions, religious conflicts, etc. Exact fields of academic expertise (406) may include history, archaeology, religious studies, etc. These fields may be given priority in data-vetting for this layer.

The GOVERNMENT data layer (206) will indicate what type of government a region is ruled by. Classifications may include monarchic, colonial, autocratic, representative, theocratic, etc, as exemplified in FIG. 5D. Whenever such classifications are in doubt or unknown, they may be resolved following the flowchart detailed in FIG. 9.

On the government data layer (206), polygon data (402) may include government types, international alliances, political party affiliations, the results of past elections, the results of currently ongoing elections, etc. Increasing the level of detail on the polygon data may show increasingly specific definitions of government types, as detailed in FIG. 5D. Point, line, and text data (404) may include coronations, revolutions, constitutions, etc. Exact fields of academic expertise (406) may include history, archaeology, political science, etc. These fields may be given priority in data-vetting for this layer.

The ECONOMICS data layer (208) will indicate what type of economic system is present in a region, in terms of how a civilization distributes and consumes resources. Classifications may include socially-stratified, socially-immobile, socialist, communist, privatized, capitalist, etc, as exemplified in FIG. 5E. Whenever such classifications are in doubt or unknown, they may be resolved following the flowchart detailed in FIG. 9.

On the economics data layer (208), polygon data (402) may include economic system types, international common markets, etc. Increasing the level of detail on the polygon data may show increasingly specific definitions of economic system types, as detailed in FIG. 5E. Point, line, and text data (404) may include events of economic importance, market crashes, international trade treaties, etc. Exact fields of academic expertise (406) may include history, archaeology, economics, etc. These fields may be given priority in data-vetting for this layer.

The TECHNOLOGY data layers (210) will indicate what technological level or industry is dominant in a region. Classifications may include hunter-gatherer, pastoralist, agricultural, industrial, etc, as exemplified in FIGS. 5F-G. Whenever such classifications are in doubt or unknown, they may be resolved following the flowchart detailed in FIG. 9.

On the technology data layers (210), polygon data (402) may include technological level, etc. Increasing the level of detail on the polygon data may show increasingly specific definitions of technological stages, as detailed in FIGS. 5F-G. Point, line, and text data (404) may include technological advances, adoption of new technology, great inventions, etc. Exact fields of academic expertise (406) may include history, archaeology, the sciences, medicine, chemistry, physics, math, computing, engineering, etc. These fields may be given priority in data-vetting for this layer.

The LANGUAGE data layers (212) will indicate what languages are dominant in a region. Classifications may be based on the traditional philological classifications of languages and their dialects, and their branching developmental relationships from one another, as deduced by linguists, as exemplified in FIGS. 5H-I. Whenever such classifications are in doubt or unknown, they may be resolved following the flowchart detailed in FIG. 9.

On the language data layers (212), polygon data (402) may include language groups, etc. Increasing the level of detail on the polygon data may show increasingly specific linguistic groups, as detailed in FIGS. 5H-I. Point, line, and text data (404) may include the origins of writing systems, beginnings and endings of dark ages, etc. Exact fields of academic expertise (406) may include linguistics, linguistic anthropology, area studies, etc. These fields may be given priority in data-vetting for this layer.

The GENETICS data layers (214) will indicate what genetic and ethnic groups are present in a region. Classifications may be based on the identification of DNA haplogroups, which are classifications based on identifiable mutations in mitochondrial DNA and Y-chromosome DNA, as identified by geneticists, as exemplified in FIGS. 5J-K. In some cases, classifications may also be based on self-identified ethnic groups, or archaeologically-identified ethnic groups, as appropriate. Whenever such classifications are in doubt or unknown, they may be resolved following the flowchart detailed in FIG. 9.

On the genetics data layers (214), polygon data (402) may include scientifically-determined DNA haplogroups, in addition to self-identified ethnic groups, or archaeologically-identified ethnic groups, etc. Increasing the level of detail on the polygon data may show increasingly specific genetic and ethnic groups, as detailed in FIGS. 5J-K. Point, line, and text data (404) may include markers of key genetic mutations, as well as events relating to ethnic migrations, ethnic cleansing, genocide, etc. Exact fields of academic expertise (406) may include genetics, biological anthropology, area studies, etc. These fields may be given priority in data-vetting for this layer.

The BIOLOGY data layers (216) will present a variety of data about the types of environment, land use, flora, and fauna that are present in a region. Classifications may be based on those used by environmental groups, development agencies, and biologists, as appropriate, as exemplified in FIGS. 5L-O. Whenever classifications are in doubt or unknown, they may be resolved following the flowchart detailed in FIG. 9.

On the biology data layers (216), polygon data (402) may include environment types, biomes, bioregions, ecosystems, ecoregions, land use types, floral ranges, faunal ranges, etc. Increasing the level of detail on the polygon data may show increasingly specific zone types or taxonomic species, as appropriate, as detailed in FIGS. 5L-O. Point, line, and text data (404) may include endangered species, extinctions, fossil sites, etc. Exact fields of academic expertise (406) may include environmental sciences, ecology, biology, zoology, paleontology, etc. These fields may be given priority in data-vetting for this layer.

The CLIMATE data layers (218) will present a variety of data about the interactions of the atmosphere and hydrosphere of the earth. Classifications may simply be an appropriate numerical scale for each layer, as exemplified in FIGS. 5P-T. As with any layer, whenever classifications are in doubt or unknown, they may be resolved following the flowchart detailed in FIG. 9.

On the climate data layers (218), polygon data (402) may include average temperature, annual rainfall, sea temperatures, sea levels, lake levels, greenhouse gas concentrations, etc. Increasing the level of detail on the polygon data may show increasingly detailed scales of measurement, as indicated in FIGS. 5P-T. Point, line, and text data (404) may include climate events, pollution events, natural disasters, hurricanes, floods, droughts, the beginnings and ends of Ice Ages, etc. Exact fields of academic expertise (406) may include environmental sciences, meteorology, climatology, etc. These fields may be given priority in data-vetting for this layer.

The GEOLOGY data layers (220) will present a variety of data about the lithosphere or geosphere of the earth. Classifications may reflect the geological ages of the Earth as identified by geologists and paleontologists, as exemplified in FIGS. 5U-V. Whenever classifications are in doubt or unknown, they may be resolved following the flowchart detailed in FIG. 9.

On the geological data layers (220), polygon data (402) may include tectonic plates, topographic and bathymetric elevation, the geological ages of exposed or buried sediments in each region, types of rocks and rock formations, natural resources, etc. Increasing the level of detail on the polygon data may show increasingly detailed scales of measurement, as appropriate, as detailed below in FIGS. 5U-V. Point, line, and text data (404) may include geological events, volcanic eruptions, earthquakes, tsunamis, etc. Exact fields of academic expertise (406) may include earth sciences, geology, geography, etc. These fields may be given priority in data-vetting for this layer.

### Classification

FIGS. 5A-V illustrate the CLASSIFICATION sub-phase of operations (230) in this embodiment. These figures are classification trees showing the exact structure of all of the data layers in this embodiment.

FIG. 5A shows the general structure of all of the data layers in this embodiment. As previously noted, researchers in all academic fields (200) may contribute and input data in a plurality of academic and scientific subject areas. These are shown in this embodiment as being divided into ten major data layers (202-220), six of which are sub-divided into two or more related data sub-layers. Each layer or sub-layer will be illustrated by a classification tree (See FIGS. 5B-V), as well as a screenshot showing a basic example of the output of that layer (See FIGS. 10A-V).

The data tree structure (500) is clearly illustrated with a hierarchical data tree diagram, also known as a directory tree, or a dendrogram. This is a standard format for classifying data, which will seem immediately familiar to any database designer or biologist. Each column to the right represents a level of depth or branching in the hierarchy, and may be given a taxonomic designation, in the same way that biologists use the taxonomic designations of kingdom, phylum, class, order, family, genus, and species. Moving towards the right, we see the major data layers in one column as the first designated taxonomic level (400), and then the data sub-layers in the next column as the next designated taxonomic level (502).

FIGS. 5B-V are a series of illustrations that show the specific structure of each individual data layer and sub-layer in this embodiment. Each data tree uses either a regional, typological, evolutionary, or numerical structure, as is appropriate to the subject matter. On these figures, moving to the right, we see that each taxonomic category falls vertically below one of the suggested grade levels (504). These suggested grade levels will help be used to activate the pre-programmed grade-levels, as described in detail below, in FIG. 6A.

Categories and concepts in the first column may be suggested as appropriate for a kindergarten grade level (506). Categories and concepts in the next column may be suggested as appropriate for a 3^{rd} grade level (508). Categories and concepts in the next column may be suggested as appropriate for a 6^{th} grade level (510). Categories and concepts in the next column may be suggested as appropriate for a 9^{th} grade level (512). Categories and concepts in the next column may be suggested as appropriate for the 12^{th} grade, Advanced Placement (AP) courses, university-level 101 courses, or undergraduate level courses (514). Categories and concepts in the next column may be suggested as appropriate for a graduate student level (516). Categories and concepts in the next column may be suggested as appropriate for a professorial level (506). Categories and concepts in the next column may be suggested as appropriate for a specialist level (506). In addition, the specialist level can be extended infinitely, simply by creating a series of sequentially numbered levels, such as “SPEC01”, “SPEC02”, “SPEC03”, et cetera. This is necessary to accommodate subjects such as linguistics, genetics, and biology, which use extremely deep and detailed hierarchical structures to organize their data. When this occurs, the trees may also use two separate sets of terminology, the first being appropriately simplified for younger students, and the second being appropriately complex for advanced students. This is the case in the LANGUAGE data layers (212), the GENETICS data layers (214), and the BIOLOGY data layers (216), as they are currently illustrated in this embodiment.

As mentioned previously, all of the layer trees can be continually updated as new information comes to light. This may include combining similar categories, adding and differentiating new categories, and debating over situations where classification is uncertain. Changes of this nature can even be made ex post facto, after the system and method are already in use. This may be done fairly often at first for the GOVERNMENT data layer (206) and the ECONOMY data layer (208), since there is still no universally standard way of categorizing data in those subjects. This will also definitely be a useful advantage for the GENETICS data layers (214) and the BIOLOGY data layers (216), since they both need to constantly update and disseminate a unified revision of an ever-changing and ever-expanding hierarchical data structure. Thus, the scope of the invention and the embodiments must not be determined by the examples given, but by the appended claims and their legal equivalents.

### Sorting

FIG. 6A illustrates the SORTING sub-phase of operations (232) in this embodiment. It is a table showing the default options for the pre-programmed grade-level settings in this embodiment.

Pre-programmed grade-level settings will allow the user or instructor to show only the data which the audience is ready or able to understand. This may be extremely useful in elementary educational settings.

In FIG. 6A, the first column lists all of the major data layers (400) and data sub-layers (502). The columns to the right show which layers may become visible at each pre-programmed grade-level (506-520). It also shows the exact point at which certain layers are triggered to switch to more advanced technical terminology (600-610). In this embodiment, all of these switches occur at the graduate level (516). These features will be discussed in full detail during the operational description section of this specification.

### Filtering

FIG. 6B illustrates the FILTERING sub-phase of operations (234) in this embodiment. It is a table showing the levels for event-importance highlighting in this embodiment.

Event-importance highlighting settings will allow the user or instructor to show only the data which the audience considers to be sufficiently important. This may be extremely useful for any audience.

In FIG. 6B, the first column lists the area of effect (612) ascribed to an event. The second column lists the degree of effect (614) ascribed to an event. For maximum clarity, the third column reiterates the verbal description (616) of the area and degree of effect. The fourth column shows what corresponding event-importance ranking (618) may be ascribed to the event. These features will be discussed in full detail during the operational description section of this specification.

### Verification

FIG. 6C illustrates the VERIFICATION sub-phase of operations (236) in this embodiment. It is a table showing the levels for expertise-based data-vetting in this embodiment.

Expertise-based data-vetting rankings will allow the user or instructor to show only the data contributed by people who have reached a desired level of expertise in the appropriate field. This may be extremely useful in advanced university settings.

In FIG. 6C, the first column lists the description of the contributor (620). The second column shows what corresponding expertise-based data-vetting ranking (622) may be ascribed to that person. These features will be discussed in full detail during the operational description section of this specification.

### Storage

FIG. 7 shows an introduction and overview of the STORAGE phase of operations (238) for this embodiment. It illustrates the overarching protocols of collaboration for data management in this embodiment.

Educational organizations (700) may provide scholarly expertise in the form of content contributors (702). A programming organization (704) provides database design and maintenance expertise in the form of content coordinators (706). Together, the coordinators (706) and the contributors (702) work on compiling the map data (222) using the protocols outlined on the flowchart in FIG. 8, and on updating the tree data (224) using the protocols outlined on the flowchart in FIG. 9. This data is stored in the database servers (708), and in turn, is sent to teachers and students (710) via the internet.

This provides an optimally organized system for managing a global historical collaborative animated map database. These protocols will be discussed in more detail during the operational description section of this specification.

### Compiling

FIG. 8 illustrates the COMPILING sub-phase of operations (240) in this embodiment. It is a flowchart showing the protocol for resolving conflicts and overlaps on the maps. This allows for a completely unified global historical collaborative animated map database with all factual contradictions resolved. The steps are labeled (800-824) on the flowchart. They will be discussed in full detail during the operational description section of this specification.

### Updating

FIG. 9 illustrates the UPDATING sub-phase of operations (242) in this embodiment. It is a flowchart showing the process for updating categorizations within the data trees. This allows for a completely unified global historical curriculum with all disagreements over concepts and definitions resolved. The steps are labeled (900-918) on the flowchart. They will be discussed in full detail during the operational description section of this specification.

### Output

FIGS. 10A-V show an introduction and overview of the OUTPUT phase of operations (244) for this embodiment. These figures include examples of all of the data layers and data sub-layers detailed in this embodiment.

FIG. 10A shows a screenshot of the main screen and interface items in this embodiment, including all menu options used during the output phase of operations (224) in this embodiment.

The center of the screen contains a map area (1000) where the rendered output data can be viewed. A navigation tool (1002) may be used to control the user's position in virtual geographic space, including a compass ring (1004) to control direction, navigation buttons (1006) to control movement, and zoom buttons (1008) to control altitude. Additional controls may be added to allow the user to control roll, pitch, and yaw, as in an airplane or an advanced spacecraft.

A timeline tool (1010) may be used to control the user's position in virtual historical time. The user may also have the option to show Non-Christian timelines, such as the Jewish and Muslim timelines. If the user wishes to view data that is more than 5,769 years old, the Jewish timeline may simply display the year expressed as a negative number.

In addition to the timeline itself (1010), this section of the interface may include a date readout (1012), a historical period indicator (1014), and a plurality of buttons including a “back to previous event” button (1016), a “reverse” button (1018), a “play/pause” button (1020), a “fast forward” button (1022), and a “forward to next event” button (1024).

A news-ticker (1026) may also be provided at the bottom of the screen to relate events that fit the categories the user desires to know about. These may be events that occurred during the historical time to which the timeline (1010) is set, or they may relate events that were happening in other parts of the world that are not currently visible on the map screen. Events scrolling on the news-ticker may be phrased in the language of news headlines for maximum impact and excitement.

A climate data indicators window (1036) may be shown if the user desires. This may show data from any of the climate data layers (218A-E) listed in this embodiment, or any other climate data that might be visualized, as a plurality of color-coded thermometers, for example, a red air temperature data indicator (1030) resembling a traditional thermometer, a blue sea level data indicator (1032), and a green CO₂ concentration data indicator. As with all units of measurement given in the output, these may be toggled between the British Standard System familiar to most Americans or the Metric System whenever the user desires. These may also be calibrated so that the average values for the Pleistocene Epoch or the most recent Ice Age are at or near the bottom, while the average values for the Holocene Epoch or Pre-Industrial Age are at the middle, so as to best convey the amount of change in recent decades, and to leave ample room for extreme climate scenarios to be encoded as hypothetical future data. The climate data indicators window (1036) may also be closed if the user does not need it, or if the user simply desires to have more room in the map area (1000). The rest of the screenshots will be shown with the climate data window (1036) closed.

A menu area (1036) may be used to feature a plurality of interface buttons. In this embodiment, it is shown directly below the map area (1000). A “Space” button (1038) may be used to access options relating to geographic space and map rendering. A “Time” button (1040) may be used to access options related to historical time and timeline rendering. A “Grade” button (1042) may be used to access options related to grade levels or the pre-programmed grade-level settings. An “Events” button (1044) may be used to access options related to events or event-importance highlighting. An “Experts” button (1046) may be used to access options related to expertise-based data-vetting. A “File” button (1048) may be used to save and access pre-recorded animations or curriculum modules. A “View” button (1050) may be used to access options related to screen or interface appearance. A “Search” button (1052) may be used to scan the database or onboard encyclopedia for any concept or keyword specified by the user. A “Pedia” button (1054) may be used to freely explore the onboard encyclopedia for more information about any civilization, any region, any event, or any category or concept encoded in the data trees. An “Online” button (1056) may be used to hyperlink to selected outside sources across the internet for deeper research. A “Help” button (1058) may be used to obtain help in a user-friendly, animated, or interactive manner.

A layer selection window (1060) may be used to allow the user to quickly and easily select which data layers and data sub-layers are visible or hidden within the map data (222). In this embodiment, it is shown to the upper-right of the map area (1000). A “CIV” button (1062) may be used to bring the civilization data layer to the front. A “REL” button (1064) may be used to bring the religion data layer to the front. A “GOVT” button (1066) may be used to bring the government data layer to the front. An “ECON” button (1068) may be used to bring the economy data layer to the front. A “TECH” button (1070) may be used to cycle the technology data sub-layers to the front. A “LANG” button (1072) may be used to cycle the language data sub-layers to the front. A “GENE” button (1074) may be used to cycle the genetics data sub-layers to the front. A “BIO” button (1076) may be used to cycle the biology data sub-layers to the front. A “CLIM” button (1078) may be used to cycle the climate data sub-layers to the front. A “GEO” button (1080) may be used to cycle the geology data sub-layers to the front. A “ZONE” column (1082) may be used to select the polygon or zone data to be visible or hidden for any layer. A “LINE” column (1084) may be used to select the line data to be visible or hidden for any layer. A “POINT” column (1086) may be used to select the point data to be visible or hidden for any layer. A “TEXT” column (1088) may be used to select the text data to be visible or hidden for any layer. An “EVENT” column (1090) may be used to select the event data to be visible or hidden for any layer.

A legend window (1092) may be used to allow the user to quickly and easily select which categories and concepts from the data trees (224) are visible or hidden. In this embodiment, the legend is shown in its traditional position on the lower-right of the map area (1000). A legend title (1094) can be featured to indicate precisely which data layer or data sub-layer is being displayed. If there are multiple sub-layers within a data layer, the user may simply click the appropriate data layer button (1062-1080) a number of times to cycle between one sub-layer and the next, and the exact title of the sub-layer selected will appear as the legend title (1094) in the legend window (1092). A legend tree (1096) may be used to indicate which categories are opened or closed, which are visible or hidden, and what colors represent them on the map.

In this first example, FIG. 10A, the map area (1000) and timeline (1010) show that we are in virtual orbit around the Ice Age Earth, searching for signs of intelligent life and civilization. The reader will note the presence of the land bridge that connected Siberia with Alaska at that time. The layer selection window (1060) indicates that we are searching for point data (1086) on the land use data sub-layer (216B), which would certainly include cities, if there were any. However, as the news-ticker (1026) shows, the Ice Age is just now ending, and so we are not finding any signs of civilization at this point in time. The deeper interactive nature of the hierarchical legend trees will be discussed in full detail during the operational description section of this specification.

Also, the reader will note that FIG. 10A included a large number of parts, covering part numbers 1000 to 1096. Because of this, the part numbers for FIGS. 10B-V must begin with part number 1100, and continue to 1140. In keeping with this, the part numbers for FIG. 11A will begin with part number 1150, and continue 1188. FIG. 12 will begin with part number 1200, as expected. The reader is encouraged to revisit the complete list of part numbers detailed above for maximum clarification.

FIGS. 10B-V show a series of screenshots showing basic introductory examples of the output for all data layers and data sub-layers detailed in this embodiment. In these next examples, the map area (1000) and timeline (1010) show that we are zooming in over North Africa and Western Eurasia, and that we have advanced into the Modern Age, to the year 1950 AD. The layer selection window (1060) indicates that we are searching for polygon data, or zone data (1082) on each of the data layers in turn (202-220B). With each figure, and with each new example, the news-ticker (1026) gives us a timely news story associated with that particular data layer.

These figures also show that a variety of color palettes may be used for the legend trees (1096) with different palettes being optimal for different types of data. First, legends may use a palette that uses colors specifically chosen to best indicate the categories, utilizing a historical association or a mnemonic device wherever appropriate, for example, green for Islam, orange for Buddhism, purple for monarchy, and red for communism. There may also be options to select culturally-specific color palettes for international users, for example, one for use in China that represents monarchy with yellow, which was the signature color worn by Chinese Emperors, rather than purple, which was the signature color worn by Roman Emperors.

Layers that show some aspect of the natural world may use a naturalistic color palette, showing oceans as blue, glaciers as white, and forests as various shades of green, et cetera. Layers that show numerical data as a simple one-dimensional measure may simply be shown in monochrome, with various channels being shown in a signature monochrome hue, for example, red for air temperature, blue for sea level, and green for greenhouse gases.

Alternately, any layer may use a standard default color palette that uses the spectrum, from red, to orange, to yellow, to green, to blue, to indigo, to violet. If more colors are needed, a spectral palette may begin with gray and brown before red, and end with purple and magenta after violet. By convention, the legends may be ordered so that categories that occurred first in history are at the top, and categories that occurred later are at the bottom. By convention, the oldest categories may be shown at the red end of the spectrum, and latest categories may be on the violet end.

Additionally, any of the above color palettes may be arranged so that each major category has a signature hue, and then the various members of that category may be shown with a progressively darker shade of that hue. Alternately, the color palettes for the legends may reverse any of these conventions, or they may use any variety of different conventions.

FIG. 10B shows an example of the CIVILIZATION data layer (202), with an example map (1100A), and an example legend (110B). It shows that a large civilization zone like the Middle East can be sub-divided into medium-sized regions, and then into smaller countries.

FIG. 10C shows an example of the RELIGION data layer (204), with an example map (1102A), and an example legend (1102B). It shows that a striping pattern can be used to represent a plurality of different types coexisting in the same region or country.

FIG. 10D shows an example of the GOVERNMENT data layer (206), with an example map (1104A), and an example legend (1104B). It shows that stripes can also be used to represent a disputed, uncertain, or transitional state between one type and another. This layer may also be used to show regional election results for years where data exists.

FIG. 10E shows an example of the ECONOMY data layer (208), with an example map (1106A), and an example legend (1106B). It shows most clearly how darker shades of a signature hue can be used to clearly represent increasing intensity within a social category. Here, for example, socialism may be shown in a medium shade of pink, while communism may be shown in a full shade of red. For the Industrial Age, the dominant industries may be shown in terms of the percentage of the population that works in that industry, rather than the percentage of the GNP or GDP that comes from that industry, simply because the former statistic is much easier for historians to estimate for historical periods prior to the turn of the Twentieth Century.

FIG. 10F shows an example of the FOOD PRODUCTION data sub-data layer (210A) of the technology layer (210), with an example map (1108A), and an example legend (1108B). It shows the use of a default spectral palette, ranging from red to violet.

FIG. 10G shows an example of the INDUSTRIAL PRODUCTION data sub-data layer (210B) of the technology layer (210), with an example map (1110A), and an example legend (1110B). It also shows a default spectral palette, ranging smoothly from red to violet.

FIG. 10H shows an example of the NATIVE LANGUAGE data sub-data layer (212A) of the language layer (212), with an example map (1112A), and an example legend (1112B). It shows the use of a default spectral palette, ranging from red to violet. Also note that this example legend (1112B) shown in this figure has been abbreviated, with a plurality of categories removed to allow it to fit onto the printed page. A computerized version may easily allow horizontal and vertical scrolling within the legend window (1092) to allow hundreds or even thousands of categories to be fully and properly represented.

FIG. 10I shows an example of the OFFICIAL LANGUAGE data sub-data layer (212B) of the language layer (212), with an example map (1114A), and an example legend (1114B). It shows the use of a default spectral palette, ranging from red to violet. Here too, note that this example legend (1114B) shown in this figure has been abbreviated, with a plurality of categories removed to allow it to fit onto the printed page. A computerized version may easily allow horizontal and vertical scrolling within the legend window (1092) to allow hundreds or even thousands of categories to be fully and properly represented.

FIG. 10J shows an example of the MITOCHONDRIAL DNA data sub-data layer (214A) of the genetics layer (214), with an example map (1116A), and an example legend (1116B). Note that this data-set is shown as point data for clearest presentation. If needed, a standard algorithm can be used to automatically translate the point data into a polygon or zone layer by calculating the relative densities of the points. Again, note that this example legend (1116B) shown in this figure has been abbreviated, with a plurality of categories removed to allow it to fit onto the printed page. A computerized version may easily allow horizontal and vertical scrolling within the legend window (1092) to allow hundreds or even thousands of categories to be fully represented as our knowledge of genetics progresses.

FIG. 10K shows an example of the Y-CHROMOSOME DNA data sub-data layer (214B) of the genetics layer (214), with an example map (1118A), and an example legend (1118B). Note that this data-set is shown as point data for clearest presentation. If needed, a standard algorithm can be used to automatically translate the point data into a polygon or zone layer by calculating the relative densities of the points. Again, note that this example legend (1118B) shown in this figure has been abbreviated, with a plurality of categories removed to allow it to fit onto the printed page. A computerized version may easily allow horizontal and vertical scrolling within the legend window (1092) to allow hundreds or even thousands of categories to be fully represented as our knowledge of genetics progresses.

FIG. 10L shows an example of the BIOME data sub-data layer (216A) of the biology layer (216), with an example map (1120A), and an example legend (1120B). It shows the use of a natural color palette, allowing for easy interpretation.

FIG. 10M shows an example of the LAND USE data sub-data layer (216B) of the biology layer (216), with an example map (1122A), and an example legend (1122B). It shows the use of a mixed natural and spectral color palette, allowing easy interpretation.

At this point, there may also be a data layer included showing population density. This may be inserted as a fifth biology data layer, inasmuch as it fundamentally shows the habitat range and population density of the species Homo sapiens, and allows the user to highlight the effects of human habitation on the rest of the natural environment. For any historical period or region for which accurate census or population density data is available, such as the Twentieth Century, the verified information may simply be added to the data layer. In addition, in order to overcome the fact that population density data is not immediately available for many historical periods prior to the turn of the Twentieth century, the population density data layer may be synthesized using the land use data layer (216B) as a basic template (See FIG. 5M and FIG. 10M). If the computer has proper data categorizing the land use, environmental biomes, air temperature, annual rainfall, agricultural technology used for food production, and the civilization for each the region, we will have enough data to make an extremely accurate estimation of population density, and this may be done for any historical period. First, the maximum number of people per square kilometer may be estimated for each type of agricultural technology for food production (See FIG. 5F). Next, a multiplying factor may be assigned to each type of environmental biome, air temperature, and annual rainfall (See FIGS. 5L, 5P, 5Q). Finally, a unique multiplying factor may be assigned to each civilization for each phase of its development, to account for the fact that some civilizations during certain phases feel a greater desire to expand, especially during phases of colonialism into new territories. Ultimately, the accuracy of these estimations may be verified against any historical period for which actual census data is available, for example, the annual censuses recorded by the Roman Empire, or censuses of contemporary hunter-gatherer societies taken by field anthropologists. This verified data may be used to calibrate and correct the data for any civilization living in a similar environment, and using a similar category of technology for food production. In this way, a data coverage may be automatically generated that shows an extremely accurate estimation of the relative population densities of civilizations, including the distant past, remote areas, and hunter-gatherer societies.

FIG. 10N shows an example of the FLORA data sub-data layer (216C) of the biology layer (216), with an example map (1124A), and an example legend (1124B). Note that this data-set is shown as point data for clearest presentation. If needed, a standard algorithm can be used to automatically translate the point data into a polygon or zone layer using the density of the points. Note also that the user may select a plurality of categories to be visible, and a plurality of categories to be hidden, so as to focus on any desired subset of the data. Finally, note that this example legend (1124B) shown this figure has been abbreviated, with a plurality of categories removed to allow it to fit onto the printed page. A computerized version may easily allow horizontal and vertical scrolling within the legend window (1092) to allow hundreds or even thousands of categories to be fully and properly represented.

FIG. 10O shows an example of the FAUNA data sub-data layer (216D) of the biology layer (216), with an example map (1126A), and an example legend (1126B). Note that this data-set is shown as point data for clearest presentation. If needed, a standard algorithm can be used to automatically translate the point data into a polygon or zone layer using the density of the points. Note also that the user may select a plurality of categories to be visible, and a plurality of categories to be hidden, so as to focus on any desired subset of the data. Finally, note that this example legend (1126B) shown this figure has been abbreviated, with a plurality of categories removed to allow it to fit onto the printed page. A computerized version may easily allow horizontal and vertical scrolling within the legend window (1092) to allow hundreds or even thousands of categories to be fully and properly represented.

FIG. 10P shows an example of the AIR TEMPERATURE data sub-data layer (218A) of the climate layer (218), with an example map (1128A), and an example legend (1128B). Note that this layer may use red as its signature monochrome hue.

FIG. 10Q shows an example of the ANNUAL RAINFALL data sub-data layer (218B) of the climate layer (218), with an example map (1130A), and an example legend (1130B). Note that this layer may use cyan as its signature monochrome hue.

FIG. 10R shows an example of the SEA TEMPERATURE data sub-data layer (218C) of the climate layer (218), with an example map (1132A), and an example legend (1132B). Note that this layer may use violet as its signature monochrome hue.

FIG. 10S shows an example of the SEA AND LAKE LEVELS data sub-data layer (218D) of the climate layer (218), with an example map (1134A), and an example legend (1134B). Note that this layer may use blue as its signature monochrome hue.

FIG. 10T shows an example of the CO₂ CONCENTRATION data sub-data layer (218E) of the climate layer (218), with an example map (1136A), and an example legend (1136B). Note that this layer may use green as its signature monochrome hue.

FIG. 10U shows an example of the TOPOGRAPHY data sub-data layer (220A) of the geology layer (220), with an example map (1138A), and an example legend (1138B). This layer contains topographic and bathymetric data that may be rendered three-dimensionally.

FIG. 10V shows an example of the GEOLOGICAL AGES data sub-data layer (220B) of the geology layer (220), with an example map (1140A), and an example legend (1140B). It also contains topographic and bathymetric data that may be rendered three-dimensionally.

### Customizing

FIGS. 11A-E illustrate the CUSTOMIZING sub-phase of operations (246) in this embodiment.

FIG. 11A is a screenshot showing an example of advanced customized output for this embodiment. This illustrates a robust and advanced example of the type of output that might be used in education, journalism, governments, international business, and international relations.

In FIG. 11A, the map area (1000) and timeline (1010) show that we are focusing in on the Middle East, during the year 2008. In this example, the layer selection window (1060) indicates that we are have brought the government data layer (206) to the front, and that we have selected polygon data or zone data (1082), point data (1086), and event data (1090) for that layer. It also shows that we have selected to add polygon data or zone data (1082) for the civilization data layer (202), the religion data layer (204), the economy data layer (208), and the technology data layers (210A-B), which may be shown as colored icons, since it is only possible to view one layer of polygon data or zone data on the screen at a time.

Here again, we have a customized example map (1150A), and a corresponding example legend (1150B) for the government data layer (206), which has currently been selected to be brought to the front. One can see clearly that the colors on the example map (1150A) correspond perfectly to the colors in the example legend tree (1150B). Since we are adding multiple layers of polygon or zone data, the map may feature civilization banners (1152), which may show the name and flag of a nation, next to a row of icons representing all of the categories that would appear in that nation if their corresponding layers were to be brought to the front for full viewing. The colors of the icons may also match the colors normally used for zone data on their corresponding layers. In this way, the icons may function as tiny windows into the data layers that are behind the front layer. Also, as an interface shortcut, the user may click on any one of these icons, which may momentarily bring the corresponding polygon or zone data layer to the front for full viewing, and then may allow that layer to automatically return to its position in the back when the user releases the mouse button again.

In this example, the icons representing polygon or zone data include, but are not limited to:
a green crescent icon for “Islam” religion (1154),
an icon for “disputed” government (1156),
an icon for “kingdom” government (1158),
an icon for “autocracy” government (1160),
an icon for “republic” government (1162),
an icon for “theocracy” government (1164),
an icon for “capitalism” economy (1166),
an icon for “animal-powered irrigated” food production (1168),
an icon for “machine-powered irrigated” food production (1170),
an icon for “mining” industrial production (1172),
an icon for “refining” industrial production (1174), and
an icon for “manufacturing” industrial production (1176),

In this example, point data includes, but is not limited to:
an explosion icon for violence or battle (1182)
an icon for modern era army unit (1184)
an icon for modern era naval unit (1186)
an icon for modern era air force unit (1188)

Event data may also be featured as pop-up bubbles, which may appear at the correct date in time, and point to the correct location on the map. In this figure, we see an example of this type of geo-referenced date-referenced event pop-up bubble (1178) The event pop-up bubbles may also feature hyperlinks (1180) to the internal encyclopedia, or to selected outside sources for more in depth information.

FIGS. 11B-E are screenshots showing examples of the “WorldView 360°” visualization, as explained in this embodiment. This illustrates another of the unique and advanced 3-D visualizations that can be accomplished using this system and method.

To create this visualization, the user may simply select a point on the map, such as the capital city of the civilization, region, or country being discussed. With one click, the user may cause the program to zoom in near to the ground level at that point, and cause the virtual camera to slowly pan around 360° showing all of the desired map information from that one point of view. In this way, the user or instructor may show the audience what the citizens or leaders of that civilization or empire would have seen if they had looked out at the world from a tower in their capital city, from their own geographic, historical, and cultural point of view. The user may also select an option so that any neighboring civilizations that were still unknown or uncontacted by the central civilization at that time may be hidden from view. This visualization may be rendered as an animation, or as a series of still frames, as in this example. FIGS. 11A-E show an example centered on the Middle East, starting facing north and proceeding clockwise, and showing the polygon or zone data of the religion data layer. In this example, the legend tree has been selectively opened to focus on the most relevant religious groups for this point in space and time.

FIG. 11B shows the first still frame, facing north. It features an example map (1190A), and an example legend (1190B).

FIG. 11C shows the second still frame, facing east. It features an example map (1192A), and an example legend (1192B).

FIG. 11D shows the third still frame, facing south. It features an example map (1194A), and an example legend (1194B).

FIG. 11E shows the fourth still frame, facing west. It features an example map (1196A), and an example legend (1196B).

This is a unique and innovative visualization method that has never been fully possible before. It may promise to be most enlightening in educational settings, in addition to journalism, governments, international business, and international relations.

### Publication

FIG. 12 illustrates the PUBLICATION sub-phase of operations (248) in this embodiment. It is a matrix showing the data types that may be used to create multiple types of useful output. It must be noted that this system and method allow nearly infinite forms of output, and so the claims of this specification should not be limited to the examples given here. The columns list the formats of output introduced in FIG. 2.

In this embodiment, the formats of output detailed include, but are not limited to:

GLOBAL HISTORICAL COLLABORATIVE ANIMATED MAP output (250)

ILLUSTRATIONS AND SLIDESHOWS output (252)

ANIMATIONS AND VIDEOS output (254)

BOX-ITEMS AND CURRICULUM MODULES output (256)

SCHOLARLY ARTICLES output (258)

CUSTOMIZABLE TEXTBOOKS output (260)

The rows of the matrix show the types of additional parameters or commands that may need to be encoded to render or animate the various formats of output. Commands or parameters for the navigator tool (1102) may include those for latitude boundaries control (1202), longitude boundaries control (1204), altitude control (1206), angle control (1208), spatial direction control (1210), and spatial speed control (1212). Commands or parameters for the timeline tool (1010) may include those for year/month/date control (1012), time direction control (1214), and time speed control (1216). Commands or parameters may also be used to specify a predetermined pre-programmed grade-level setting (504), a predetermined level for event-importance highlighting (618), and a predetermined level for expertise-based data-vetting (622). Commands or parameters may also be used to encode additional information (1200), including additional text or interactive captions (1218), additional audio or interactive tutorials (1220).

### Operational Description

FIG. 2 shows an introduction and overview of the complete system and method for this embodiment in chronological order. This figure has been described in detail in the static description section of this specification.

### Input

FIG. 3 shows an introduction and overview of the INPUT phase of operations (226) for this embodiment in procedural order, detailing an innovative process for inputting the georeferenced historical data. When used in conjunction with the provided categorized data layers, and the provided categorized data trees, this protocol may provide a means for visual template-based data-entry, which may use a guided graphic user interface. When used in conjunction with the provided categorized data layers, and the provided categorized data trees, this protocol may also provide a means for ensuring that all input data adhere to a universal data format. Using this system and method, the map database may be built as a living document and a collaborative effort, and the maps may be successively edited and updated by using the first contributor's input as a template, adding additional events, and using the concepts and categories on the data trees to fill in the missing data for each region, using a unique and innovative “paint-by-numbers” approach.

The flowchart starts in the upper-left (300). The contributor (702) begins by selecting a civilization for which data is to be entered (302). The user enters the founding date and the ending date for that civilization (304). The dates chosen may also mark a specific phase or period of a civilization that continued through time, and several contributors (702) may collaborate to enter successive historical periods. Alternately, one contributor may lay down the basic timeline, and others may go back over it later to add detail, or to add information relating to different academic fields or specialties. Even if only these basic pieces of information have been entered, the civilization may now be shown and presented on a master timeline in the traditional bar format, and the database coordinators (706) can run a search for an appropriate expert within the user community to help fill in the needed data.

The contributor then assigns an appropriate flag, heraldry, or identifiable insignia for that era of the civilization (306). If no flag or heraldry is historically known, the contributor may assign an appropriate image or symbol. The contributor then assigns a signature hue for the civilization (308). For the purposes of legibility and clear visual display, no civilization may be assigned a hue of pure black or pure white. When the civilization appears on the map, it may be colored with its assigned hue by default, and when the civilization is shown delineated into regions or territories, they may be shown as various shades of that same signature hue for clearest presentation (See FIG. 10B). For regions with a large number of territories, a common map-coloring algorithm may be used, which typically uses five different shades of a hue to color a map so that no adjacent regions are the same color.

In entering data, the contributor begins at the predetermined start date, for example, the founding date of the civilization (310). The contributor then locates the founding of the capital city and enters it as point data and as an event (312). The contributor then traces out the initial territory of the civilization on the map (314). Territories and regions may also delineated in this way. The contributor then selects from the data trees the initial type of religion, government, economy, technology, language, and genetic or ethnic groups that were present at the time of the foundation of the civilization (316). The contributor then scrolls or jumps forward to the next date at which a significant event occurred in that civilization (318), and marks the date (320), and the location of that event (322), and enters appropriate text to describe the event (324), as well as a picture or video file if desired (326). If the exact date of an event is unknown, the average date of carbon dating samples may be used.

For each event, the contributor may also enter an estimation of the appropriate minimum grade level that would be ready to learn about the event (328) for the purposes of the pre-programmed grade-level settings (504) (See also FIG. 6A), and an estimation of the relative global importance of the event (330) for the purposes of event-importance highlighting (618) (See also FIG. 6B). For expertise-based data-vetting, all events may be initially keyed to the expertise level of the initial contributor. If the data is later reviewed, vetted, and approved by a higher-level expert, then the expertise ranking of that data will rise to the level of that higher-level expert who completed the vetting (See also FIG. 6C).

The next step is to review the event just entered, and to determine what aspects of society it effected, and to determine if it changed the appearance of the any of the polygon data layers. If the event did not directly change the appearance of the polygon data layers, it may simply be cataloged as a pop-up event relating to the appropriate layer (332). If the event did actually change the status and the visual appearance of one or more of the polygon data layers, the interface may display each affected data layer in turn, so that the contributor can select and update the region or regions that were affected. If the territory expanded or contracted, the contributor may draw the new boundary on the screen. If the territory experienced a change in society that effected the appearance of the polygon data layers, the contributor may select the new category from the appropriate data tree interactively displayed on the screen (344). For example, if the event was a revolution that resulted in a change of government type in a region, the contributor may select the new government type from the government data tree (See also FIG. 5C). If no change is selected, the computer will always assume that the status quo remains the same.

The contributor may continue to repeat these steps as indicated on the flowchart until the end date for that civilization or phase of civilization has been reached (336). When data entry is complete, the program may clean the polygon layers using the standard GIS algorithms, to ensure that all of the lines connect properly, and that all of the regions are filled (338). If there is an area on the map where new data overlaps old data, the computer may prompt the contributor to indicate the proper status of the overlap region following the protocols detailed in FIG. 8 (340). The program may then compile the data into a GIS coverage for each slice of time (342).

Whenever territorial borders changed abruptly, a standard shape-morphing algorithm may be used to animate the change in territory more smoothly. Different styles of animations for border changes may be used to represent violent or peaceful expansions. Different styles of border may be used to represent different types of land use or different phases of civilization, for example, fuzzy boundaries for hunter-gatherers. Ultimately, if the borders of a society or civilization are not exactly known, for example, with hunter-gatherer societies, standard GIS algorithms may be used to locate the areas in the topography, such as mountain ridges, where societies and civilizations most commonly draw their borders.

### Structuring

FIG. 4 illustrates the STRUCTURING sub-phase of operations (228) in this embodiment. It is a table showing what information types are contained in all the data layers in this embodiment. This figure has been described in detail in the static description section of this specification.

### Classification

FIG. 5A-V illustrates the CLASSIFICATION sub-phase of operations (230) in this embodiment. These figures are classification trees showing the structure of all of the data layers in this embodiment.

FIG. 5A shows the general structure of all of the data layers in this embodiment. This figure has been described in detail in the static description section of this specification.

FIGS. 5B-V are a series of illustrations that show the specific structure of each individual data layer and sub-layer in this embodiment. Note that in FIG. 5B, most of the names of the regions are followed by one or more labels in square brackets. These are examples of data tags that may be attached to individual regions or categories on the trees. These tags may be used to indicate which nations belong to larger international groups, such as the UN, The G8, The G20, the EU, OPEC, ASEAN, NAFTA, and MercoSur. These tags will be necessary to indicate groups that include members from some but not all of the nations on a branch, or that bring nations from multiple branches together, and therefore do not perfectly match the tree structure. These data tags can also be used to allow the instructor to command the computer to highlight all of the members a specified group for any date in historical time. This membership may be indicated as an insignia, as a bold boundary line, or perhaps as a glowing halo that momentarily or permanently highlights the member nations whenever that group is selected for discussion.

For the civilization data layer, data tags may also include “League of Nations”, “Permanent Member of UN Security Council”, “UN Protectorate”, etc. For the religion data layer, tags may also include “Fertility Goddess Worship”, “Monotheism”, “Holy Roman Empire”, “Alliance for the First Crusade”, etc. For the government data layer, tags may also include “Axis Powers”, “Allied Powers”, “International Coalition Forces”, “Voted Republican 2008”, “Voted Democrat 2008”, etc. For the economic data layer, tags may also include “Slave-Holding US States”, “Eastern Bloc”, “European Union”, “OPEC”, “NAFTA”, etc. For the technology data layers, tags may also include “Fertile Crescent Domesticates”, “African Domesticates”, “Rice Agriculture”, “Maize Agriculture”, “Electricity”, “Steam Power”, “Mechanized Armed Forces”, “Nuclear Capability”, “Biological Warfare Capability”, “Kyoto Climate Treaty Member”, etc. For the language data layer, tags may also include “Prehistoric/Preliterate Civilizations”, “Historic/Literate Civilizations”, etc. For the genetics data layer, tags may also include “Native American”, “Indo-European”, “Polynesian/Oceanic”, “Ashkenazi Jewish”, etc. For the biology data layer, tags may also include “Threatened Species”, “Endangered Species”, “Extinct in the Wild”, “Extinct”, etc.

As mentioned in the static description above, there may also be included a data layer showing population density. This may be inserted as a fifth biology data layer, inasmuch as it fundamentally shows the habitat range and population density of the species Homo sapiens, and allows the user to highlight the effects of human habitation on the rest of the natural environment. For any historical period or region for which accurate census or population density data is available, such as the Twentieth Century, the verified information may simply be added to the data layer. In addition, in order to overcome the fact that population density data is not immediately available for many historical periods prior to the turn of the Twentieth century, the population density data layer may be synthesized using the land use data layer (216B) as a basic template (See FIG. 5M and FIG. 10M). If the computer has proper data categorizing the types of land use, environmental biomes, air temperature, annual rainfall, agricultural technology used for food production, and the civilization for each the region, we will have enough data to make an extremely accurate estimation of population density, and this may be done for any historical period. First, the maximum number of people per square kilometer may be estimated for each type of agricultural technology for food production (See FIG. 5F). Next, a multiplying factor may be assigned to each type of environmental biome, air temperature, and annual rainfall (See FIGS. 5L, 5P, 5Q). Finally, a unique multiplying factor may be assigned to each civilization for each phase of its development, to account for the fact that some civilizations during certain phases feel a greater desire to expand, especially during phases of colonialism into new territories. Ultimately, the accuracy of these estimations may be verified against any historical period for which actual census data is available, for example, the annual censuses recorded by the Roman Empire, or censuses of contemporary hunter-gatherer societies taken by field anthropologists. This verified data may be used to calibrate and correct the data for any civilization living in a similar environment, and using a similar category of technology for food production. In this way, a data coverage may be automatically generated that shows an extremely accurate estimation of the relative population densities of civilizations, including the distant past, remote areas, and hunter-gathering societies.

In addition, the database may also feature a wide variety of socioeconomic data that is typically only available for the last several decades, including GNP, GDP, GNP per capita, GDP per capita, GNP adjusted for purchasing power parity, GDP adjusted for purchasing power parity, adult literacy, infant mortality, life expectancy, presence of HIV/AIDS, regional election results, voter demographics, citizen demographics, etc. This type of data can be entered and displayed very easily, as it is with a number of public domain mapping utilities. It may be encoded as tags within the most appropriate data layer, or it may be added as additional layers of bonus data, which may be accessible through the menu options.

### Sorting

FIG. 6A illustrates the SORTING sub-phase of operations (232) in this embodiment. It is a table showing the suggested default options for the pre-programmed grade-level settings in this embodiment. In conjunction with the categorized data trees, this protocol may provide a means for pre-programmed grade-level settings. This will allow the user or instructor to show only the data which the audience is ready or able to understand.

It will be noted each data layer has a suggested grade level at which the layer becomes visible and the root of the directory tree becomes accessible, as well as a suggested grade level at which the advanced terminology becomes visible, as shown in FIG. 6A. In addition, all of the individual categories and concepts within each data tree have been assigned to a suggested default grade level, as detailed in FIGS. 5B-V. In addition, suggested grade levels may also be assigned to all forms of data, including events, text, point data, line data, polygon or zone data, as detailed in FIG. 3. In this manner, the user can simply select a pre-programmed grade level, and the system may automatically show only the events, text, points, lines, data layers, and categories and concepts within the data layers that the audience has learned and is ready to understand, and automatically hide all of the data, categories, and concepts that are suggested to be too difficult for the audience. This may be extremely useful in a classroom setting.

Naturally, the users may also have the option to adjust the settings in any manner they desire. This may include customizing exactly which specific data types they wish to show and hide by selecting or deselecting them in any combination possible. There may also be more finely nuanced pre-programmed grade-level settings, including a first grade level that is slightly harder than the kindergarten level described here (506), a second grade level that is slightly harder than the first grade level, but slightly easier than the third grade level described here (508), etc, etc, etc, including any other possible grade level that can be imagined. There may also be pre-programmed subject-matter settings, as well as customized predetermined grade-level settings specifically tailored to Montessori students, Honors students, Advanced Placement students, or university students who may be very advanced in one subject area, but still have only limited knowledge of other subject areas.

It must also be noted that the data classification trees themselves constitute a complete system and method for organizing and leading a curriculum, which may easily be connected to the guidelines and standards put forth by state governments, national governments, and educational organizations. The structure of these data classification trees is a novel, useful, and non-obvious new use of existing systems, and thus, must be considered an integral part of this patent specification, and is covered in the claims.

### Filtering

FIG. 6B illustrates the FILTERING sub-phase of operations (234) in this embodiment. It is a table showing the suggested levels for event-importance highlighting in this embodiment. In conjunction with the categorized data trees, this protocol may provide a means for event-importance highlighting. This will allow the user or instructor to show only the data which the audience considers to be sufficiently important.

It will be noted that this system and method allows suggested event-importance levels to be assigned to multiple forms of data, including events, text, point data, line data, polygon or zone data. In this manner, the user can simply select an event-importance level, and the system will automatically show only the events, text, points, lines, and data layers, that the user or instructor considers to be important, and it will automatically hide all of the data that are considered to be unimportant. Naturally, this may be extremely useful when showing regions of the world that are very well documented by historians, and as the user approaches and enters the Modern Age, when the number of historically-known events begins to multiply geometrically at an alarming and overwhelming rate.

Here again, the users may have the option to adjust these settings in any manner they desire. This may include customizing exactly which specific event-importance rankings they wish to show and hide by selecting or deselecting them in any combination possible. There may also be more finely graded event-importance rankings, or customized predetermined event-importance ranking settings for Montessori students, Honors students, Advanced Placement students, or university students, etc, who may be very advanced in one subject area, but still have only limited knowledge of other subject areas.

### Verification

FIG. 6C illustrates the VERIFICATION sub-phase of operations (236) in this embodiment. It is a table showing the suggested levels for expertise-based data-vetting in this embodiment. In conjunction with the categorized data trees, this protocol may provide a means for expertise-based data-vetting. This will allow the user or instructor to show only the data contributed by people who have reached a desired level of expertise in the appropriate field.

It will be noted that this system and method allows expertise-based data-vetting rankings to be assigned to multiple forms of data, including events, text, point data, line data, polygon or zone data. In this manner, the user can simply select an expertise-based data-vetting level, and the system will automatically show only the events, text, points, lines, and data layers, etc, that were contributed or verified by someone whom the user feels is sufficiently knowledgeable. Conversely, it may hide all of the data that have not yet been vetted out by someone whom the user feels is sufficiently knowledgeable. Naturally, this feature may be extremely useful for advanced users and policy makers.

Here again, the users may have the option to adjust these settings in any manner they desire. This may include customizing exactly which specific vetting levels they wish to show and hide by selecting or deselecting them in any combination possible. There may also be more finely graded expertise-based data-vetting rankings.

Naturally, contributors may also add citations to the data, to identify the source of the data, to maintain full academic standards, and to facilitate vetting. These citations may also be hyperlinked to outside sources. Additionally, contributors may choose to create brief or extended biographies which may identify their contributions and further facilitate vetting.

Finally, as discussed in the static description, more highly-credentialed users can review and “vet out” any lower ranked data, and give it their official approval, thus increasing the data-vetting rank of that data. Using this system and method, users may periodically review data that has risen to one or two rank levels below them, vet it, verify it, and raise it's rank. After several iterations of this, data that was entered accurately and properly by low-ranked users will rise to the highest level. In this manner, the people who are considered to be the most authoritative experts in the field will be freed from the time-consuming task or republishing printed textbooks every several years, and can spend a minimum amount of time reviewing, vetting, verifying, and adding to the data that has already risen to level 8 or 9. This may create a more encyclopedic, unified, customizable, updatable, expandable, and transmittable repository of human knowledge, available more rapidly and cheaply than ever before, with fewer mistakes and less repeated effort.

### Storage

FIG. 7 shows an introduction and overview of the STORAGE phase of operations (238) for this embodiment in chronological order. It illustrates the protocol of collaboration for data management in this embodiment. The next two sections will focus in more detail on the protocols for managing the map data (222), and the tree data (224).

### Compiling

FIG. 8 illustrates the COMPILING sub-phase of operations (240) in this embodiment. It is a flowchart showing the process for resolving conflicts and overlaps within the maps. Using this protocol, the map database may be compiled into a unified document.

The flowchart starts at the top (800). If an area is detected where conflicting data overlaps, the contributor (702) first determines if this is a simple update in the map data (802). If so, the new data is entered over the old (804). If not, then the contributor must then determine if it represents a complete annexation or expansion into a neighboring civilization (806). If so, all of the data categories from the expanding civilization are copied onto the newly acquired region (808). If not, then the contributor must determine if it represents a successful colonization or the creation of a vassal state (810). If so, the contributor will intelligently select and copy the correct data categories onto the newly controlled region (812). If not, then the contributor must then determine if it represents a military invasion or occupied territory (814). If so, the contributor will indicate that all of the data layers should show overlapping stripes representing both civilizations (816). If not, then the contributor must then determine if it represents a military retreat or ceded territory (818). If so, all of the data categories from the re-expanding civilization will be copied back onto the newly re-acquired region (820). If the overlap does not clearly represent any of these scenarios, then the contributor must resolve the overlap intelligently by deciding to assign the region to the newer civilization, to assign the region to the older civilization, to instruct the computer to use a standard algorithm to split it down the middle, or by deferring to the data entered by the contributor with the higher expertise-based data-vetting rank (822).

### Updating

FIG. 9 illustrates the UPDATING sub-phase of operations (242) in this embodiment. It is a flowchart showing the process for updating the categories within the data trees. In conjunction with the data trees, this protocol may provide a means for continually updating the data trees in the future. This protocol is fundamentally based on the method that biologists use to assign species to the taxonomic tree, that linguists use to assign languages to the developmental tree, and that geneticists use to assign DNA samples into haplogroups, but it works equally well for any hierarchical data tree.

The flowchart starts in the upper-left (900). If the contributors (702) look at a newly discovered datum, concept or category and determined that it fits neatly into one of the existing categories on the data tree (902), then they will simply place it into that classification group (904). If not, then they will begin at the root of the data tree, and then look at the very first level of branching for that data tree (906). If there is no appropriate choice at that point, they will create a new category and attach it directly to the root of the data tree (908). If there is an obvious choice at that point, they will follow that branch, and then look at the next level of branching (910). If there is no obvious choice at this next point, then they will create a new category and attach it directly to this particular branch of the data tree (912). If there is an obvious choice at this point, they will follow this next branch further out, and then look at the subsequent level of branching (914), repeating the process until they either agree upon a satisfactory category, or they choose to create a new category (912). No matter what the outcome, if new information comes to light, the whole process of the flowchart may be repeated from the start (900) multiple times if needed, and the trees may be changed ex post facto, even after the initial publication and release of the database. Categories may be added, deleted, combined together, or split apart, multiple times. Any time a change is made to a category, all members of that category will be automatically reassigned to their new category or categories, but marked with a tag indicating that they had been moved, in case the decision is reversed.

In addition, in conjunction with the data trees, this protocol may provide a means for continually updating existing output modules in the future. Specifically, whenever the master structure of the data trees is officially updated, the users may have the option to have some or all of their pre-existing pre-composed maps and customized output modules set to be automatically and appropriately updated with the new correct information. In this manner, instructors may ensure that all of their maps, illustrations, and lectures are continually and automatically updated for accuracy. Moreover, whenever definitions or terminology change, and whenever new information comes to light, the entire user community can be updated. This may be most important in biology and genetics, where the state of knowledge is constant rapidly expanding. And ultimately, even if completely new concepts of religion, governance, economic policy, and social interaction are invented by humankind in the distant future, then they can be added to the continuum of knowledge with ease.

### Output

FIGS. 10A-V show an introduction and overview of the OUTPUT phase of operations (244) for this embodiment in chronological order. These figures include examples of all of the data layers and data sub-layers detailed in this embodiment.

FIG. 10A shows a screenshot of the main screen and interface items in this embodiment, including all menu options used during the output phase of operations (244) in this embodiment. This figure was discussed in full detail in the static description section of this specification.

As mentioned above, the reader will note that FIG. 10A included a large plurality of parts. Because of this, the part numbers for FIGS. 10B-V must begin with part number 1100, continuing through 1140. In keeping with this, the part numbers for FIG. 11A will begin with part number 1150. FIG. 12 will begin with part number 1200, as expected. The reader is encouraged to revisit the complete list of part numbers above for best clarification.

FIGS. 10B-V show screenshots of basic introductory examples of the output for all data layers and data sub-layers detailed in this embodiment. A few additional points need to be made here detailing the procedures for rendering the biology, climate, and geology data layers. (See FIGS. 10L-V)

The biology data layers include FIGS. 10L-O. The biology data layers (216) may be rendered using pre-rendered graphic patterns, procedural-generation, or other computer algorithms to realistically approximate the look of a real satellite-based environmental map. This data may also be modeled, synthesized, and recreated for periods of the deep past using known climate data from arctic ice cores, geological soil cores etc. In this way, the data may be rendered and animated for the extended periods of the Earth's history. Proceeding through time, these layers may show an accurate view of the advance and retreat of glaciers during successive Ice Ages, and the expansion and contractions of deserts and other environmental zones, as well as the origin and extinctions of species throughout all of the geological ages of the Earth.

The climate data layers include FIGS. 10P-T. The climate data layers (218) may be rendered using pre-rendered graphic patterns, procedural-generation, or other computer algorithms to realistically approximate the look of an accurate satellite-based weather map. This data may also be modeled, synthesized, and recreated for periods of the deep past using known climate data from arctic ice cores, geological soil cores, etc. In this way, the data may be rendered and animated for the extended periods of the Earth's history. Proceeding through time, these layers may show an accurate view of the rise and fall of global sea levels during successive Ice Ages, and the rise and fall of lake levels due to climate change, as well as the fluctuations in the concentrations of greenhouse gasses, including carbon dioxide, methane, nitrous oxide, and any other climate indicators, throughout all of the geological ages of the Earth.

The geology layers include FIGS. 10U-V. The geology data layers (220) may be rendered using pre-rendered graphic patterns, procedural-generation, or other computer algorithms to realistically approximate the look of an accurate paper-based or satellite-based geological, topographic, or bathymetric map. This data may also be modeled, synthesized, and recreated for periods of the deep past using known data from surveys, remote sensing, excavation, geological boreholes, bathymetric mapping, etc. First, all events and fossil sites may be keyed to their current locations on the bedrock of the modern continents, and then the positions and shapes of the continents may be visually warped back to their original positions along the known vectors of plate tectonic movement. In this way, the data may be rendered and animated for the extended periods of the Earth's history. Proceeding through time, these layers may show an accurate view of the separation of Pangaea, the movements of tectonic plates, as well as the eventual re-collision of the continents in the Pacific Ocean many millions of years in the future.

To allow the program to run more smoothly on the end-user's computer, all of the polygons and zones on the geological, climate, and biological layers may be transmitted as pre-rendered frames of an animated movie, rather than rendering all of the data on demand.

### Customizing

FIGS. 11A-E illustrate the CUSTOMIZING sub-phase of operations (246) in this embodiment.

FIG. 11A is a screenshot showing an example of advanced customized output for this embodiment. This figure will help to illustrate several additional procedural points relating to the rendering and customizing of output data.

The first several points concern polygon data or zone data. If the user is familiar with the look of traditional historical atlases, then the appearance of striped zones will be immediately familiar. However, until now, there have not been any firm guidelines on their meaning or use. Using this system and method, the exact percentages of a plurality of coexisting types can be encoded into a region. In this embodiment, and in these example figures, the color of a category is only drawn if it represents at least 33.4% of the total sum. By using this convention, no more than two colors may be shown together as stripes, which creates an easily readable map. The user may raise this threshold to inhibit stripes, or lower it to allow multiple colors to be striped if desired.

Also, with polygon or zone data, the user may increase and decrease the level of detail for the whole map or within selected nations or provinces. Within the legend box (1150B), if the user clicks on any node of the tree structure, the computer may automatically open or close that category, and may automatically change the colors on the map as appropriate. Thus, increasing the depth of detail of a category on the data tree in the legend may automatically cause all of the polygons on the map in that category to be shown in more detailed range of predetermined colors, corresponding with the more detailed range of predetermined categories. Alternately, if the user selects a zone in the map area (1150A) and rolls the mouse wheel up and down, the computer may increase and decrease the depth of the data categories that are differentiated in the same manner. By using various shades of a signature hue to color similar categories, the map will appear most intuitively legible, although the user may choose to alter the palette to any number of predetermined or chosen parameters. In conjunction with the data trees, this protocol may provide a means to increase the depth of detail in infinitely customizable ways.

If the user clicks on any icon within the civilization banners (1152) in the map area (1150A), the computer may bring the corresponding data layer to the top, and then may let it return to the back when the user releases the mouse button. Also, if the user clicks on the name of any civilization within the civilization banners (1152), the computer may automatically open the onboard encyclopedia to the article about that place. Within the legend box (1150B), if the user clicks on the color box for any category or concept, the computer may briefly highlight all of the zones on the map that have that color and concept. Also, if the user clicks the name of any category or concept, the computer may automatically open the encyclopedia (1054) to the definition of that concept. Within the encyclopedia, clicking on the title on the article's home page may cause the computer to show a quick animation or the entire history of that civilization, or all events relating to that topic. The user may also search for any keyword (1052), and select to show only events relating to that chosen keyword as history progresses.

The next points concern line data. Line data can also be added to any layer, but preferably minimally, since the goal will be to show historical movements in real-time animation, rather than visually overloading the map with too many arrows. Migrations, trade routes, and alliances are traditionally shown as line data and arrows on printed maps, but as history approaches the modern period, the map quickly becomes unreadable. Instead, most line data can be reserved for box-items. Box-items may be used to highlight the same sorts of regional topics, historical vignettes, or featured expeditions that are usually shown as an article in a magazine, or a grey box set apart from the main body of text in a printed textbook. They may be similar to the normal date-referenced geo-referenced event popups (1178), but they may have a unique appearance, and they may appear over the centroid of the appropriate region throughout appropriate time bracket. Users will have tools to compose animated box-items using existing point, line, zone, and text data, together with the types of additional information detailed in FIG. 12.

The next several points concern point data and event data. Battle icons (1182) may be a special class of point data that accompany violent events. Such icons are standard in printed historical atlases. Battles may be viewed with their event pop-ups, or they may be viewed without text, so that the viewer can get a purely visual impression of the clashes of civilizations and the progress of wars. Military units (1184, 1186, 1188) may also be programmed with vectors to move across the map accurately in historical time, to allow fully visually rendered re-enactments of wars. The icons may also change to match the unit type, historical period, or culture. In addition, any other types of point data, including animals, people representing DNA data sample points, and weather events can be programmed with vectors and move across the map, and thus visually recreating any scientific or historical scenario of war or peace.

Cities can also be shown on the map as points or icons, and they may be encoded with estimated population data so they may be shown with an appropriate size on the map. Major cities may be represented by a special icon unique to their civilization's culture and architecture. When a civilization enters the Agricultural Revolution, its borders may switch from fuzzy to distinct, as is traditional in historical atlases. Additionally, the globe may be rendered using a variety of map projections, and using a realistic day and night illumination, so that all of the cities of the world may be viewed as points of light from outer space, switching from hearth-fires to electric lights as they enter the Industrial Revolution.

Ultimately, the Wonders of the World, and many other major achievements, including most visibly the Great Wall of China, may appear as small 3-D objects on the map in their accurate location beginning in the year that they were created.

FIGS. 11B-E are screenshots showing examples of the “WorldView 360°” visualization, as explained in this embodiment. These figures will help to illustrate several additional points relating to the rendering and customizing of 3-D output data.

Using 3-D rendering will allow a variety of benefits. First, it allows the most accurate representation of territory size. It allows the user to show the civilization being discussed in the foreground, with neighboring civilizations along the horizon. It also allows the user to orient the map so that a civilization faces towards its most important adversary, or looks towards its most important direction of expansion. It represents the natural way that pre-industrial human beings see the world, not as aerial maps, or from outer space, emphasizing how important the development of accurate maps and the first views of earth from space were to the modern worldview. Finally, it allows one to perform a “Worldview 360°” visualization, which may show a scrolling panoramic view from any chosen point, as illustrated in FIGS. 11B-E. This may show what a person would have seen from the top of an extremely high tower, looking outward upon the known world at that time. It may be programmed to fog out or obscure regions that were unknown to the home civilization at that time. The radius of visibility or contactability may also increase as global communications technology increases. This is the most accurate possible representation of the way that individual human beings and individual societies perceive their worldview in real life. It is something that has never been fully visualized before in any book or software, and something that can only be accomplished with this type of encyclopedic database. It will undoubtedly be an extremely powerful visual, and quite impressive when shown in classroom and fundraising presentations.

Ultimately, in conjunction with the categorized data trees, this system and method may provide a means for voice-activated interface controls. Given that the data trees encode every historical concept in a distinctly categorized structure, the user can then command the computer using a series of voice commands which correspond directly to any of the functions, procedures, parameters, or customizations described above, which would normally be executed with one or more mouse clicks. Voice commands may be established to correspond to predetermined geographic areas, predetermined time brackets, specified data layers, specified data sub-layers, predetermined pre-programmed grade level settings, predetermined event-importance levels, predetermined expertise-based vetting rankings, as well as predetermined parameters for any function described herein. Thus, given the full benefit of this disclosure, one can clearly envision, for example, that whoever is leading the group can stand up like the captain on the bridge of the Starship Enterprise, and say, “Computer, show me the world, start 13,000 BC, 1 millennium per second . . . Go!!”, or “Computer, show me governments, China, 6th grade level, start 300 BC, 1 century per second . . . Go!!” or “Computer, show me religions, Middle East, 9th grade level, level 10 globally important events only, level 10 professionally vetted data only, start 600 AD, forward 1 decade per second . . . Go!!”

### Publication

FIG. 12 illustrates the PUBLICATION sub-phase of operations (248) in this embodiment. It is a matrix showing the data types that may be used to create multiple types of useful output. It must be noted that this system and method allow nearly infinite forms of output, and so the claims of this specification should not be limited to the examples given here.

Using this system and method, the user may command the computer to render a fresh and updated version of any desired animation at any time. Once the predetermined set of parameters and commands are chosen, the computer can recreate the desired animation using the newest and best data available. This feature may be most powerfully effective for institutions that require up-to-the-minute data, including journalists and governments, and ensure that all users, including those working in international business, international relations, and education may have access to global historical collaborative animated map data more rapidly and cheaply than ever before, with fewer mistakes and less repeated effort.

There can also be a multitude of tools provided to compose and print maps. The user may create illustrations and export them in a format ready for printed or online publication, or have them printed up as high quality wall posters by a print shop. There may also be a customized printer provided that will allow users to print large files using ink at a more economical cost, as well as punching the appropriate holes in the sheets.

However, it may be envisioned that the main channel for distribution of the database will be online. Indeed, if this system and method is adopted by governments, international finding agencies, and policy-making departments, there will undoubtedly be a large number of people who desire to log on and contribute. If successful, this system and method may become one of the core reference sites on the internet.

### ALTERNATIVE EMBODIMENTS

Given the full benefit of this disclosure, many other ramifications and variations may become apparent to one skilled in the art, for example, the inclusion or exclusion of different types of data, variations in the input of the data, variations in the structure of the data, variations in the storage of the data, variations in the output of the data, variations in the presentation of the data, translations of the database into foreign languages, a simplified interface for younger students and instructors, a more complex interface for advanced students and instructors, a voice-activated interface for selecting and customizing output, the capability for users to add extra layers, the capability to restrict or encrypt extra layers for internal use only, automated versions of map visualizations which may be executed with only one click of the mouse or with only minimal input from the user, data for past geological ages which may include the ability to visually warp georeferenced map data and regions back into their former tectonic positions including Pangaea, hypothetical scenarios for past events, multiple simultaneous hypothetical scenarios for past events, hypothetical scenarios for future events, multiple simultaneous hypothetical scenarios for future events, alternative scenarios representing religious histories, alternative scenarios representing mythological histories, alterations of the database structure for users with different historical or religious worldviews, alterations of the database content for users with different historical or religious worldviews, a 3-D version which may include specialized eyewear, a mobile version for tourists and travelers, the integration of updated news-feeds into the database, the development of games and activities, and the development of educational materials in all formats, including materials that allow students to use any element of this method as part of a curriculum, and including materials that allow students to use any element of this method in a computer-based or non-computer-based format.

### Conclusion, Ramifications, and Scope

Thus the reader will see that, according to one embodiment of the invention, this document presents an innovative system and method which may be used to input data relating to any number of historical or scientific subjects, store the data in a collaborative format, and output data in any number of static or animated formats. In various embodiments, this method may provide a revolutionary means for encoding the entire history of the earth, encoding the entire history of human cultures, and for ensuring that all input data adhere to a universal data format. It provides and specifies a number of innovative and collaborative protocols for input, storage, classification, sorting, filtering, verifying, compiling, updating, customizing, and publishing data. It may also provide a means for creating a revolutionary format of global historical collaborative animated map. It may be used widely in various applications, including but not limited to education, journalism, governments, international business, and international relations.

It may also include a guided graphic user interface that provides a means for visual template-based data-entry with a guided graphic user interface, categorized data trees, customizable depth of detail, pre-programmed grade-level settings, event-importance highlighting, and expertise-based data-vetting. It may be used to create tools for curriculum development, or a wide variety of interactive multimedia presentations.

These innovations may allow an instructor or user to view the sum total of the historical knowledge of humankind on a virtual globe that can be easily visualized and studied, with the ability to choose any region of focus, or to choose any period of time, or to select any category of study, or to show any type of information to any interactive level of detail, or at any desired grade level, or within any specified level of historical importance, or with a sufficient level of vetting by experts for scientific accuracy.

It may present information that every citizen of the modern world needs to know, but in a way that may be in various embodiments and using various parameters, more accurate, more visual, more intuitive, more comprehensible, more retainable, more teachable, more encyclopedic, more globalized, more customizable, more unified, more updatable, more expandable, more transmittable, and available more rapidly and more cheaply than ever before, with fewer mistakes and less repeated effort.

This database may be a collaborative document, constantly open to scholarly scrutiny, constantly expanding, and constantly made more accurate and more detailed. If successful, this system and method may become one of the core reference sites on the internet. It may take some time to fill in every corner of the globe and every millennium of history, but once complete, it may be the equivalent of the Human Genome Project for international historians and environmental scientists.

It may be based on the traditional GIS, or Geographic Information Systems, platforms that are typically used to create georeferenced databases, primarily for urban planning and environmental impact assessments, yet it may contain a multitude of additions and improvements that have never been properly codified into such systems. All modern standard GIS-based systems are designed to take elements of map data, arrange them into layers of polygon data, line data, and point data, with associated text, to wrap them around a virtual globe for accurate viewing, and to perform various types of spatial analysis on the data. These systems, often with simplified interfaces, have become very popular in recent years. All GIS-based systems involve manipulations of map data in virtual space, and many of them will also allow for manipulations of data across time. Almost all involve a plurality of data layers, but none of them allow for the specific types of data, the specific data structure, and the specific data management protocols that will be needed to create a fully functional tool for use in education, journalism, governments, international business, and international relations.

While the above description contains many specificities, these should not be construed as limitations on the scope of the invention or any embodiment, but as exemplifications of the presently preferred embodiments thereof. Many other ramifications and variations are possible for one skilled in the art, for example, the inclusion or exclusion of different types of data, variations in the input of the data, variations in the structure of the data, variations in the storage of the data, variations in the output of the data, variations in the presentation of the data, translations of the database into foreign languages, a simplified interface for younger students and instructors, a more complex interface for advanced students and instructors, a voice-activated interface for selecting and customizing output, the capability for users to add extra layers, the capability to restrict or encrypt extra layers for internal use only, automated versions of map visualizations which may be executed with only one click of the mouse or with only minimal input from the user, data for past geological ages which may include the ability to visually warp georeferenced map data and regions back into their former tectonic positions including Pangaea, hypothetical scenarios for past events, multiple simultaneous hypothetical scenarios for past events, hypothetical scenarios for future events, multiple simultaneous hypothetical scenarios for future events, alternative scenarios representing religious histories, alternative scenarios representing mythological histories, alterations of the database structure for users with different historical or religious worldviews, alterations of the database content for users with different historical or religious worldview, a 3-D version which may include specialized eyewear, a mobile version for tourists and travelers, the integration of updated news-feeds into the database, the development of games and activities, and the development of educational materials in all formats, including materials that allow students to use any element of this method as part of a curriculum, and including materials that allow students to use any element of this method in a computer-based or non-computer-based format.

1. A method for creating a database, comprising:
a) inputting data relating to one or more historical or scientific subjects;
b) storing data in a collaborative format, and;
c) outputting data in one or more static or animated formats.

2. The method of claim 1, wherein the method of inputting data may provide a means for encoding the entire history of the earth.

3. The method of claim 1, wherein the method of inputting data may provide a means for encoding the entire history of human cultures.

4. The method of claim 1, wherein the method of inputting data provides a means for entering data with a guided graphic user interface.

5. The method of claim 1, wherein the method of storing data provides a means for ensuring that data adhere to a universal format.

6. The method of claim 1, wherein the method of storing data provides one or more protocols for enhancing updatability.

7. The method of claim 1, wherein the method of storing data provides one or more protocols for enhancing customizability.

8. The method of claim 1, wherein the method of outputting data provides a means for creating a static map.

9. The method of claim 1, wherein the method of outputting data provides a means for creating an animated map.

10. The method of claim 1, wherein the method of outputting data provides a means for creating a customized map.

11. The method of claim 1, wherein said method provides a means for creating a global historical collaborative animated map.

12. The method of claim 11, wherein said method provides a means for the user to make customizations to said global historical collaborative animated map.

13. The method of claim 1, wherein said method provides a means for the creation of one or more output types selected from the set comprising: illustrations, slideshows, animations, videos, box-items, curriculum modules, news features, educational games, standardized textbooks, customizable textbooks, and scholarly articles.

14. The method of claim 1, further including an interface that provides a means for ensuring that all input data adhere to a universal data format.

15. The method of claim 14, wherein said interface provides a means for rendering data onto pre-provided categorized data layers.

16. The method of claim 14, wherein said interface provides a means for selecting data from pre-provided categorized data trees.

17. The method of claim 14, wherein said interface provides a means for template-based data-entry in a manner which is substantially similar to the means described in this specification.

18. The method of claim 1, further including categorized data layers.

19. The method of claim 18, wherein said data layers include one or more data types selected from the set comprising: civilizations, religions, governments, economic systems, linguistic data, ethnic data, genetic data, biological data, climate data, and geological data.

20. The method of claim 18, further including a means for users to create additional data layers.

21. The method of claim 20, further including a means for users to hide and encrypt data layers for restricted access.

22. The method of claim 1, further including categorized data trees.

23. The method of claim 22, wherein said data trees include one or more data types selected from the set comprising: civilizations, religions, governments, economic systems, linguistic data, ethnic data, genetic data, biological data, climate data, and geological data.

24. The method of claim 22, wherein said data trees are used as legends for maps.

25. The method of claim 22, wherein minimizing and maximizing the categories of the data tree on the screen is simultaneously reflected in the appearance of the map data.

26. The method of claim 25, wherein increasing the depth of detail of a category on the data tree on the screen may automatically cause all of the polygons on the map in that category to be shown in more detailed range of predetermined colors, corresponding with the more detailed range of predetermined categories.

27. The method of claim 26, wherein said method uses a means for customizable depth of detail in a manner which is substantially similar to the method described in this specification.

28. The method of claim 22, further including an explicit method and protocol for continually updating the data trees in the future.

29. The method of claim 28, wherein updating the master structure of the data trees may automatically cause existing static maps and existing animated maps to be appropriately updated with the new correct information.

30. The method of claim 29, wherein said method uses a protocol for resolving disputes within data trees in a manner which is substantially similar to the method described in this specification.

31. The method of claim 22, wherein students learn the specific structure and contents of said data trees as an element of a curriculum.

32. The method of claim 1, further including specific designations of predetermined suggested grade levels for data types.

33. The method of claim 32, wherein said predetermined suggested grade levels provide a means for the user or instructor to show only the data which the audience is ready or able to understand.

34. The method of claim 33, wherein said method uses a means for pre-programmed grade-level settings in a manner which is substantially similar to the method described in this specification.

35. The method of claim 1, further including specific designations of predetermined event-importance levels for data types.

36. The method of claim 35, wherein said predetermined event-importance levels provide a means for the user or instructor to show only the data which the audience considers to be sufficiently important.

37. The method of claim 36, wherein said method uses a means for event-importance highlighting in a manner which is substantially similar to the method described in this specification.

38. The method of claim 1, further including specific designations of predetermined expertise levels for contributors.

39. The method of claim 38, wherein said predetermined expertise levels provide a means for the user or instructor to show only the data which has been vetted out by those who have reached a desired level of expertise in the appropriate field.

40. The method of claim 39, wherein said method uses a means for expertise-based data-vetting in a manner which is substantially similar to the method described in this specification.

41. The method of claim 1, further including an explicit method and protocol for representing complex historical interactions more easily.

42. The method of claim 41, wherein said method uses a protocol for resolving disputes within data layers in a manner which is substantially similar to the method described in this specification.

43. The method of claim 1, further including an explicit method and protocol for executing commands with spoken voice commands.

44. The method of claim 43, wherein said method uses a protocol for voice-activated interface controls in a manner which is substantially similar to the method described in this specification.

45. The method of claim 1, further including hypothetical past data.

46. The method of claim 45, wherein said method provides a means for multiple hypothetical past scenarios to be stored simultaneously.

47. The method of claim 1, further including hypothetical future data.

48. The method of claim 47, wherein said method provides a means for multiple hypothetical future scenarios to be stored simultaneously.

49. The method of claim 1, further including religious histories.

50. The method of claim 49, wherein said method provides a means for said religious histories to be stored in the same manner as scientific histories.

51. The method of claim 1, further including mythological histories.

52. The method of claim 51, wherein said method provides a means for said mythological histories be stored in the same manner as scientific histories.

53. The method of claim 1, wherein the data includes visualizations of past or present human civilizations.

54. The method of claim 53, wherein said visualizations include views from the point of view of the civilization itself.

55. The method of claim 54, wherein said visualizations include scrolling or static panoramic views from at or near ground level.

56. The method of claim 55, wherein said visualizations may be executed automatically with only one click of the mouse, or with only minimal input from the user.

57. The method of claim 1, wherein the data includes visualizations of past or present natural environments.

58. The method of claim 57, wherein said visualizations include accurate representations of the landscapes of past geological ages.

59. The method of claim 58, wherein said visualizations include accurate representation of tectonic movements.

60. The method of claim 59, wherein said visualizations may be created automatically by visually warping georeferenced map data back into former tectonic positions, including Pangaea.

61. A computer database product, comprising:
a) a data storage means for storing data relating to one or more historical subjects in a collaborative format, and;
b) a data output means for outputting the data in one or more static or animated formats.

62. The computer database product of claim 61, further including a data input means for encoding the entire history of the earth.

63. The computer database product of claim 61, further including a data input means for encoding the entire history of human cultures.

64. The computer database product of claim 61, further including a data input means for entering data with a guided graphic user interface.

65. The computer database product of claim 61, wherein the means for data storage provides a means for ensuring that data adhere to a universal format

66. The computer database product of claim 61, wherein the means for data storage provides one or more protocol means for enhancing updatability.

67. The computer database product of claim 61, wherein the means for data storage provides one or more protocol means for enhancing customizability.

68. The computer database product of claim 61, wherein the means for data output provides a means for creating a static map.

69. The computer database product of claim 61, wherein the means for data output provides a means for creating an animated map.

70. The computer database product of claim 61, wherein the means for data output provides a means for creating a customized map.

71. The computer database product of claim 61, wherein said computer database product provides a means for creating a global historical collaborative animated map.

72. The computer database product of claim 71, wherein said computer database product provides a means for the user to make customizations to said global historical collaborative animated map.

73. The computer database product of claim 61, wherein said computer database product provides a means for the creation of one or more output types selected from the set comprising: illustrations, slideshows, animations, videos, box-items, curriculum modules, news features, educational games, standardized textbooks, customizable textbooks, and scholarly articles.

74. The computer database product of claim 61, further including an interface that provides a means for ensuring that all input data adhere to a universal data format.

75. The computer database product of claim 74, wherein said interface provides a means for rendering data onto pre-provided categorized data layers.

76. The computer database product of claim 74, wherein said interface provides a means for selecting data from pre-provided categorized data trees.

77. The computer database product of claim 74, wherein said interface provides a means for template-based data-entry in a manner which is substantially similar to the means described in this specification.

78. The computer database product of claim 61, further including specific designations of predetermined suggested grade levels for data types.

79. The computer database product of claim 78, wherein said predetermined suggested grade levels provide a means for the user or instructor to show only the data which the audience is ready or able to understand.

80. The computer database product of claim 79, wherein said computer database product uses a means for pre-programmed grade-level settings in a manner which is substantially similar to the means described in this specification.

81. The computer database product of claim 61, further including specific designations of predetermined event-importance levels for data types.

82. The computer database product of claim 81, wherein said predetermined event-importance levels provide a means for the user or instructor to show only the data which the audience considers to be sufficiently important.

83. The computer database product of claim 82, wherein said computer database product uses a means for event-importance highlighting in a manner which is substantially similar to the means described in this specification.

84. The computer database product of claim 61, further including specific designations of predetermined expertise levels for contributors.

85. The computer database product of claim 84, wherein said predetermined expertise levels provide a means for the user or instructor to show only the data which has been vetted out by those who have reached a desired level of expertise in the appropriate field.

86. The computer database product of claim 85, wherein said computer database product uses a means for expertise-based data-vetting in a manner which is substantially similar to the means described in this specification.

87. The computer database product of claim 61, further including an explicit flowchart and protocol for representing complex historical interactions more easily.

88. The computer database product of claim 87, wherein said computer database product uses a protocol for resolving disputes within data layers in a manner which is substantially similar to the means described in this specification.

89. The computer database product of claim 61, further including an explicit method and protocol for executing commands with spoken voice commands.

90. The computer database product of claim 89, wherein said computer database product uses a protocol for voice-activated interface controls in a manner which is substantially similar to the means described in this specification.

91. A means of education, comprising:
a) one or more categorized data trees, and;
b) means for utilizing said data trees for curriculum development.

92. The means of education of claim 91, wherein said data trees include one or more data types selected from the set comprising: civilizations, religions, governments, economic systems, linguistic data, ethnic data, genetic data, biological data, climate data, and geological data.

93. The means of education of claim 91, further including the assigning of predetermined suggested grade levels to individual elements of said data trees.

94. The means of education of claim 93, wherein said predetermined suggested grade levels provide a means for the user or instructor to show only the data which the audience is ready or able to understand.

95. The means of education of claim 94, wherein said means of education uses data trees that are substantially similar to those illustrated in this specification.

96. The means of education of claim 91, wherein said data trees may provide a means for teaching the entire history of the earth.

97. The means of education of claim 91, wherein said data trees may provide a means for teaching the entire history of human cultures.

98. The means of education of claim 91, wherein said data trees may provide a means for teaching specified subjects in a more visual manner.

99. The means of education of claim 91, wherein said data trees are used as a legend on a map.

100. The means of education of claim 91, wherein said data trees provide the means for the creation of a static map.

101. The means of education of claim 91, wherein said data trees provide the means for the creation of an animated map.

102. The means of education of claim 91, wherein said data trees provide the means for the creation of a customized map.

103. The means of education of claim 91, wherein said data trees provide the means for the creation of a global historical collaborative animated map.

104. The means of education of claim 103, wherein said data trees provide the means for the user to make customizations to said global historical collaborative animated map.

105. The means of education of claim 91, wherein said data trees provide the means for the creation of one or more output types selected from the set comprising: illustrations, slideshows, animations, videos, box-items, curriculum modules, news features, educational games, standardized textbooks, customizable textbooks, and scholarly articles.

106. A method of business, comprising:
a) providing proprietary hardware that may be optimally designed for the subscribers of a proprietary data service;
b) providing said proprietary hardware only to the subscribers of said proprietary data service, and;
c) providing said proprietary hardware and associated supplies at a lower cost than would otherwise be available on the market.

107. The method of business of claim 106, wherein monitors may be made available only to the subscribers of said data service.

108. The method of business of claim 107, wherein the monitors may be provided at lower cost to subscribers of said data service.

109. The method of business of claim 106, wherein projectors may be made available only to the subscribers of said data service.

110. The method of business of claim 109, wherein the projectors may be provided at lower cost to subscribers of said data service.

111. The method of business of claim 106, wherein printers may be made available only to the subscribers of said data service.

112. The method of business of claim 111, wherein the printers may be provided at lower cost to subscribers of said data service.

113. The method of business of claim 111, wherein the printer may provide a means of printing only approved files from said data service.

114. The method of business of claim 111, wherein the printer may provide a means of binding or punching holes in large volumes of printed data, as required to fully utilize said data service.

115. The method of business of claim 111, wherein the printer may utilize proprietary ink cartridges, which may be made available only to the subscribers of said data service.

116. The method of business of claim 115, wherein said proprietary ink cartridges may be provided at lower cost to subscribers of said data service, in accordance with said business method.
